(19) United States
(12) Patent Application Publication
(10) Pub. No.: US 2023/0301377 A1
(43) Pub. Date: Sep. 28, 2023

(54) MASK INCLUDING SIDE FIXING PORTION

(71) Applicant: KOREATECH CO., LTD., Seoul (KR)

(72) Inventor: Dong Yol LEE, Seoul (KR)

(73) Assignee: KOREATECH CO., LTD., Seoul (KR)

(21) Appl. No.: 18/020,658

(22) PCT Filed: Feb. 22, 2021
(86) PCT No.: PCT/KR2021/002209

§ 371 Date: Feb. 10, 2023

(30) Foreign Application Priority Data
Aug. 13, 2020 (KR) 10-2020-0101485
Feb. 19, 2021 (KR) 10-2021-0022883

(51) Int. Cl. A41D 13/11; A62B 18/08

(52) U.S. Cl. CPC A41D 13/1161; A62B 18/084

(57) ABSTRACT

Disclosed is a novel mask including a fixing portion that is not fixed to ears but is brought into tight contact with a specific region of a face so as to fix the mask to the face and a nose pressing portion that securely seals the peripheral portion of a nose without pressing the face of a user, unlike a conventional mask.

### TECHNICAL FIELD

This application claims the benefit of priority to Korean Patent Application No. 2020-0101485 filed on Aug. 13, 2020 and Korean Patent Application No. 2021-0022883 filed on Feb. 19, 2021, the disclosures of which are incorporated herein by reference in their entireties.

The present invention relates to a mask including a side fixing portion. More particularly, the present invention relates to a novel mask, which includes a side fixing portion that is not fixed to ears but is brought into tight contact with a specific region of a face so as to fix the mask to the face and a pressing portion that securely seals the peripheral portion of a nose without pressing the face of a user, unlike a conventional mask.

### BACKGROUND ART

Masks, which are a product related to diseases, have been limitedly used. Masks have been used as an auxiliary means for preventing diseases of an individual from propagating to others or preventing infection from others. The cases in which masks are worn in order to block yellow dust and fine dust have become more frequent; however, this is also for preventing diseases.

Due to the coronavirus disease 2019 (COVID-19) pandemic, awareness about masks has abruptly changed. Masks have been treated with respect to such an extent that masks were in short supply, and the fact that a disease prevention effect is great even if only masks are used has been socially learned. Experiences in which people spend most of the day while wearing masks have been widely shared. A negative point of view that faces are covered by wearing masks has been alleviated without distinction between East and West.

Meanwhile, in the case of a disease spread by droplets, it is desirable not to touch a mask with hands after wearing the same. The reason for this is that the mask may be wet with saliva and the surface of the mask may be contaminated with other foreign substances. In order to fundamentally obviate this problem, medical personnel wears masks and face shields. Non-Patent Document 1 is a paper that demonstrates effects obtained by wearing masks and face shields, and it can be seen therefrom that face shields exhibit excellent effects.

A face shield also has an effect of primarily blocking foreign substances approaching a user's face; however, it is very inconvenient to additionally wear a face shield over a mask, and the mask and the face shield are undesirably displaced.

Masks have been used as daily necessities, like glasses. It seems to be that all families continuously stock at least a minimum quantity of masks. It will be very natural to wear masks for pollen or yellow dust in spring, automobile exhaust fumes in summer, and mild cold in winter. Wearing masks will also be very natural, much like wearing glasses is normal.

As the temporal, spatial, and cultural environments for masks have changed rapidly, new-concept masks that transcend the current concept of masks are needed. Because masks are not only worn very frequently but are also worn for a long time, new-concept masks having high durability and capable of improving wearing sensation and reducing discomfort are needed.

It is necessary to improve the way a user fixes and wears a mask. A mask includes a fixing portion, which fixes the mask on a face by hanging strings on ears, and a main body portion, which covers a nose and a mouth while pressing a region around the nose and the mouth. When the user wears the mask for a long time, the mask leaves marks on the user's face and ears along the strings of the fixing portion.

The process of wearing a mask is also inconvenient. It is necessary to adjust not only the length of the strings but also the contact force and direction of a nose bridge strip and the shape of a portion covering a chin so that the mask fits snugly on a face. Nevertheless, fogging of glasses due to incomplete sealing is recognized as a chronic problem of a conventional mask that is unlikely to be solved soon.

Stress on ears also needs to be eliminated. Ears are the most important parts for fixing a mask. Devices designed to be worn on a face by being supported by ears have also greatly increased in number. Headphones and earphones as well as typical glasses are also designed so as to be supported by ears in various manners. Utilization of VR devices, which are a product designed to be supported by ears, has gradually increased.

Time for which devices designed to be supported by ears are worn has also greatly increased. Not only glasses, which are worn all day long, but also masks are worn irrespective of place and time. Using earphones, to which new technology is applied, for several hours has become very natural.

As a result, it is expected that physical stress on ears will greatly increase. Discomfort will be increased for glasses wearers, who make up more than 50% of adults. Daily wearing of a mask due to COVID-19 and fine dust is one of the factors that increase physical burden on ears.

Therefore, there is a need to develop a new method of fixing a mask to a face while reducing physical stress on ears. It is necessary to develop a method of fixing a mask to a second fixing region capable of assisting or replacing ears, rather than a conventional method relying only on ears.

In order to solve such a problem, the inventor of the present application has analyzed problems with a mask. To this end, preliminary research on a leakage rate depending on the length of a string of the mask and pain felt when the mask is worn was conducted. In the present invention, preliminary research on a KF94 mask was conducted for nine participants.

First, research on an appropriate length of a string of the mask capable of achieving a low leakage rate, which is a basic object of the mask, was conducted. A leakage rate in the case in which the length of a string of a mask manufactured for adults was not adjusted and a leakage rate in the case in which the length of the mask including the string was adjusted to 120% of a facial length were compared with each other. It was revealed that, in the latter case, the leakage rate was reduced by at least 25% and up to 83% compared to the former case. That is, it can be seen that, only when the length of the string of the mask is adjusted, it is possible to reduce the leakage rate, whereby it is possible to achieve the original purpose of wearing the mask.

Here, the facial length is a facial length measured using Morpheus, and is defined as the distance from the left ear to the point under the nose of a user and from the point under the nose to the right ear of the user.

When the length of the string of the mask is reduced, the leakage rate may be reduced; however, pain in various regions due to long-term wearing was observed.

FIG. 1 is a schematic view showing positions at which pain depending on wearing of a mask was observed. The degree of pain in specific portions of a face shown in FIG. 1 was qualitatively evaluated immediately after the mask was worn and after the mask was continuously worn for eight hours. It was observed that, when the mask was continuously worn for eight hours without adjusting the length of a string of the mask, the degree of pain was greatly increased only at region 6 (behind the ear). This is analyzed as pain that appears as the result of the string of the mask being continuously fixed to the ear even if the degree of pressure against the face is low.

It was revealed that, when the mask was continuously worn for eight hours in the state in which the leakage rate was reduced by adjusting the length of the string of the mask to 120% of the facial length, the degree of pain was increased at various regions, including region 6. It was revealed that the degree of pain was also greatly increased at region 3 and region 7, including region 4 related to the ear. Region 3 and region 7 are regions at which pain of a fascia tender point is manifested, and headache may be easily caused by this pain. The temporalis muscle and muscles of the upper cervical vertebrae extensor of an occipital region, which correspond to region 3 and region 7, respectively, are regions that cause pain of a fascia tender point of an upper trapezius, and headache and shoulder pain may be caused.

The inventor of the present application has found through the above-described preliminary research that, when a mask was worn for a long time, pain was also caused in musculoskeletal systems other than ears. Various kinds of pain caused due to wearing of a mask also cause lack of concentration, whereby study or work may be impeded. Recently, the problem of deformation of the ears of growing children or teenagers due to wearing of a mask for a long time has also emerged.

The present invention has been made in view of the above problems, and the present invention has been derived through a process of developing a mask that is capable of being fixed by a second fixing region excluding ears.

Patent Document 1 relates to a mask that is easily and conveniently worn, the mask including a frame including a holding portion held over a curved portion of a front surface of a face and an elastic tight contact portion extending from the holding portion so as to come into contact with an upper end of a cheekbone and extending to a side surface of the face near each ear along the contour of the face, a main body having formed therein a mounting hole, into which the frame is detachably inserted, the main body being configured to cover the vicinities of a nose and a mouth of the face, the main body being made of an elastic fiber band material, and a filter detachably mounted to an inner surface of the main body, the filter having formed therein a mounting hole, into which the frame is detachably inserted, the filter being configured to cover the nostrils and the mouth, wherein the holding portion and the elastic tight contact portion are maintained in the state of being held over the face in tight contact with the face due to elastic force of the elastic tight contact portion of the frame. An object of Patent Document 1 is to provide a mask that is stably brought into tight contact with a face of a user without discomfort in ears. The mask has a structure in which the main body and the filter are detachably attached to each other, whereby it is possible to replace the filter, and the main body and the filter may be separated from each other so as to be independently used depending on a use environment.

In Patent Document 1, the frame including the elastic tight contact portion extending from the holding portion so as to come into contact with the upper end of the cheekbone and extending to the side surface of the face near each ear along the contour of the face is widely disposed over a region including the vicinity of a cheek. In this case, the mask continuously irritates a weak region of the skin, whereby a mark is left on the face of a user when the user wears the mask for a long time, and the user feels discomfort. In addition, definite criteria for a surface that is pressed and pressure applied thereto are not presented, whereby it is difficult to secure consistent fixing force.

Patent Document 2 relates to a neck warmer configured to block fine dust, wherein the neck warmer includes a neck cover portion formed in a cylindrical shape, the neck cover portion being configured to cover a range from points under eyes of a face to a neck when worn, a sealing cover portion formed so as to cover a nose and a mouth of a user in the state of being spaced apart therefrom by a predetermined distance when worn, a pressing ring portion formed at an edge of an upper end of the neck cover portion, the pressing ring portion being configured to allow the upper end of the neck cover portion to come into tight contact with the face, and a filtering portion configured to filter air introduced into the nose and the mouth, whereby fine dust introduced into respiratory organs is blocked while the face and the neck are protected. An object of Patent Document 2 is to provide a functional neck warmer capable of efficiently blocking fine dust and protecting the neck and the face, wherein the neck warmer is brought into tight contact with a curved surface of the face in order to secure efficiency in blocking fine dust, and the neck warmer is prevented from moving under the chin during activity.

A typical problem with a configuration using a rubber band of Patent Document 2 is that 1) detachment and attachment of the neck warmer is very inconvenient. In addition, 2) the face may be rubbed during attachment and detachment of the neck warmer, whereby makeup may be removed. 3) A mark is left on the face of the user when the user wears the neck warmer for a long time, and the user feels discomfort.

Patent Document 3 relates to a wearable mask including a main body configured to cover a mouth region of a face of a user in order to protect the mouth region and a face fixing member connected to the main body, the face fixing member being configured to contact a part of the face of the user so as to be brought into tight contact therewith when the user wears the wearable mask. An object of Patent Document 3 is to provide a wearable mask configured to be brought into tight contact with a part of the face through a concave recess when worn on the face, whereby it is unnecessary to form a catching tool, such as a string added to the mask, and therefore it is possible to reduce manufacturing cost, and configured such that the main body is formed so as to be disposable, whereby the wearable mask is semi-permanently usable by replacing only the main body.

In Patent Document 3, 1) there is concern that a mark may be left on the face due to continuous wearing, and 2) definite criteria for a surface that is pressed and pressure applied thereto are not presented, whereby it is difficult to secure consistent fixing force.

Patent Document 4 relates to a facial mask for adults and children configured to be fitted on a face, a jaw portion, and a front head through drawing corresponding to a solid based on a stretch rate of a material for the mask, the length from jaws to a tragus, and the position of a cheekbone. An object of Patent Document 4 is to provide a drawing method corresponding to a solid of a sheet type facial mask configured to be fitted on the face, the jaw portion, and the front head and suitable for medical supplies replacing a bandage, an adhesive bandage, and an eye bandage or cosmetic purposes and the mask.

In Patent Document 4, the mask is held by ears and tension induced therefrom is used, and therefore stress on the ears mentioned in the present invention is extremely high.

Patent Document 5 relates to a mask cover capable of being mounted to a face without ear strings. An object of Patent Document 5 is to provide a mask configured to be deformed along a curved surface of the face using a material that exhibits excellent elasticity and including a mask cover having good breathability.

In Patent Document 5, 1) a user may feel uncomfortable wearing the mask since a separate anchor member is attached to the face, and 2) a mark is left on the face along a surface to which the anchor is attached or the skin may be injured due to continuous irritation. In addition, 3) definite criteria for the surface to which the anchor is attached are not presented, whereby it is difficult to secure consistent fixing force.

Patent Document 6, which relates to a body relaxation prevention and improvement member, provides a body relaxation prevention and improvement member configured such that manufacturing cost of the member is reduced, and the member can be mounted to a head and other regions, whereby tensile force is applied in a direction toward a face over a large range, and the relaxation prevention and improvement member is configured such that a branch capable of being wound around an occipital region is integrally connected to a stump that covers an area ranging from the top of the head or a front head to the tip of a chin and a lower part of the chin via the masseteric fascia.

Patent Document 6, in which tensile force that covers the entirety of the face is used, is characterized by the tensile force itself, and therefore it is not possible to solve the problems presented in the present invention.

A problem in that a mask is separated from a face without accurately being brought into tight contact with the face commonly arises from goggles, a gas mask, and a VR headset, including the mask. A nose and a peripheral portion thereof are further bent than other parts of the face, the skin at the nose and the peripheral portion thereof is thin, whereby almost no buffering action is performed, and the heights of the nose and the peripheral portion thereof are large, whereby it is difficult for the mask to be accurately brought into tight contact with the face. In addition, when a user breathes or speaks, leakage more easily occurs from the nose and the peripheral portion thereof due to motion of facial muscles.

In order to solve the above problem, a deformable elastic member is inserted into the portion of the mask corresponding to the nose and the peripheral portion thereof or is attached to the surface of the portion of the mask. However, the mask is still not accurately brought into tight contact with the face. Even if a metal, such as a wire, used for most masks is deformed such that the mask is temporarily brought into tight contact with the face, a gap is formed therebetween due to motion of facial muscles, since the mask has no supporting region. This problem is very simple and one would expect the problem to have already been solved. In fact, however, this problem has remained unsolved for a long time.

Motion of facial muscles due to conversation causes motion of the mask. When the mask must be worn for a long time due to COVID-19 or the like, the skin is injured due to friction between the ridge of the nose and the mask. In order to prevent injury to the skin due to such frequent friction, medical personnel, such as nurses, attach band-aids or plasters to the ridges of their noses and then wear masks thereon.

For a gas mask, an elastic sealing portion made of silicone strongly presses the nose and the peripheral portion thereof through a band configured to be disposed at the back of a head, whereby tight contact between the gas mask and the face is enhanced. However, force applied to the nose and the peripheral portion thereof is relatively strong, whereby long-term wearing is difficult. In addition, a mask mark is left on the face, whereby women avoid wearing of gas masks, which is a problem to be solved.

The mask and the gas mask are devices that block the flow of air, whereas blocking the flow of air and blocking the light are simultaneously required for a VR headset. If the nose and the peripheral portion thereof are not sealed when the VR headset is worn, concentration is lowered due to exposure to the light. All products released so far do not seriously consider such a problem and present incomplete technology of strongly pressing the face, like the gas mask, as a solution thereto.

Patent Document 7 relates to an inexpensive mask configured to prevent leakage of breathing gas, to select an optimum porous filter portion, to solve shortness of breath, and to provide a glasses spillage preventing function. The mask includes a fixing frame portion having excellent tight contact with the skin, a filter portion configured to be freely attached to and detached from the fixing frame portion, and a mounting portion configured to be fixed to the face, wherein the respective portions are made of different materials and have different functions. The part of the fixing frame portion that contacts the skin is provided with a notch, whereby the contact area of the fixing frame portion is increased by tensile force of the mounting portion, and a shape memory resin configured to contract due to the temperature of the skin or a skin adhesive resin is used as the material thereof. The upper side of the contact part is formed of an elastic resin configured to expand and contract in response to deformation of facial muscles and a skeleton due to conversation or change in facial expression. The filter portion may be separated from the fixing frame portion, and a mask capable of selecting a necessary material according to the purpose is provided.

Patent Document 8 relates to a mask including a nose sealing portion, wherein breathing gas is supplied under a positive pressure, the mask has an improved nose sealing portion capable of covering at least one of a nose or a mouth of a user, and the mask is provided with a first paddle and a second paddle.

Patent Document 9 relates to a mask having a nose pad attached thereto, wherein the mask includes a mask main body, a nose pad, and inner layer wrinkles. The mask main body includes an outer layer surface, an intermediate layer surface, and an inner layer surface, the nose pad is disposed on the outer layer surface, the inner layer wrinkles extend from the inner layer surface so as to be folded, the inner layer wrinkles and the outer layer surface simultaneously cover the nose pad, and a protrusion corresponding to the nose pad is formed on the mask main body.

Patent Document 10 relates to a tight contact mask having an elastic band, wherein a secondary tight contact portion having elasticity and flexibility is formed along an edge of a mask main body, the mask main body is provided at an inner upper part thereof with a nose pad configured to be brought into tight contact with the ridge of a nose from above while covering the ridge of the nose, lateral lower films extend downwards from opposite sides of the nose pad in the form of a closed curve so as to cover the vicinities of the nose and mouth, a primary tight contact portion made of an elastic and flexible material so as to be brought into tight contact with the skin is provided at an edge of each of the lateral lower films, and a separate elastic band having elasticity is provided at a position above one side of the secondary tight contact portion, whereby the force of tight contact of the nose pad 40 with the ridge of the nose is increased, and therefore it is possible to prevent upward outflow of internal air.

Patent Document 11 relates to a mask, wherein a cover is provided at an inner upper part thereof with a receiving recess configured to receive the ridge of a nose as the result of the ridge of the nose being introduced thereinto, and a sealing means is provided with protrusions configured to be inserted into spaces defined between the ridge of the nose and opposite cheekbones under eyes of a face at opposite sides of the receiving recess so as to be brought into tight contact with the skin.

Patent Document 12 relates to a mask capable of preventing gas from being introduced into the mask without being filtered through a filter sheet, wherein the mask includes a nose clip and/or a nose pad.

Patent Document 13 relates to a dust mask configured to prevent introduction of fine dust into a respiratory system, wherein the dust mask includes an upper cover unit having nose support portions formed on upper and lower end inner surfaces and a lower cover unit provided with a jaw support portion having an air discharge portion formed therein, whereby, when a user wears the mask, the nose support portions formed at the upper cover unit are brought into tight contact with the nose without separate manipulation, and therefore it is possible to easily wear the mask.

Patent Document 14 relates to an environmentally friendly traditional Korean paper mask, the mask including a mask main body 100 formed so as to correspond to the curvature of a face in order to shield a mouth and a nose and fixing strings 200 formed at opposite sides of the mask main body 100 so as to be held by the ears, wherein the inherent function of the Korean paper is provided, fine dust, contaminants, and various harmful bacteria are effectively filtered through adsorption, and breathability, warmth, quick drying, and antibiosis of the mask are excellent, whereby a comfortable state is maintained for a long time, and in particular the mask is less harmful to the human body, and therefore children or the elderly and infirm can use the mask in a relaxed state.

As described above, Patent Documents 7 to 14 disclose various means for tight contact between the mask and the nose including the peripheral portion thereof.

However, the conventional art has problems in that 1) the degree of tight contact is low even if the tight contact is temporarily achieved in the state in which the mask is worn, 2) the mask is disposed on the facial region in which the muscles of the user are inevitably moved, whereby the degree of tight contact is easily lowered due to motion of the facial muscles and the skin is injured due to frequent friction between the mask and the skin, such as the ridge of the nose, 3) the degree of tight contact is lowered due to vibration when the user moves in a state of wearing the mask or the VR headset without motion of the facial muscles, 4) the tight contact region, such as the nose pad, is configured to strongly press the nose region, whereby makeup of female users is removed, and therefore the female users avoid wearing of the masks, 5) for some gas masks, it is not possible to adjust the degree of pressure, and therefore only strong pressing is possible, 6) the degree of tight contact is changed depending on the degree of skill of users, and therefore incomplete tight contact is achieved for users who are not accustomed to adjustment of an apparatus or a mechanism, such as the elderly and infirm or children, and 7) when a face shield is additionally worn, it is still necessary to separately fix the face shield and the mask to the face.

A mask that is capable of being fixed by a second fixing region excluding ears and has an improved configuration for tight contact with a nose and a peripheral portion thereof has not been developed.
Korean Patent Registration No. 10-1773856 (“Patent Document 1”)
Korean Patent Registration No. 10-1954022 (“Patent Document 2”)
Korean Utility Model Registration No. 20-0490095 (“Patent Document 3”)
Japanese Unexamined Patent Publication No. 2004-267692 (“Patent Document 4”)
Japanese Unexamined Patent Publication No. 2018-145570 (“Patent Document 5”)
Japanese Patent Registration No. 4799884 (“Patent Document 6”)
Japanese Unexamined Patent Publication No. 2011-000430 (“Patent Document 7”)
Japanese Unexamined Patent Publication No. 2019-030698 (“Patent Document 8”)
Japanese Utility Model Registration No. 3222972 (“Patent Document 9”)
Korean Patent Registration No. 10-2012157 (“Patent Document 10”)
Korean Utility Model Laid-Open Publication No. 2011-0009652 (“Patent Document 11”)
Korean Utility Model Laid-Open Publication No. 2017-0000048 (“Patent Document 12”)
Korean Patent Laid-Open Publication No. 2017-0072094 (“Patent Document 13”)
Korean Patent Laid-Open Publication No. 2019-0032897 (“Patent Document 14”)
Bandaru S V, Augustine A M, Lepcha A, Sebastian S, Gowri M, Philip A, Mammen M D. The effects of N95 mask and face shield on speech perception among healthcare workers in the coronavirus disease 2019 pandemic scenario. J Laryngol Otol 2020; 134:895-898. https://doi.org/10.1017/S0022215120002108 (“Non-Patent Document 1”)

### DISCLOSURE

### Technical Problem

The present invention has been made in view of conventional problems, and it is an object of the present invention to provide a mask configured such that 1) detachment and attachment thereof are easy, 2) contact with the skin, including the face, during detachment and attachment thereof is minimized, 3) skin irritation is low even if the mask is worn for a long time, 4) discomfort due to pain in ears and other musculoskeletal systems is minimized, and 5) a pressed region is clearly specified and the region is optimized, whereby consistent fixing force is provided regardless of users.

In addition, it is another object of the present invention to provide a mask configured such that 1) the degree of tight contact with a face is high, 2) tight contact with the face is continuously maintained even when facial muscles are moved, 3) the degree of tight contact with the face is not lowered due to vibration generated when a user moves in a state of wearing the mask, 4) the region that is pressed for tight contact with the face is minimized, 5) the degree of pressure is easily adjusted depending on the height of a nose of the user, and 6) a predetermined level of tight contact can be provided to users who are not accustomed to adjustment of an apparatus or a mechanism, such as the elderly and infirm or children.

In addition, it is still another object of the present invention to provide a mask that exhibits a low leakage rate even when a single mask is used, provides excellent wearing sensation, and is capable of being easily manufactured.

### Technical Solution

In order to solve the above problems, the present invention provides a mask including a filter configured to cover vicinities of a nose and a mouth of a user and a frame unit coupled to the filter so as to be brought into tight contact with at least part of a first fixing region of the user to fix the filter to a face of the user,
wherein the first fixing region includes, among regions of the face of the user, at least one of
1) a 1-1^{st} fixing region corresponding to a lower facial region including a range from a position including a styloid process of the user to a premolar of the user in consideration of a movement range of a sagittal or anteroposterior axis and including a temporal process of the user in consideration of a movement range of a longitudinal or craniocaudal axis,
2) a 1-2^{nd} fixing region corresponding to a lower facial region including a range from a position including a parotid gland of the user to a region left by excluding a region in which a funiculus anterior is located from two branches of a medial pterygoid of muscles of mastication of the user in consideration of the movement range of the sagittal or anteroposterior axis and including the temporal process of the user in consideration of the movement range of the longitudinal or craniocaudal axis,
3) a 1-3^{rd} fixing region corresponding to a lower facial region including a range from a position including the styloid process of the user to a masseter muscle of the muscles of mastication of the user in consideration of the movement range of the sagittal or anteroposterior axis and including the temporal process of the user in consideration of the movement range of the longitudinal or craniocaudal axis, wherein a muscle belly is excluded, the muscle belly being the most protruding portion of the masseter muscle,
4) a 1-4^{th} fixing region corresponding to a lower facial region including a range from a front end of a tragus of the user to a region in which a rear surface of a zygomaticus major of the user is not pressed in consideration of the movement range of the sagittal or anteroposterior axis and including the temporal process of the user in consideration of the movement range of the longitudinal or craniocaudal axis,
5) a 1-5^{th} fixing region corresponding to a triangular region having a temple, an angle of mandible, and an inferior border of mandible of the user as vertices,
6) a 1-6^{th} fixing region corresponding to the interior of a square provided based on the face of the user,
wherein the square provided based on the face of the user is a square having the angle of mandible and a zygomatic process of the user as one surface, and the square provided based on the face of the user has the sagittal or anteroposterior axis and the longitudinal or craniocaudal axis as a width and a length, respectively, and a distance from the angle of mandible to the zygomatic process in the longitudinal or craniocaudal axis is a length of one side, or
7) a 1-7^{th} fixing region in which values of (x,y) provided based on the face of the user are (−1,−1), (1,−1), (2,−1), (3,−1), (4,−1), (−1,1), (1,1), (2,1), (3,1), (4,1), (5,1), (−1,2), (1,2), (2,2), (3,2), (−1,3), (1,3), (2,3), (−1,4), (1,4), (−1,5), (1,5), and (2,5),
wherein (x,y) provided based on the face of the user is a position based on coordinates of each of small squares formed when the width and the length of the square provided based on the face of the user are divided into five equal parts, wherein the x is designated as 1, 2, 3, 4, and 5 from a rear surface to a front surface of a head of the user, and the y is designated as 1, 2, 3, 4, and 5 from an upper surface to a lower surface of the head of the user,
wherein “x” of a small square further disposed in symmetry based on the longitudinal or craniocaudal axis of the rear surface of the head of the user in the square provided based on the face of the user is designated as a negative value, and “y” of a small square further disposed in symmetry based on a lateral axis of the upper surface of the head of the user in the square provided based on the face of the user is designated as a negative value, and
wherein “x” and “y” of a small square further disposed in symmetry based on apexes of the upper surface and the rear surface of the head of the user in the square provided based on the face of the user are designated as negative values.

The values of (x,y) provided based on the face of the user applied to the 1-6^{th} fixing region may be (1,1), (2,1), (3,1), (4,1), (1,2), (2,2), (3,2), (1,3), (1,4), (1,5), (2,5), (1,−1), and (−1,1), may be (2,2), (4,2), (1,3), (3,3), (4,3), (5,3), (1,4), (2,4), (3,4), (4,4), (5,4), (1,5), (2,5), (4,5), (5,5), (1,1), (1,−1), and (−1,1), or may be (2,1), (2,2), (1,3), (4,3), (5,3), (1,4), and (−1,1). The values of (x,y) provided based on the face of the user applied to the 1-6^{th} fixing region may preferably be (2,2), (1,3), (2,4), (1,5), (2,5), (1,1), (1,−1), and (−1,1), more preferably (2,2), (1,3), (1,−1), and (−1,1).

The values of (x,y) provided based on the face of the user applied to the 1-7^{th} fixing region may be (−1,−1) (1,−1), (2,−1), (3,−1), (4,−1), (−1,1), (1,1), (2,1), (−1,2), (−1,3), and (1,3).

The present invention provides a mask including a filter configured to cover vicinities of a nose and a mouth of a user, a frame unit disposed along an outer surface of the filter, and a fixing portion formed at each end of the frame unit to couple the frame unit to the filter, the fixing portion being brought into tight contact with at least part of a face of the user to fix the filter and the frame unit to the face of the user,
wherein the frame unit includes a pressing portion configured to press an outer surface of an upper filter surface corresponding to a part of the filter so that the upper filter surface is brought into tight contact with a skin of at least part of the nose of the user (including a lateral nasal cartilage, a major alar cartilage, and minor alar cartilages in FIGS. 22 to 24) and a skin of a peripheral portion of the nose, and
wherein the pressing portion presses
1) a surface of the upper filter surface, opposite a skin of the user, against a first pressed region corresponding to at least part of a nasolabial fold region of the user so that the upper filter surface is brought into tight contact with the skin of the user,
2) a surface of the upper filter surface, opposite a skin of the user, against a second pressed region corresponding to at least part of a levator labii superioris (refer to FIGS. 23 and 24) or a levator labii superioris alaeque nasi (refer to FIG. 24) of the user so that the upper filter surface is brought into tight contact with the skin of the user, or
3) a surface of the upper filter surface, opposite a skin of the user, against a third pressed region corresponding to at least part of an outer periphery of each of alar creases of the user so that the upper filter surface is brought into tight contact with the skin of the user.

The pressing portion may bring the upper filter surface into tight contact with the skin of the user, and may simultaneously allow the mask to be supported by the face of the user.

The filter may include a filter main body disposed on a front surface of the face of the user in a curved shape, an upper filter surface fixed along at least part of an outer periphery of an upper portion of the filter main body, fixed while being spaced downwards apart from at least part of the outer periphery of the upper portion of the filter main body, or formed as a result of the upper portion of the filter main body being bent to cover a skin of at least part of the nose of the user and a skin of a peripheral portion of the nose, a lower filter surface fixed along at least part of an outer periphery of a lower portion of the filter main body, fixed while being spaced upwards apart from at least part of the outer periphery of the lower portion of the filter main body, or formed as a result of a lower surface of the filter main body being bent to cover a skin of at least part of a chin of the user and a skin of a peripheral portion of the chin, and a side filter surface formed at each of opposite sides of the filter main body so as to be coupled to the frame unit.

The side filter surface may extend from the filter main body, and may be made of the same material as the filter main body. The side filter surface may be provided with a reinforcing portion.

The upper filter surface and/or the lower filter surface may be provided at opposite sides thereof with one or more first coupling portions fixed to the filter main body, and the first coupling portions may have a detachable coupling structure. The upper filter surface and/or the lower filter surface may be provided at a middle portion thereof with one or more second coupling portions fixed to the filter main body, and the second coupling portions may have a detachable coupling structure. The detachable coupling structure may be configured such that coupling portions are detached from each other without damage to the filter main body, the upper filter surface, and the lower filter surface. As another example, the detachable coupling structure may be at least one selected from the group consisting of Velcro tape, snap buttons, and clips. A range within which the upper filter surface can be disposed may be between tip-defining points and a lower end of the nasal bone.

When the first coupling portions and the second coupling portions are disposed along the outer peripheries of the upper filter surface and the lower filter surface, strength in tight contact is high. Even if a portion of the upper filter surface or the lower filter surface is damaged at the time of detachment, therefore, there is no problem. In this case, tight contact with the face of the user is achieved by the remaining portion of the upper filter surface or the lower filter surface, since the damaged portion of the upper filter surface or the lower filter surface is the outermost portion of the upper filter surface or the lower filter surface.

The upper filter surface or the lower filter surface may be provided with separate wrinkles formed at positions corresponding to the first coupling portions or the second coupling portions. The wrinkles may be curved along the contour line of the face, particularly the contour line of the jaws, rather than being straight.

The frame unit may include a frame main body disposed on an upper surface of the upper filter surface in a semicircular band shape and a coupling portion extending from each of opposite ends of the frame main body so as to be coupled to the side filter surface. The frame main body may be provided with a connecting portion disposed at a middle of the frame main body to allow the frame main body to be folded.

At least a portion of the frame main body may be coupled to at least one of the filter main body, the upper filter surface, or the lower filter surface. At least a portion of the frame main body may be coupled to at least one of an inner surface or an outer surface of at least one of the filter main body, the upper filter surface, or the lower filter surface.

The coupling portion may include a fixing portion configured to be directly brought into tight contact with the first fixing region, and the fixing portion may be provided with a fixing portion cover coupled to an outer surface thereof.

The side filter surface may be coupled to at least one of one surface of the fixing portion or one surface of the fixing portion cover, or may be disposed between the fixing portion and the fixing portion cover.

The fixing portion may have a ring shape, and may include an elastic member containing silicone.

The filter may be provided with a separate protective layer disposed on an outer surface thereof, and the protective layer may be fixed to at least one of the filter or the frame unit. In addition, the protective layer may be made of at least one material selected from among a fiber, a polymer resin, and metal, and may be translucent or opaque. The metal may be formed in a plate or mesh shape.

The mask according to the present invention may further include an auxiliary fixing portion using an auxiliary fixing region located on at least one of a nose, a chin, each ear, a mastoid bone, a back of a neck, or a parietal bone or occipital bone of a head.

The pressing portion may protrude upwards from the frame main body, may be coupled to an upper surface of the frame main body, or may be a part of the frame main body. The pressing portion may be made of an elastic material.

The pressing portion may include a pressing region having at least one of a dot shape, a line shape, or a plane shape. The pressing portion may include at least one pressing region. The pressing portion may include a pressing region having fine protrusions.

The direction in which the pressing portion presses the outer surface of the upper filter surface may be a direction perpendicular to the skin of the user, a direction of wrinkles formed on the face of the user, a direction perpendicular to wrinkles formed on the face of the user, a direction extending along the outer periphery of the nose of the user, a direction oriented toward or away from the outer periphery of the nose of the user, a direction of muscles around the nose of the user, or a complex combination of the above directions.

The pressing portion may have at least one of a dot shape, a line shape, a plane shape, or a solid shape, and the upper filter surface may be provided on an outer surface thereof or in an interior thereof with a clip configured to be changeable in shape.

Meanwhile, in the mask according to the present invention, the filter and the frame unit may be made of the same or similar materials. For example, the filter and the frame unit may be made of the same or similar polymer materials. As a concrete example, all of the parts including the filter and the frame unit may be made of PP or PE. Alternatively, the filter may be made of PE, and the frame unit may be made of PP. Although the materials of the filter and the frame unit are the same as or similar to each other, detailed processes for forming the filter and the frame unit may be different so that the filter and the frame unit carry out their inherent functions.

The filter may be implemented as at least one of a double folding type filter, a foldable filter, or a cup mask type filter.

In addition, the present invention may provide all possible combinations of the above solving means.

### Advantageous Effects

As described above, the present invention may provide a mask configured to be fixed to a face by pressing a specific region of a face. Compared to the conventional mask, the mask according to the present invention is characterized in that 1) detachment and attachment thereof are easy, 2) contact with the skin, including the face, during detachment and attachment thereof is minimized, 3) skin irritation is low even if the mask is worn for a long time, 4) discomfort due to pain in ears and other musculoskeletal systems is minimized, 5) a pressed region is clearly specified and the region is optimized, whereby consistent fixing force is provided regardless of users, and 6) physical force for the ears is not applied to the specific region of the face that is pressed in the present invention, as previously described, whereby there are no problems of stress due to long-term wearing and concentration weakening.

In addition, the present invention is provided with a pressing portion to prevent fogging of glasses, which is an unsolved chronic problem of the conventional mask. The mask according to the present invention is capable of increasing the degree of tight contact with the nose and a peripheral portion thereof while minimizing pressure, thereby achieving effects that the conventional mask is not capable of achieving. Specifically, the mask of the present invention is configured such that 7) the degree of tight contact with a nose is high, 8) tight contact with the nose is continuously maintained and friction therewith is minimized even when facial muscles are moved, 9) the degree of tight contact is not lowered due to vibration generated when a user moves in a state of wearing the mask, 10) a region that is pressed for tight contact is minimized, 11) the degree of pressure is easily adjusted depending on the height of the nose of the user, and 12) a predetermined level of tight contact can be provided to users who are not accustomed to adjustment of an apparatus or a mechanism, such as the elderly and infirm or children.

The present invention may provide a mask including coupling portions, wherein detachment of the coupling portions is adjusted so as to correspond to the face of an individual user, whereby it is possible to provide a mask having a low leakage rate and excellent wearing sensation. In addition, a process of adding the coupling portions may be configured by modifying only some of a conventional process while the conventional process is basically applied as is. Consequently, addition of the above construction is easy and economical. Meanwhile, variously sized masks corresponding to sizes and shapes of faces of users are not provided, whereby limited variety production is achieved, and therefore a possibility of occurrence of surplus products is low. This is also very desirable in environmental terms in that resource utilization is more effective and it is possible to reduce mask waste.

### DESCRIPTION OF DRAWINGS

FIG. 1 is a schematic view showing positions at which pain depending on wearing of a mask was observed.

FIG. 2 is a side view of a skull including a styloid process.

FIG. 3 is an anatomical diagram simultaneously showing a skeleton and a muscle in order to simultaneously show a temporal process and a medial pterygoid.

FIG. 4 is an anatomical diagram simultaneously showing a skeleton and a muscle in order to simultaneously show muscles of mastication and a medial pterygoid.

FIG. 5 is an anatomical diagram simultaneously showing a skeleton and a muscle in order to simultaneously show a zygomaticus major and a medial pterygoid.

FIG. 6 is an anatomical diagram for showing a 1-5^{th} fixing region.

FIG. 7 is a view including a square and small squares formed by dividing the interior of the square provided based on a face of a user having an angle of mandible and a zygomatic process as one surface.

FIG. 8 is a schematic view showing values of (x,y) provided based on the face of the user according to the present invention.

FIG. 9 is an illustrative photograph showing that the square provided based on the face of the user including the small squares on the face of the user is actually applied to the face of a person in order to conduct an experiment.

FIG. 10 is a schematic view of an apparatus configured to measure a PPT.

FIG. 11 is a view showing experimental results on a PPT for a 1-6^{th} fixing region according to a first embodiment of the present invention.

FIG. 12 is a view showing experimental results on a VAS for the 1-6^{th} fixing region according to the first embodiment of the present invention.

FIG. 13 is a view showing analysis results on a PPT/VAS for the 1-6^{th} fixing region according to the first embodiment of the present invention.

FIG. 14 is a view showing experimental results on a PPT for a 1-7^{th} fixing region according to a second embodiment of the present invention.

FIG. 15 is a view showing an apparatus configured to measure the degree of fixing when a frame unit is fixed to a specific region of an actual user at a specific pressure.

FIG. 16 is a view showing a frame unit having a pressing portion added thereto.

FIG. 17 is a photograph showing that the pressing portion is located above alar creases, on the alar creases, and under the alar creases.

FIG. 18 is a view showing experimental results on a pressure at which pain is felt in the state in which (−1,1) and (1,−1) are added to the 1-6^{th} fixing region.

FIG. 19 is a view showing results of a “Verbal” experiment performed to measure the degree of fixing in the state in which (−1,1) and (1,−1) are added to the 1-6^{th} fixing region.

FIG. 20 is a view showing results of a “Flexion” experiment performed to measure the degree of fixing in the state in which (−1,1) and (1,−1) are added to the 1-6^{th} fixing region.

FIG. 21 is a view showing results of a “Walking” experiment performed to measure the degree of fixing in the state in which (−1,1) and (1,−1) are added to the 1-6^{th} fixing region.

FIGS. 22 to 24 are schematic anatomical diagrams showing a face on which first to third pressed regions according to the present invention can be disposed.

FIGS. 25 to 27 are photographs showing that a pressing portion, which is capable of pressing a first pressed region to a third pressed region according to the present invention in the state in which a fitting function of a conventional mask (KF94) is not used, is manufactured in a shape of a metal clip and then is worn in order to measure an official leakage rate of the mask according to the present invention.

FIG. 28 is a photograph showing that an elastic member configured to be fixed to only left and right parts of a face of a user in order to check displacement depending on whether the pressing portion according to the present invention is provided and then the elastic member is worn in order to track change in position of the elastic member at a peripheral portion of a nose using a motion sensor.

FIG. 29 is a view showing results of observation of positional displacement in FIG. 28.

FIG. 30 is an exploded perspective view of a mask 100 according to a first embodiment of the present invention.

FIG. 31 illustrates a perspective view, a front view, a left view, and a top view of the mask 100 according to the first embodiment of the present invention.

FIG. 32 is an exploded perspective view of a mask 200 according to a second embodiment of the present invention.

FIG. 33 is an exploded perspective view of a mask 300 according to a third embodiment of the present invention.

FIGS. 34 to 39 show various examples of a structure in which a frame main body according to the present invention is coupled to an outer surface of the mask.

FIGS. 40 to 45 show various examples of a structure in which the frame main body according to the present invention is coupled to an inner surface of the mask.

FIGS. 46 to 49 show various examples of the pressing portion of the present invention.

FIG. 50 shows an example of a clip according to an embodiment of the present invention.

FIG. 51 is a schematic view of a structure in which an additional external screen is provided on an outer surface of a mask according to an embodiment of the present invention.

FIGS. 52 and 53 show two examples of the shape of a first coupling portion and/or a second coupling portion according to the present invention.

FIG. 54 shows various modified examples of a fixing portion according to the embodiment of the present invention.

FIGS. 55 to 120 show various examples of the pressing portion according to the present invention.

FIGS. 121 to 126 show various examples of a 1-5^{th} fixing region and a fixing portion of the mask according to the present invention that presses the corresponding fixing region.

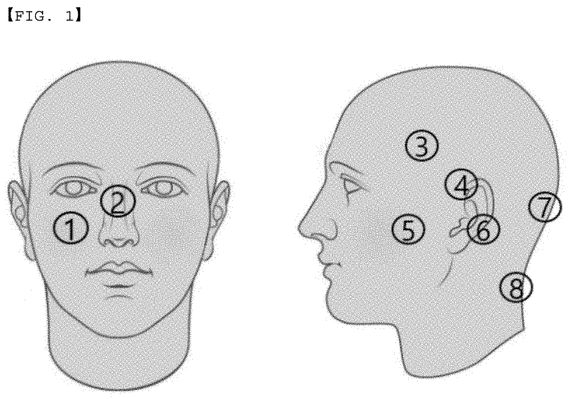

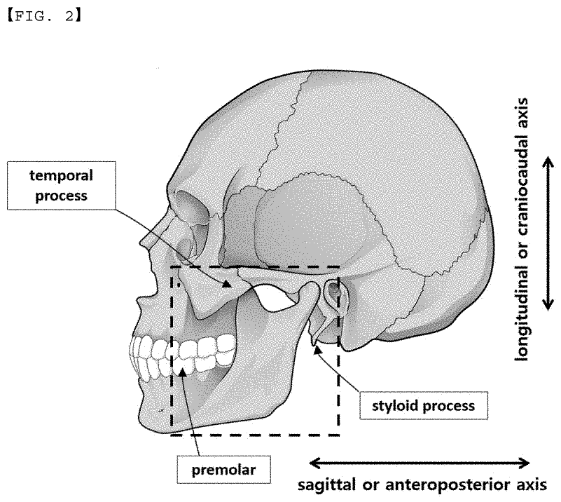

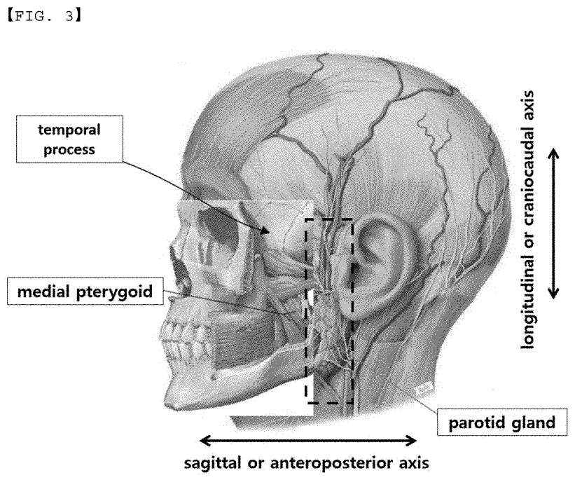

### BEST MODE

Now, preferred embodiments of the present invention will be described in detail with reference to the accompanying drawings such that the preferred embodiments of the present invention can be easily implemented by a person having ordinary skill in the art to which the present invention pertains. In describing the principle of operation of the preferred embodiments of the present invention in detail, however, a detailed description of known functions and configurations incorporated herein will be omitted when the same may obscure the subject matter of the present invention.

In addition, the same reference numbers will be used throughout the drawings to refer to parts that perform similar functions or operations. In the case in which one part is said to be connected to another part throughout the specification, not only may the one part be directly connected to the other part, but also, the one part may be indirectly connected to the other part via a further part. In addition, that a certain element is included does not mean that other elements are excluded, but means that such elements may be further included unless mentioned otherwise.

Hereinafter, the present invention will be described in detail through the embodiments. However, the embodiments are provided in order to illustratively describe the present invention, and the scope of the present invention is not limited by the embodiments.

Hereinafter, various embodiments of the present invention will be described with reference to the drawings.

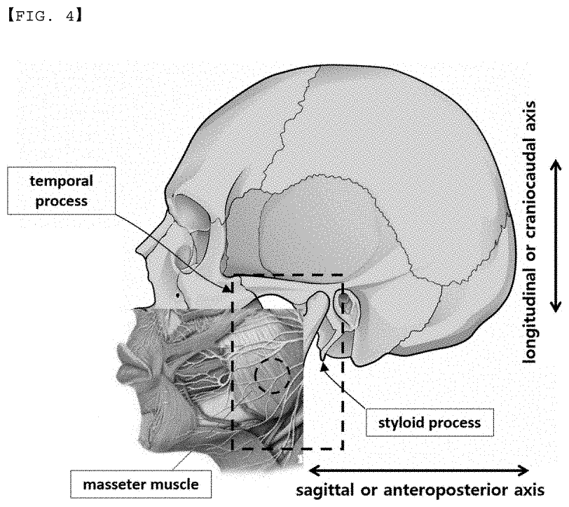

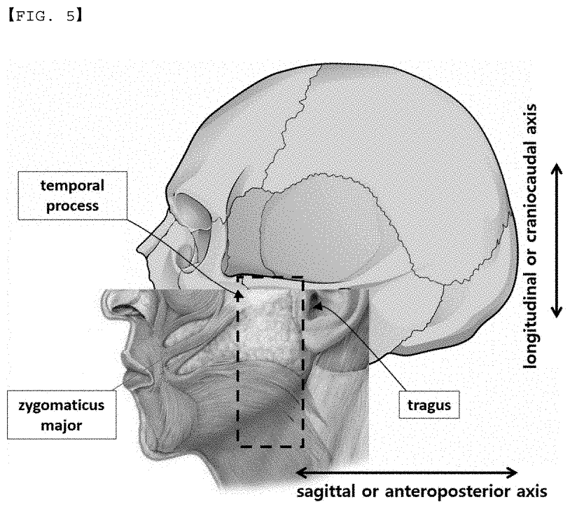

FIGS. 2 to 8 are anatomical diagrams for showing a first fixing region according to the present invention.

A fixing region according to FIG. 2 is a lower facial region including a range from a position including a styloid process of a user to a premolar of the user in consideration of a movement range of a sagittal or anteroposterior axis and including a temporal process of the user in consideration of a movement range of a longitudinal or craniocaudal axis.

Here, the sagittal or anteroposterior axis corresponds to an x-axis or a lateral axis in FIGS. 2 to 7, and the longitudinal or craniocaudal axis corresponds to a y-axis in FIGS. 2 to 7. Specifically, a dotted region illustrated in FIG. 2 may be a 1-1^{st} fixing region according to the present invention.

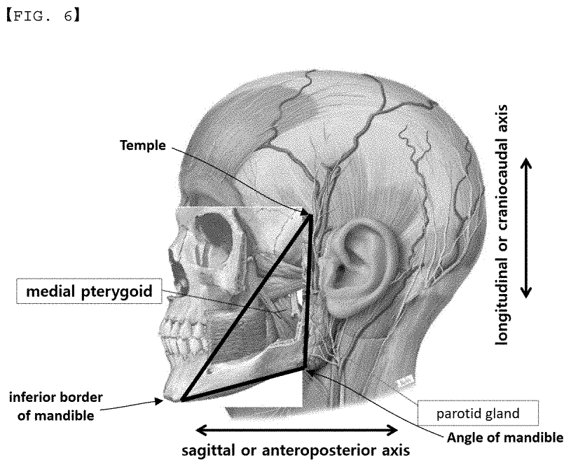

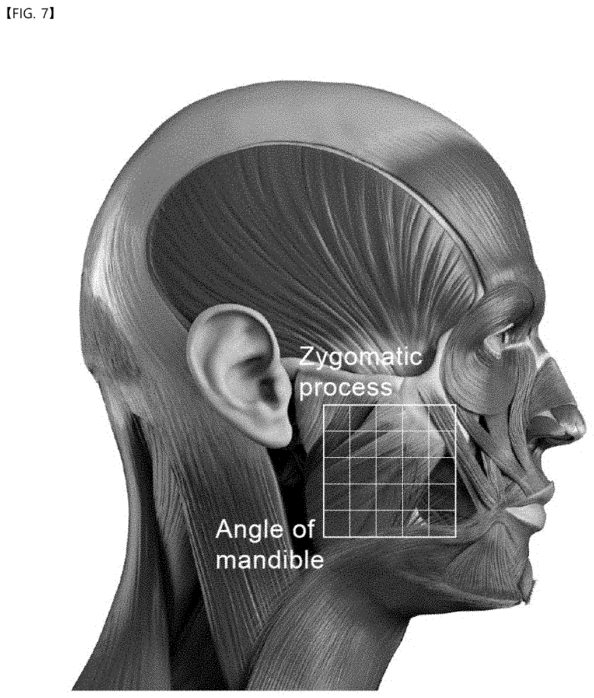

A 1-2^{nd} fixing region according to FIG. 3 is a lower facial region including a range from a position including a parotid gland of the user to a region left by excluding a region in which a funiculus anterior is located from two branches of a medial pterygoid of muscles of mastication of the user in consideration of the movement range of the sagittal or anteroposterior axis and including the temporal process of the user in consideration of the movement range of the longitudinal or craniocaudal axis. When compared to FIG. 2, the same movement range of the longitudinal or craniocaudal axis is provided, and there is a difference in that the fixing region includes the range from the position including the parotid gland of the user to the region left by excluding the region in which the funiculus anterior is located from the two branches of the medial pterygoid of the muscles of mastication of the user in consideration of the movement range of the sagittal or anteroposterior axis.

In FIG. 3, two medial pterygoids are finally designated, and a portion corresponding to the front of the face is a region in which the funiculus anterior is located, which is excluded. A dotted region illustrated in FIG. 3 may be the 1-2^{nd} fixing region according to the present invention.

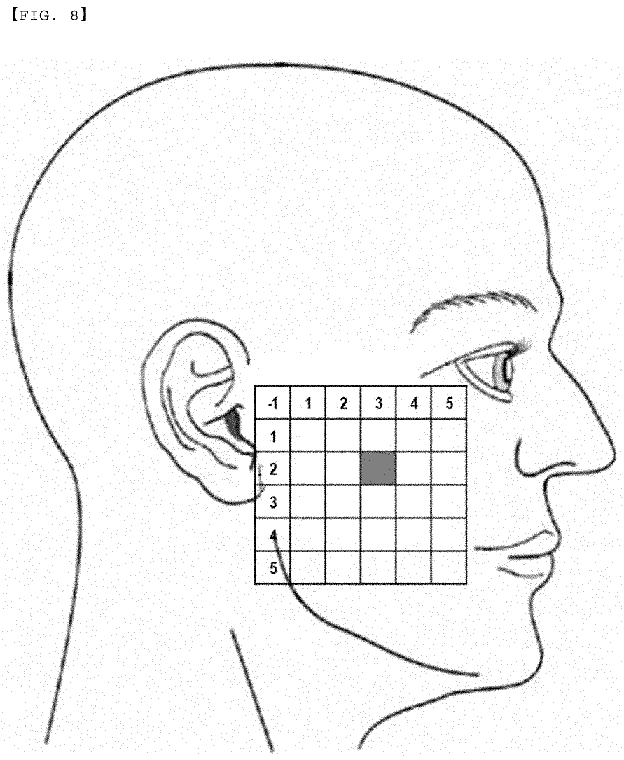

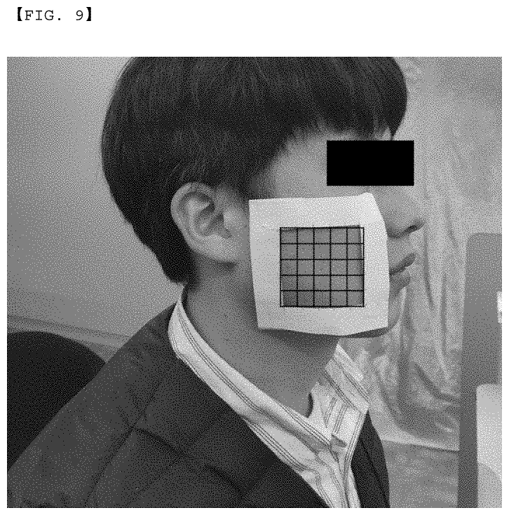

A 1-3^{rd} fixing region according to FIG. 4 is a lower facial region including a range from the position including the styloid process of the user to a masseter muscle of the muscles of mastication of the user in consideration of the movement range of the sagittal or anteroposterior axis and including the temporal process of the user in consideration of the movement range of the longitudinal or craniocaudal axis, wherein a muscle belly, which is the most protruding portion of the masseter muscle, is excluded. An apparatus fixed to a face having the above characteristics is provided.

In FIG. 4, the masseter muscle of the muscles of mastication is included; however, the user may easily feel pain in the muscle belly, which is the most protruding portion of the masseter muscle, when pressure is applied thereto, and therefore it is preferable to exclude the muscle belly.

A quadrangular dotted region illustrated in FIG. 4 excluding a circular dotted region is a preferable region of the 1-3^{rd} fixing region according to the present invention.

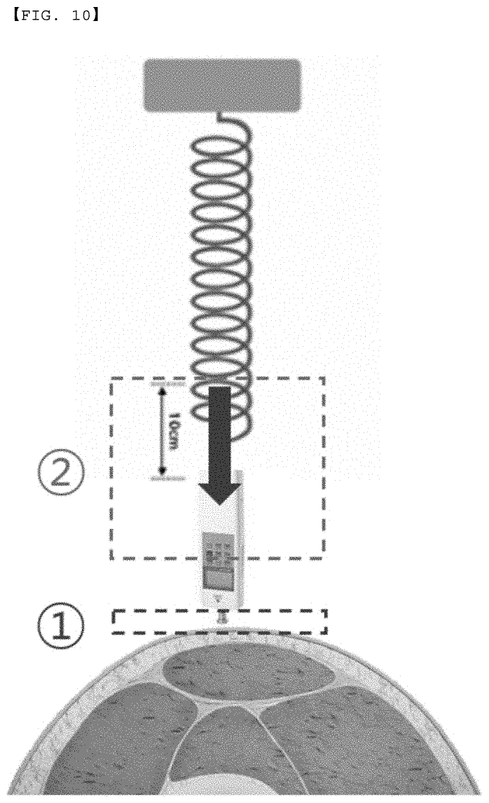

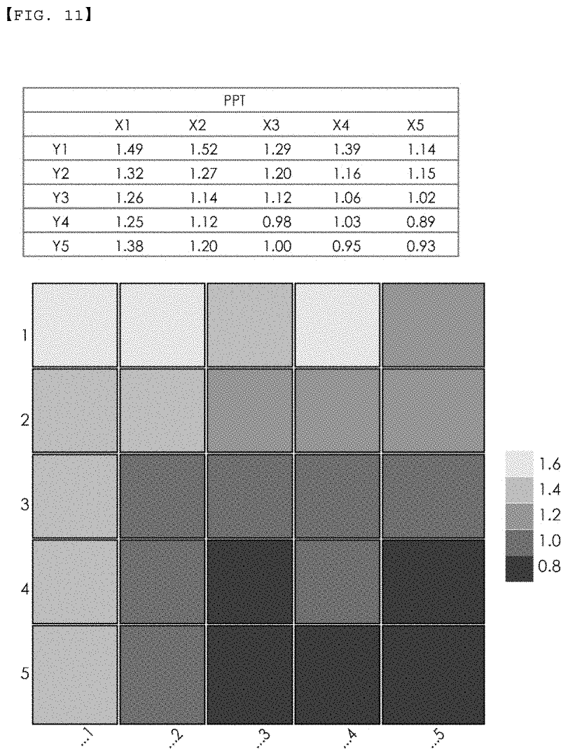

A 1-4^{th} fixing region according to FIG. 5 is a lower facial region including a range from a front end of a tragus of the user to a region in which a rear surface of a zygomaticus major of the user is not pressed in consideration of the movement range of the sagittal or anteroposterior axis and including the temporal process of the user in consideration of the movement range of the longitudinal or craniocaudal axis.

A dotted region illustrated in FIG. 5 may be the 1-4^{th} fixing region according to the present invention.

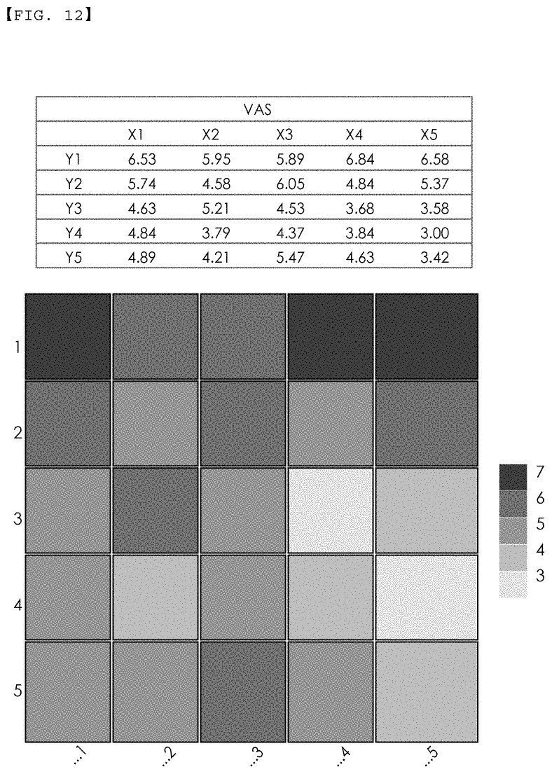

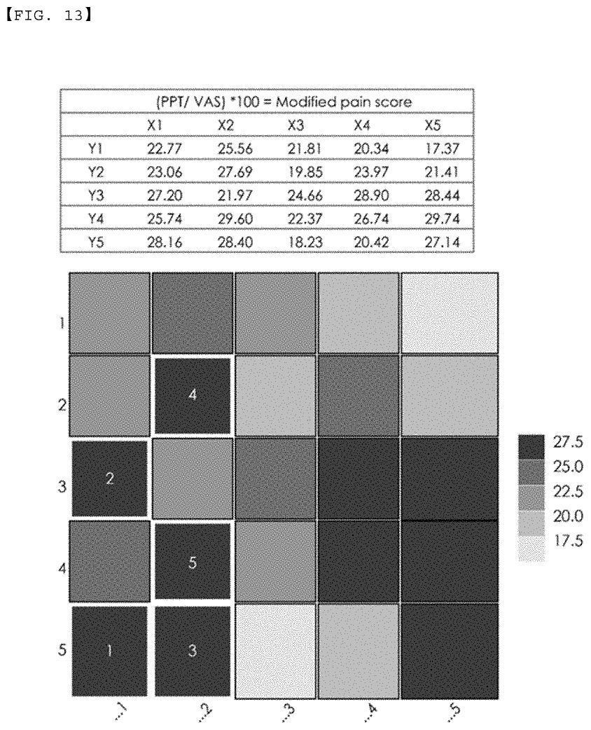

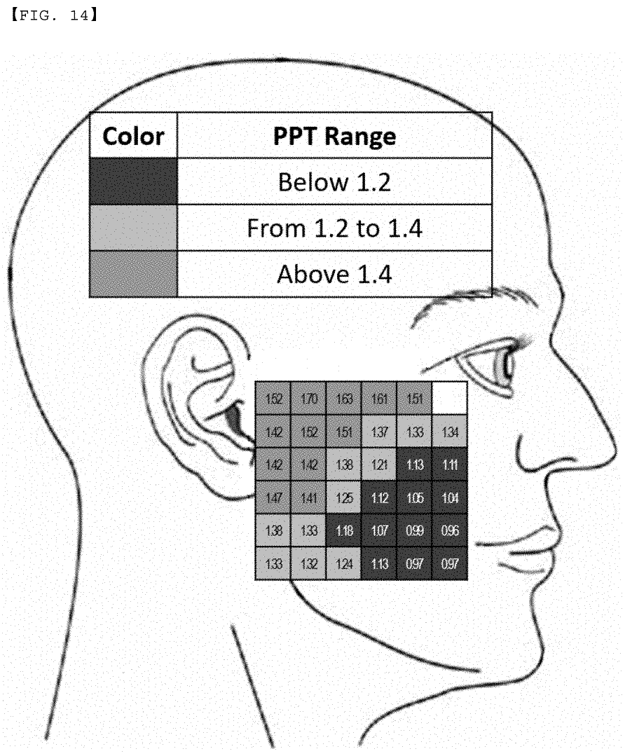

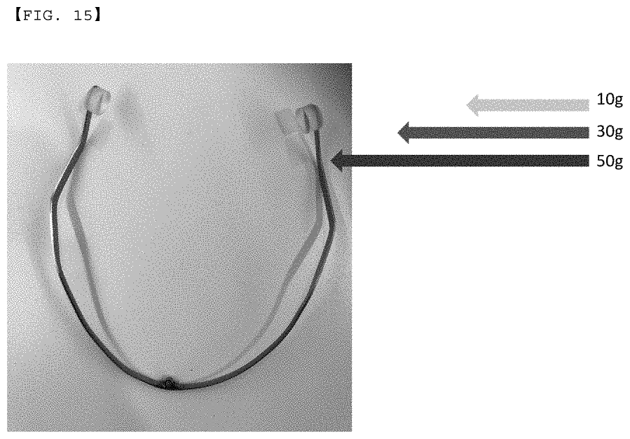

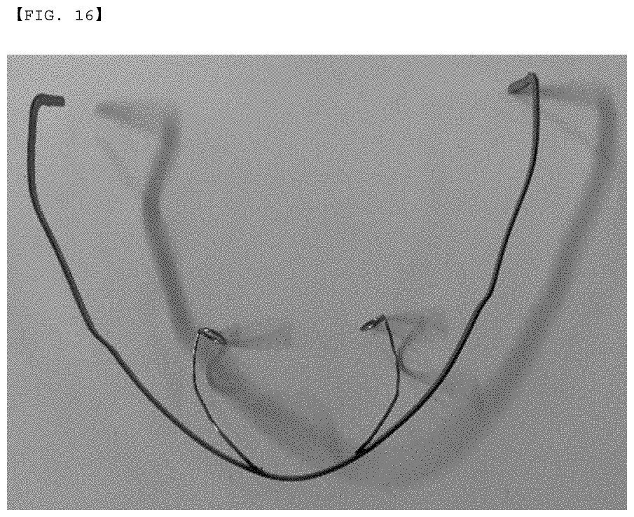

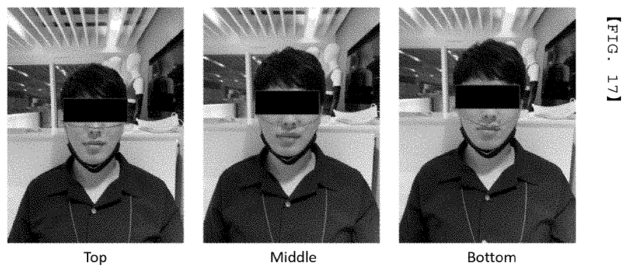

FIG. 6 shows a 1-5^{th} fixing region according to the present invention, FIG. 7 shows a 1-6^{th} fixing region according to the present invention, and FIG. 8 shows 1-8^{th} fixing region according to the present invention.

The 1-5^{th} fixing region according to FIG. 6 is a triangular region having a temple, an angle of mandible, and an inferior border of mandible of the user as vertices.

FIG. 7 is a view including a square and small squares formed by dividing the interior of the square provided based on the face of the user having the angle of mandible and the zygomatic process as one surface, wherein the largest square including 25 small squares may be the 1-6^{th} fixing region according to the present invention.

FIG. 8 shows a 1-7^{th} fixing region according to the present invention, which is an extension of the 1-6^{th} fixing region, wherein values of (x,y) provided based on the face of the user applied to the 1-6^{th} fixing region and the 1-7^{th} fixing region are shown.

The values of (x,y) provided based on the face of the user applied to the 1-6^{th} fixing region may be (1,1), (2,1), (3,1), (4,1), (1,2), (2,2), (3,2), (1,3), (1,4), (1,5), (2,5), (1,−1), and (−1,1), may be (2,2), (4,2), (1,3), (3,3), (4,3), (5,3), (1,4), (2,4), (3,4), (4,4), (5,4), (1,5), (2,5), (4,5), (5,5), (1,1), (1,−1), and (−1,1), or may be (2,1), (2,2), (1,3), (4,3), (5,3), (1,4), (2,4), (4,4), (5,4), (1,5), (2,5), (5,5), (1,1), (1,−1), and (−1,1). The values of (x,y) provided based on the face of the user applied to the 1-6^{th} fixing region may preferably be (2,2), (1,3), (2,4), (1,5), (2, 5), (1, 1), (1, −1), and (−1, 1), more preferably (2, 2), (1,3), (1,−1), and (−1,1).

The values of (x,y) provided based on the face of the user applied to the 1-7^{th} fixing region are (−1,−1), (1,−1), (2,−1), (3,−1), (4,−1), (−1,1), (1,1), (2,1) (−1,2), (1,2), (−1,3), and (1,3).

Here, the square provided based on the face of the user is a square having the angle of mandible and the zygomatic process of the user as one surface, wherein the square provided based on the face of the user has the sagittal or anteroposterior axis and the longitudinal or craniocaudal axis as a width and a length, respectively, and the distance from the angle of mandible to the zygomatic process in the longitudinal or craniocaudal axis is the length of one side.

Here, (x,y) provided based on the face of the user is the position of each small square formed when the width and the length of the square provided based on the face of the user are divided into five equal parts, wherein “x” is designated as 1, 2, 3, 4, and 5 from a rear surface to a front surface of the head of the user, and “y” is designated as 1, 2, 3, 4, and 5 from an upper surface to a lower surface of the head of the user.

“x” of the small square of the square provided based on the face of the user, which is further disposed in symmetry based on the longitudinal or craniocaudal axis of the rear surface of the head of the user, is designated as a negative value, “y” of the small square of the square provided based on the face of the user, which is further disposed in symmetry based on the lateral axis of the upper surface of the head of the user, is designated as a negative value, and “x” and “y” of the small square of the square provided based on the face of the user, which is further disposed in symmetry based on apexes of the upper surface and the rear surface of the head of the user, are designated as negative values.

FIG. 7 shows a square provided based on the face of the user having the angle of mandible and the zygomatic process of the user as one surface, wherein the square provided based on the face of the user has the sagittal or anteroposterior axis and the longitudinal or craniocaudal axis as a width and a length, respectively, and the distance from the angle of mandible to the zygomatic process in the longitudinal or craniocaudal axis is the length of one side. The square provided based on the face of the user shown in FIG. 6 includes small squares obtained by dividing the width and the length of the square into five equal parts, respectively.

FIG. 8 is a schematic view illustrating values of (x,y) provided based on the face of the user according to the present invention. In FIG. 8, the square parts having no numbers are identical to the square provided based on the face of the user shown in FIG. 7. In FIG. 8, the numbers shown at the upper end along the lateral axis indicate x-values, among the values of (x,y) provided based on the face of the user, and the numbers shown in the longitudinal or craniocaudal axis indicate y-values, among the values of (x,y) provided based on the face of the user. A portion denoted by −1 has an x-value of −1 and a y-value of −1, and (x,y) provided based on the face of the user is (−1,−1). The values of (x,y) of the portions denoted by −1, 1, 2, 3, 4, and 5 in the lateral axis based on the face of the user correspond to (−1,−1), (1,−1), (2,−1), (3, −1), (4, −1), and (5, −1), and the values of (x,y) of the portions denoted by −1, 1, 2, 3, 4, and 5 in the longitudinal or craniocaudal axis based on the face of the user correspond to (−1,−1), (−1,1), (−1,2), (−1,3), (−1,4), and (−1,5). The other portions denoted by no numbers are combinations of x-values and y-values. For example, in FIG. 8, the value of (x,y) of the colored portion based on the face of the user is (3,2).

The following experiments were conducted in order to present definite criteria for user discomfort and fixing force depending on specific positions of the fixing regions.

<First Experiment: Measurement of Fixing Force in 1-6^{th} Fixing Region>

The pressure at which the user feels pain (PPT) and the pain that the user feels under fixed pressure (VAS) were measured for the coordinates of values of (x,y) provided based on the face of the user shown in FIG. 7.

The reason why the pressure at which the user feels pain and the pain that the user feels under fixed pressure are separately measured is that, when pressure is increased, fixing force may be secured but the user may feel pain, or the user may feel no pain but fixing force may not be secured, depending on whether a muscle exists based on the position of the face of the user, the position of a skeleton, and the thickness of the skin.

The pressure pain threshold (PPT) of the user was measured for the coordinates of values of (x,y) provided based on the face of the user shown in FIG. 7. In this experiment, the pressure pain threshold (PPT) was defined as the maximum pressure value at which the user could endure pain.

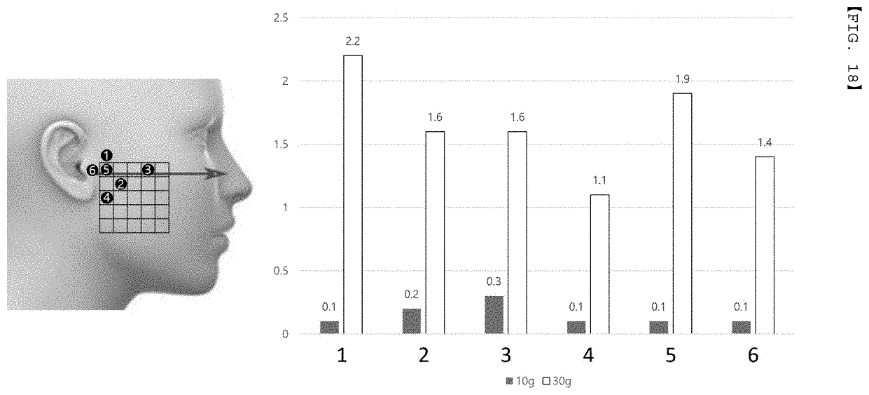

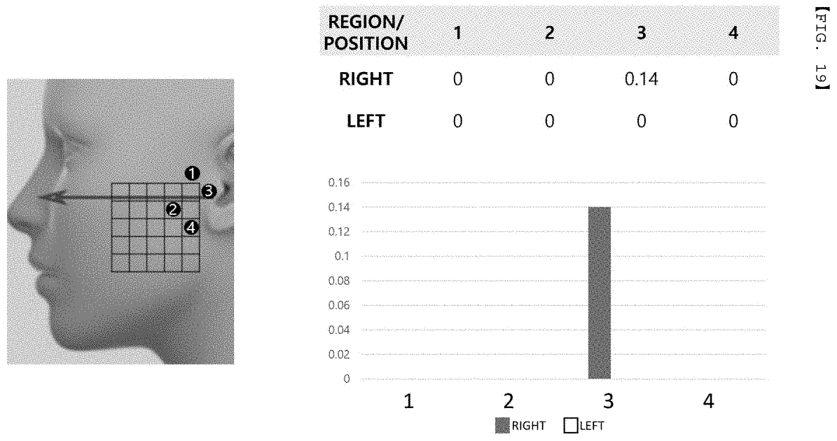

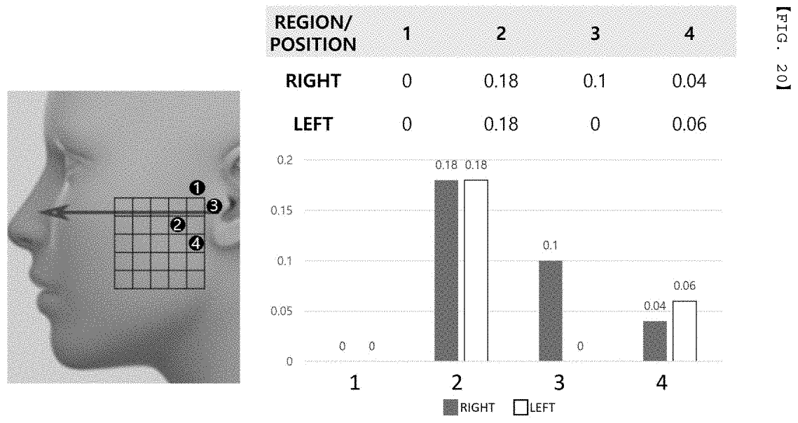

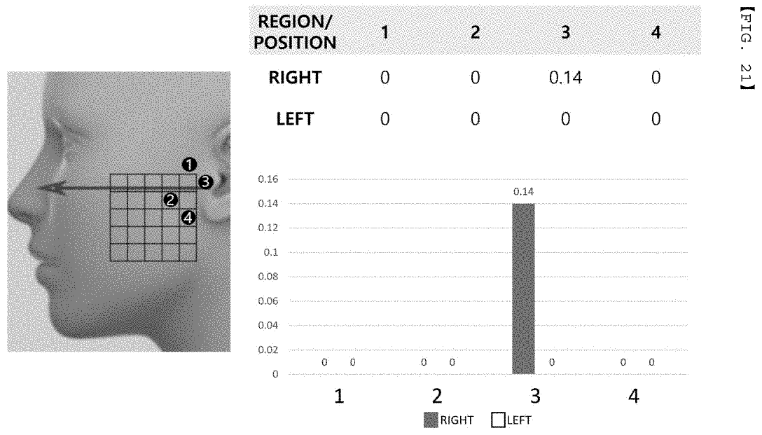

FIG. 9 is an illustrative photograph showing that the square including the small squares on the face of the user is actually applied to the face of a person in order to conduct the experiment, and FIG. 10 is a schematic view of an apparatus configured to measure the PPT.

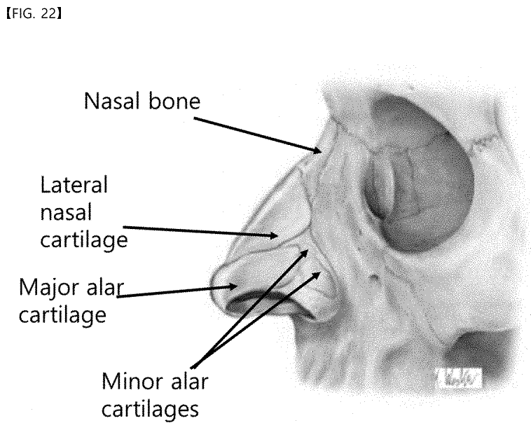

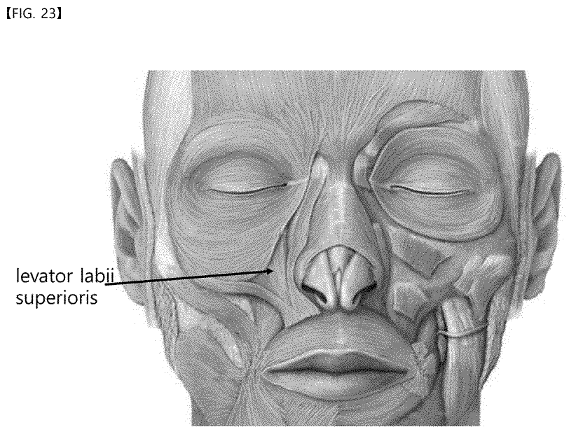

In order to measure distribution in pressure at which the user felt pain, the pressure at which the user felt pain (pressure pain threshold: PPT) was measured using an algometer. The pressure pain threshold (PPT) was measured on a small square area corresponding to each of the values of (x,y) provided based on the face of the user according to the present invention located on a surface of a face of a subject using a PPT instrument. The unit of pressure at which the pain is felt is kg/cm². Pressure values at which pain started to be felt were input to the respective coordinates, and the results of conversion of the pressure values into relative colors are shown in FIG. 11. The results shown in FIG. 11 are the averages of the values measured for 19 people. In FIGS. 11, 12, and 13, upper tables show measured values depending on the positions of (x,y) provided based on the face of the user shown in FIG. 7, and lower graphs show the measured values using different colors. 1 to 5 marked at the square of each lower graph in the longitudinal axis correspond to y-values of the coordinates of values of (x,y) provided based on the face of the user, and 1 to 5 marked at the square of each lower graph in the lateral axis correspond to x-values of the coordinates of values of (x,y) provided based on the face of the user.

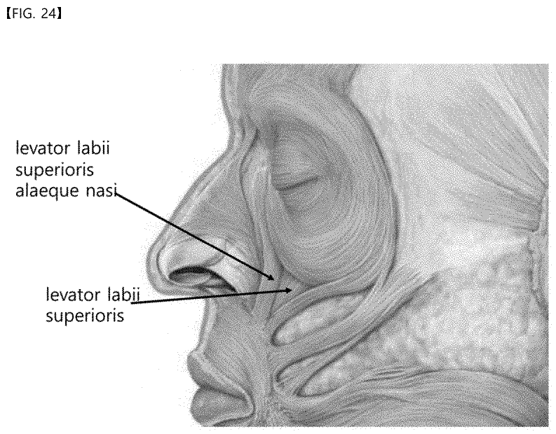

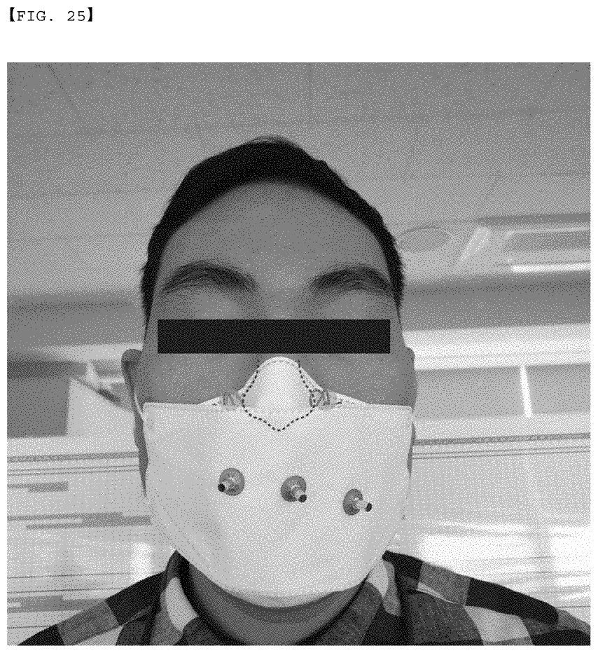

In order to measure distribution in pain that was felt under fixed pressure, discomfort scores (VAS) of the subject were measured using an algometer connected to the coordinates of the respective small squares via a spring in the state in which uniform tension was maintained. The pressure was fixed at 1 kg/cm², discomfort scores were input to the respective coordinates, and the results of conversion of the input values into relative colors are shown in FIG. 12. A visual analog scale (VAS) is a method of setting the pain that patients perceive to levels ranging from 0 indicating “no pain” to 10 indicating “extreme pain” and directly displaying the level of pain for each patient, which is one of pain evaluation scales. The results shown in FIG. 12 are the averages of the values measured for 19 people.

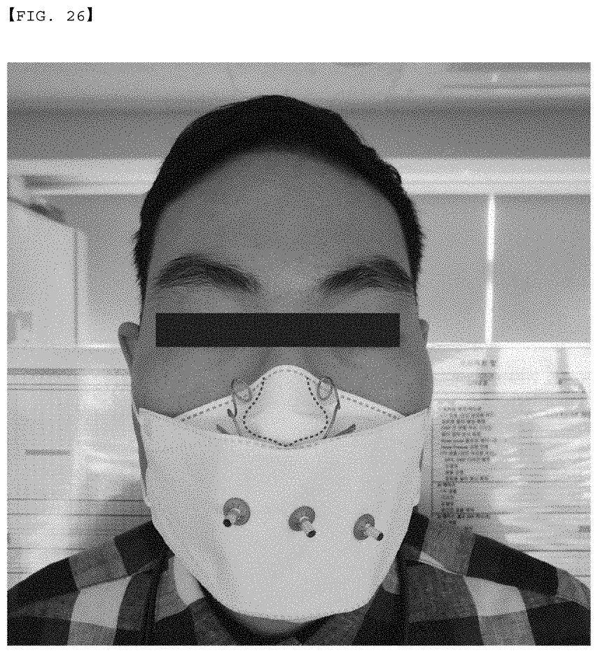

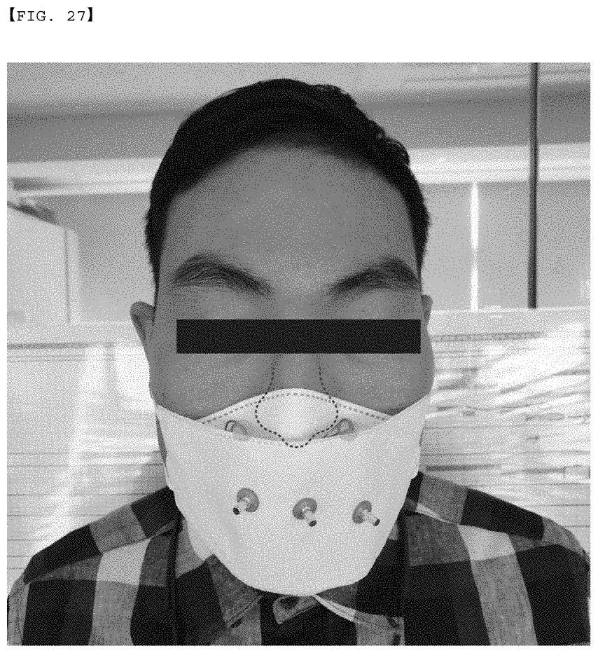

Meanwhile, a novel pain index was derived based on the experimental results on the pressure at which the user felt pain and the pain that the user felt under fixed pressure. The novel pain index, which is a value obtained by multiplying a value obtained by dividing the pressure at which the user feels pain (PPT) by the value of pain that the user feels under fixed pressure (VAS) by 100, is used to select a region in which the user feels less pain while enduring high pressure. The results of analysis on the coordinates of the respective small squares are shown in FIG. 13.

In the first experiment of the present invention for the 1-6^{th} fixing region, definite fixing regions could be derived using the three methods as described above. It was evaluated that fixing force could be secured while user discomfort was minimized when a value of 1.2 or greater was applied in FIG. 11, when a value of 5.0 or greater was applied in FIG. 12, and when a value of 25 or greater was applied in FIG. 13.

<Second Experiment: Measurement of Fixing Force in 1-7^{th} Fixing Region>

As described above, the 1-6th fixing region was selected through the first experiment. The 1-6^{th} fixing region corresponds to the interior of the square provided based on the face of the user having the angle of mandible and the zygomatic process of the user as one surface.

During research according to the present invention, it was found that a space from the front of an ear canal to the rear of a temporomandibular joint could be utilized as a fixing region. In the second experiment of the present invention, further evaluation on this region was performed. In extending a range of the fixing region to the rear of the face, it was recognized that utilization was possible unless the range of the fixing region covered the temporomandibular joint, and the range of the fixing region was extended. In the same manner, the range of the fixing region was extended to the upper part of the face.

The pressure at which the user felt pain (PPT) was measured for the coordinates of values of (x,y) provided based on the face of the user shown in FIG. 8. A measurement method was identical to the measurement method in the first experiment.

The reason why the pressure pain threshold (PPT) of the user is measured according to the coordinates of (x,y) provided based on the face of the user according to the present invention is that the degree of pain may be changed depending on whether a muscle exists based on the position of the face of the user, the position of the skeleton, and the thickness of the skin. This means that, as the pressure pain threshold (PPT) increases, it is possible to increase pressure at which fixing force can be secured.

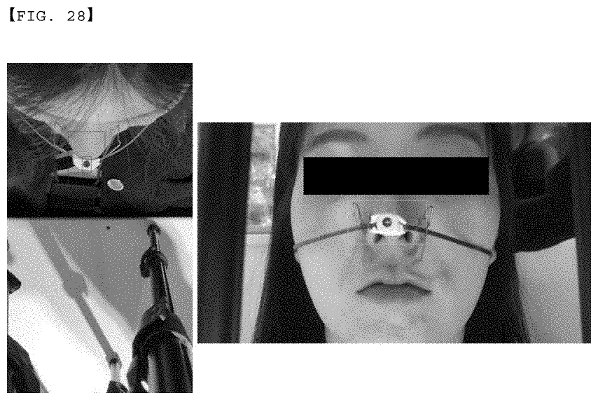

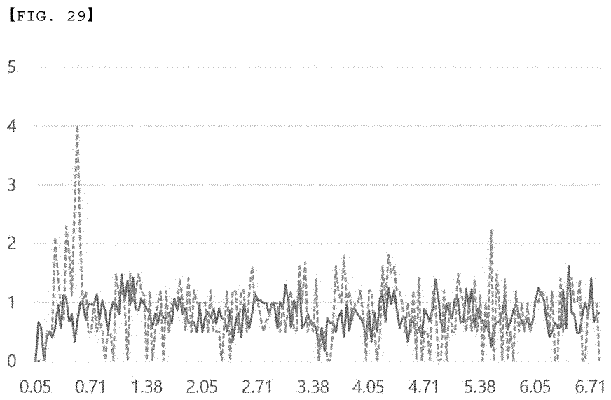

The unit of pressure at which the pain is felt is kg/cm². The pressure pain threshold was input to each of the coordinates, and the results thereof are shown in FIG. 14. The results shown in FIG. 14 are the averages of the values measured for 9 people. The upper part in FIG. 14 shows criteria based on which colors are changed depending on a range of pressure pain thresholds (PPTs). A region below 1.2 is a region that has too low a pressure pain threshold and thus is not suitable for use as a fixing region, and a region above 1.4 is a region that has the highest pressure pain threshold and thus is most suitable for use as a fixing region.

<Fixing Force Experiment>

Among the regions derived according to the first experiment of the present invention, particularly five regions evaluated to have a high ratio of fixing force to pain were selected, and the fixing force thereof was measured using various methods.

Among the values of (x,y) provided based on the face of the user, (1,5), (1,3), (2,5), (2,2), and (2,4) were designated as region 1, region 2, region 3, region 4, and region 5, respectively, and fixing force experiments were separately performed thereon. For region 1, region 2, region 3, region 4, and region 5, a frame-shaped semicircular frame (hereinafter referred to as a “frame”) that pressed only the coordinates of the small squares corresponding thereto while covering the face was manufactured. Thereafter, whether the semicircular frame was maintained in position when “a-e-i-o-u” was pronounced while the pressure at which the semicircular frame pressed the corresponding coordinates was changed (Verbal), whether the semicircular frame was maintained in a horizontal state when the semicircular frame was held horizontally and a neck of the user was bent by 30 degrees and then was returned to the original state thereof (Flexion), and whether the semicircular frame got out of position when the user walked at speeds of 3 km/h and 5 km/h (Walking) were observed. The experimental results thereof are shown in Table 1, Table 2, and Table 3. These are the averages of the results of experiments performed for 3 people.

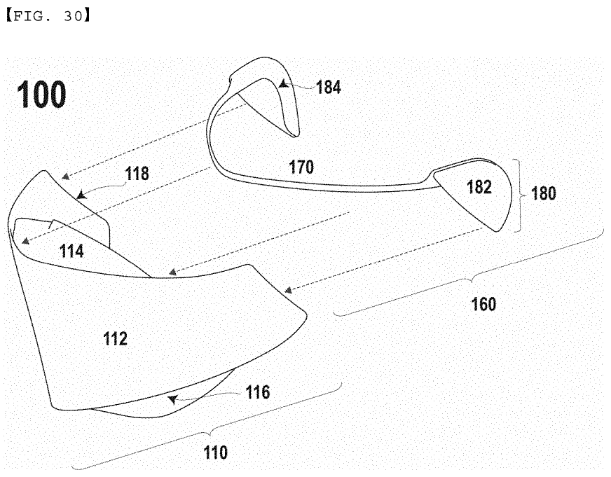

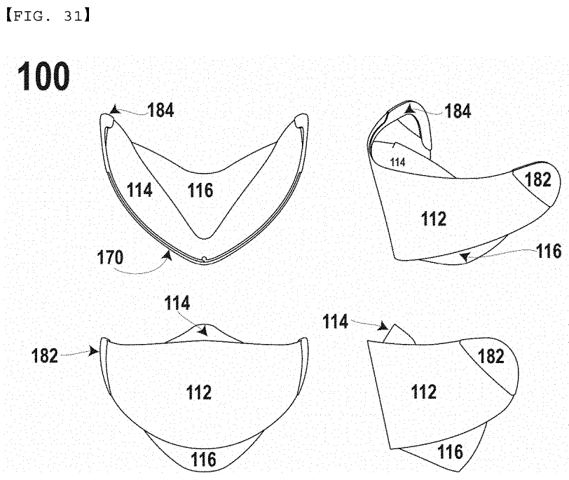

FIG. 15 is a view showing an apparatus configured to measure the degree of fixing when the frame is fixed to a specific region of an actual user at a specific pressure. Additionally, different levels of pressure applied to the face of the user when the elastic force of the apparatus was changed to 10 g, 30 g, and 50 g are schematized.

The pressure described in Table 1 is elastic force or pressure that is applied to the user by the frame, and the unit thereof is g. Table 1 shows the minimum pressure necessary for the frame to be maintained in position during the “Verbal,” “Flexion,” and “Walking” experiments, and it can be seen that the frame was maintained in position at position 2 and position 4 due to low pressure.

TABLE 1
Minimum pressure necessary for frame to be maintained in position

| | Position | | | | |
|---|---|---|---|---|---|
| Task | 1 | 2 | 3 | 4 | 5 |
| Verbal | 30 | 30 | >50 | 10 | 50 |
| Flexion | >50 | 30 | >50 | 50 | >50 |
| Walking | 50 | 10 | >50 | 10 | 30 |

Table 2 shows the number of people having frames deviated from the original positions thereof according to the levels of fixing pressure during the “Verbal,” “Flexion,” and “Walking” experiments. Similarly to Table 1, the frames did not deviate from the original positions thereof at position 2 and position 4.

TABLE 2
Number of people having frames deviated
from original positions thereof

| | | Position | | | | |
|---|---|---|---|---|---|---|
| Task | | 1 | 2 | 3 | 4 | 5 |
| Verbal | 10 G | — | — | 2 | — | — |
| | 30 G | — | — | — | — | — |
| | 50 G | — | — | — | — | — |
| Flexion | 10 G | 3 | — | 3 | — | 2 |
| | 30 G | — | — | 1 | — | — |
| | 50 G | — | — | — | — | — |
| Walking | 10 G | 1 | — | 3 | — | 1 |
| | 30 G | 1 | — | — | — | — |
| | 50 G | — | — | — | — | — |

Table 3 shows regions in which the frames did not move depending on the levels of pressure applied by the frames. It can be seen that the frames did not move at position 2 and position 4 even at low pressure.

TABLE 3
Regions in which frames did not move

| | | Position | | | | |
|---|---|---|---|---|---|---|
| Task | | 1 | 2 | 3 | 4 | 5 |
| Verbal | 10 G | | | | ∘ | |
| | 30 G | ∘ | ∘ | | ∘ | |
| | 50 G | ∘ | ∘ | | ∘ | ∘ |
| Flexion | 10 G | | | | | |
| | 30 G | | ∘ | | | |
| | 50 G | | ∘ | | ∘ | |
| Walking | 10 G | | ∘ | | ∘ | |
| | 30 G | | ∘ | | ∘ | ∘ |
| | 50 G | ∘ | ∘ | | ∘ | ∘ |

For the five positions, weights having predetermined weights were suspended from the frame in order to measure whether the frame was fixed, and the results of measurement are shown in Table 4.

TABLE 4
Minimum pressure necessary for fall prevention (pressure of mask)

| | Weight | | | | |
|---|---|---|---|---|---|
| Position | 10 g | 20 g | 30 g | 40 g | 50 g |
| 1 | 30 | 50 | >50 | >50 | >50 |
| 2 | 10 | 10 | 50 | 50 | >50 |
| 3 | 30 | 50 | >50 | >50 | >50 |
| 4 | 10 | 10 | 50 | >50 | >50 |
| 5 | 10 | 50 | 50 | >50 | >50 |

As can be seen from Table 4, the heavy weights can be fixed even at low pressure at position 2 and position 4. It can be seen from the above experiment that the largest fixing force is secured at position 2 and position 4.

<Measurement of Fixing Force Generated by Addition of Pressing Portion>

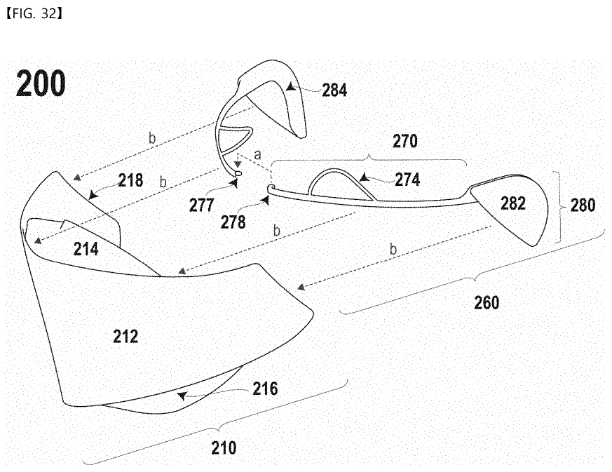

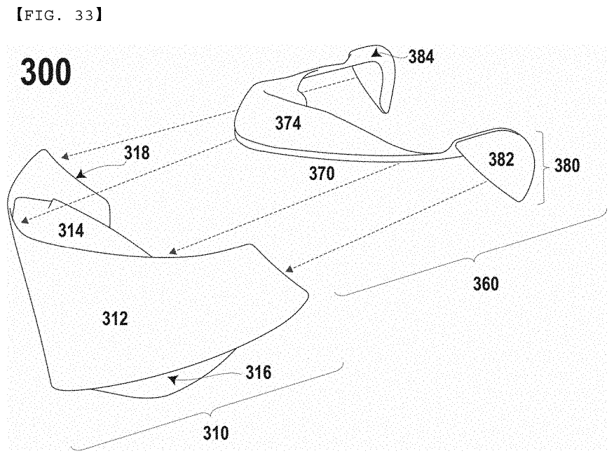

Fixing force generated by addition of a pressing portion according to the present invention was measured. The pressing portion according to the present invention may additionally generate fixing force. In order to measure fixing force generated by addition of the pressing portion, a member having the same shape as the pressing portion according to the present invention (hereinafter referred to as a “pressing portion”) is added to the frame shown in FIG. 15. FIG. 16 is a view showing the pressing portion added to the frame in order to measure fixing force generated by addition of the pressing portion.

After the frame was fixed such that the first fixing region corresponds to position 2 and position 4 in the above-described fixing force experiment, fixing force was observed while the pressing portion was added or removed and while the pressing portion was located above the alar creases, on the alar creases, and under the alar creases.

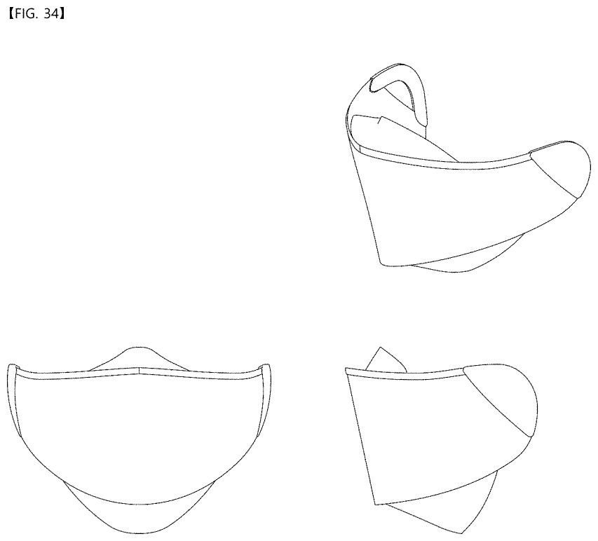

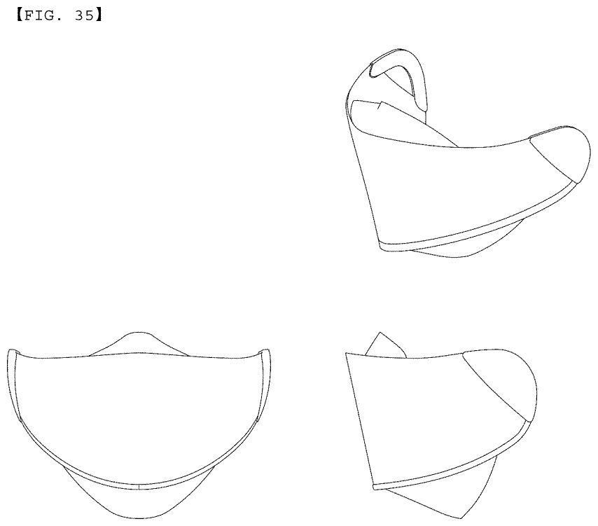

FIG. 17 is a photograph showing that the pressing portion is located above the alar creases, on the alar creases, and under the alar creases.

In the same manner as the fixing force was measured with only the frame, whether the semicircular frame got out of position when “a-e-i-o-u” was pronounced (Verbal) and whether the semicircular frame got out of position when the user walked at speeds of 3 km/h and 5 km/h (Walking) were observed in the state in which separate weights of 10, 20, 30, 40, and 50 g were added to the frame. The results of this experiment are the averages of the results obtained from 3 people.

As can be seen with reference to Table 2, when the fixing force of the frame was 30 g, the frame did not deviate from the fixing position during the “Verbal” and the “Walking” irrespective of whether the pressing portion was added.

In order to observe the effect achieved by the pressing portion, the support pressure of the frame was minimized and the pressure of the frame was reduced to 10 g or less. In this case, 10 g, which is the minimum weight, could not be supported even at position 2 and position 4. Table 5 below shows the experimental results according thereto. The cases in which the frame did not deviate from the original position thereof depending on the weight of the weights and the position of the pressing portion are denoted by “O”.

TABLE 5

| | With | | | | | | Without | |
|---|---|---|---|---|---|---|---|---|
| | Above | | On | | Under | | — | |
| Weight/Position | 2 | 4 | 2 | 4 | 2 | 4 | 2 | 4 |
| 10 g | . | ∘ | ∘ | ∘ | ∘ | ∘ | . | . |
| 20 g | . | . | ∘ | ∘ | ∘ | ∘ | . | . |
| 30 g | . | . | . | . | ∘ | ∘ | . | . |
| 40 g | . | . | . | . | ∘ | ∘ | . | . |
| 50 g | . | . | . | . | ∘ | ∘ | . | . |

Referring to Table 5, it was revealed that the frame having no pressing portion got out of position at position 2 and position 4. In addition, it was observed that the extent to which the pressing portion deviated from the original position thereof was changed depending on the position thereof and that, when the pressing portion was located under the alar creases, the strongest fixing force was secured.

<Measurement of Fixing Force at (−1,1) and (1,−1)>

In addition, in the present invention, in consideration of the fact that, since a disposable or general mask is very light compared to a general gas mask, the mask can be sufficiently fixed to a face even at fixing force much less than the fixing force of the frame used in the <measurement of fixing force>, a conventional region in which the degree of pain is high but the level of fixing force is high was selected, and an experiment was performed. In this experiment, the above region was added to the 1-6^{th} fixing region; however, the region resulting from the addition eventually corresponds to the 1-7^{th} fixing region.

The experiment was performed in the same manner as <First experiment: Measurement of fixing force in 1-6^{th} fixing region> and <Fixing force experiment> described above.

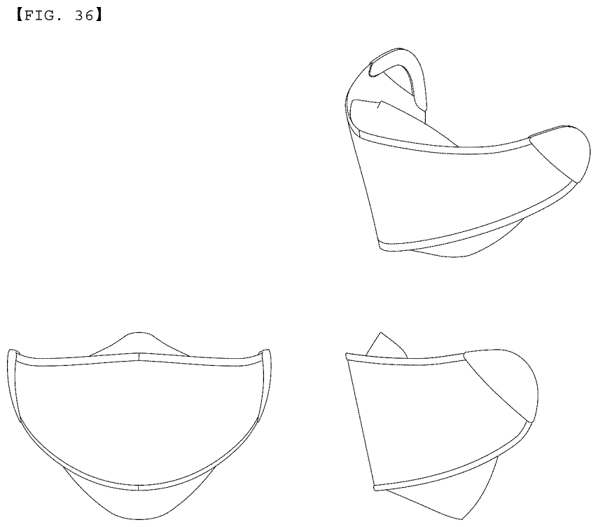

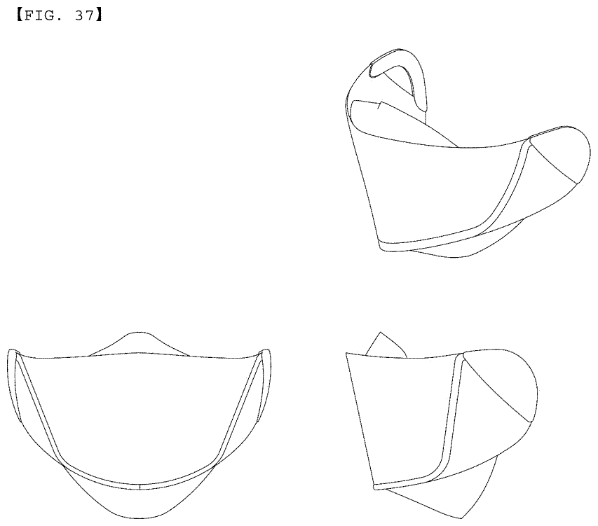

FIG. 18 is a view showing results of measuring VAS in the state in which (−1,1) and (1,−1) were added to the 1-6^{th} fixing region. In FIG. 18, position 1 corresponds to (1, −1), and position 6 corresponds to (−1, 1). The graph in FIG. 18 shows results of measuring VAS at position 1 and position 6. Position 1 and position 6 are regions in which the degree of pain is large when pressure of 30 g is applied thereto, and thus are not suitable for use as fixing regions. However, position 1 and position 6 may be used as fixing regions when pressure of 10 g is applied thereto. The results shown in FIG. 18 are the averages of the values obtained from the experiments performed for 5 people.

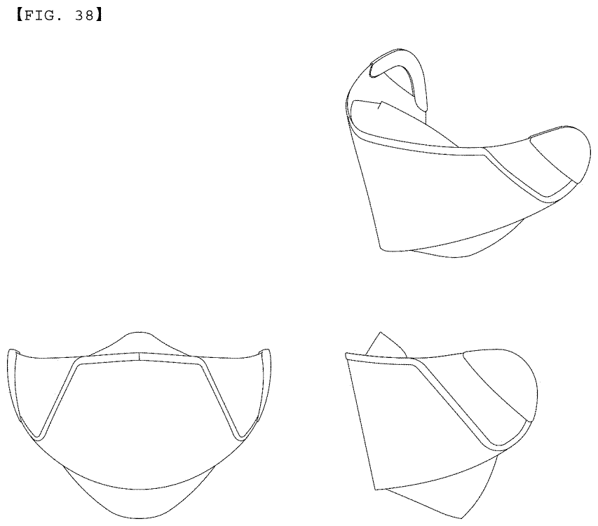

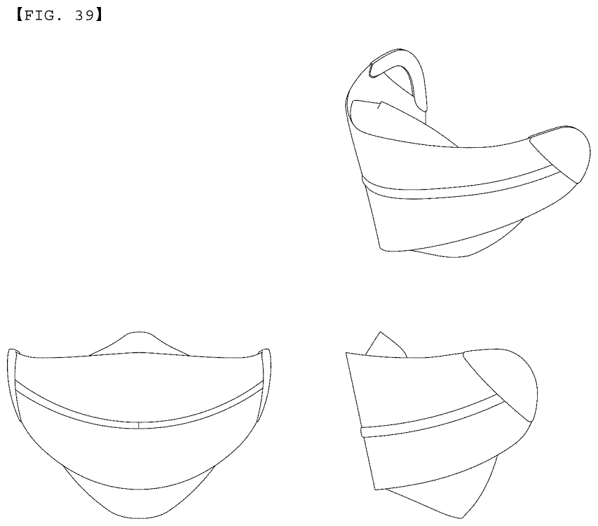

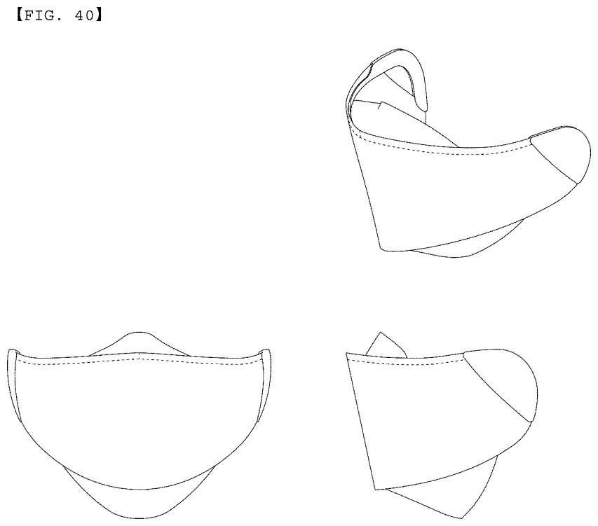

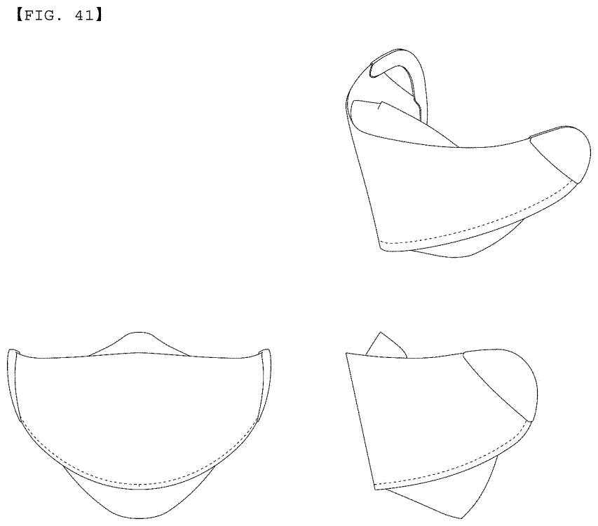

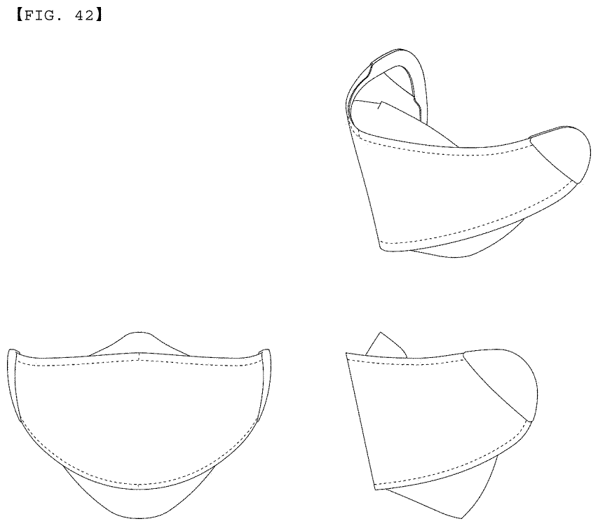

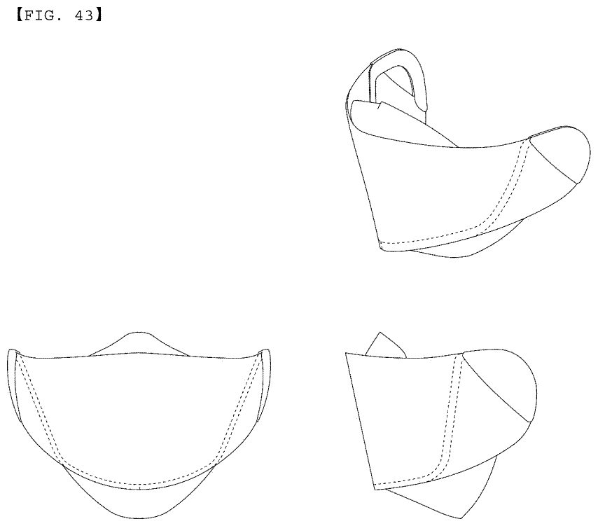

FIGS. 19 to 21 show results of the “Verbal,” “Flexion,” and “Walking” experiments performed to measure the degree of fixing at position 1, position 6, position 2, and position 4, which are regions in which the degree of pain is relatively low among the experimental results shown in FIG. 18. Position 3 in FIGS. 19 to 21 corresponds to position 6 in FIG. 18. It can be seen from the results shown in FIGS. 19 to 21 that all of the four regions on which the experiments were performed are suitable for use as fixing regions in which sufficient fixing force can be secured. In particular, the highest degree of fixing is observed at position 1 in all cases.

As described above, in the present invention, various experiments were performed on respective regions in the state in which anatomically specific positions were clearly set. A specific region in which strong fixing force can be secured even with minimum required force is derived, and accordingly, it is possible to provide a mask characterized in that skin irritation is low even if the mask is worn for a long time, in that a pressed region is clearly specified and the region is minimized, and in that consistent fixing force is provided regardless of users.

<Measurement of Official Leakage Rate>

<Leakage Rate Examples>

FIGS. 25 to 27 are photographs showing that a pressing portion, which is capable of pressing a first pressed region to a third pressed region according to the present invention in the state in which a fitting function of a conventional mask (KF94) is not used, is manufactured in a shape of a metal clip and then is worn in order to measure an official leakage rate based on the pressing portion according to the present invention.

An official leakage rate was measured when the clip was brought into tight contact with the third pressed region (Leakage Rate Example 1), the second pressed region (Leakage Rate Example 2), and the first pressed region (Leakage Rate Example 3) according to the present invention, as shown in FIGS. 25 to 27.

<Leakage Rate Comparative Examples>

A disposable KF94 mask, which is a conventional mask, was used for Leakage Rate Comparative Examples. The mask is configured such that a steel wire capable of being deformed is inserted into the portion of the mask corresponding to the peripheral portion of the nose in order to seal the peripheral portion of the nose. The official leakage rate was measured using the mask. In Leakage Rate Comparative Examples 1, 2, and 3, the leakage rate was measured using the conventional KF94 mask at the position at which the leakage rate was measured in Leakage Rate Examples 1, 2, and 3.

The leakage rate was measured according to a leakage rate test method stated in guideline-0349-04 in “guidelines on standards of health masks (civil service guideline)” of the National Institute of Food and Drug Safety Evaluation in Korea. The leakage rate results of the present invention are leakage rate results obtained by performing tests after a test apparatus and method were certified by the National Institute of Food and Drug Safety Evaluation in Korea.

In the result values in the table below related to the leakage rate, a first behavior to a fifth behavior respectively correspond to (A) walking for two minutes without moving the head or speaking, (B) moving the head from side to side 15 times for about two minutes as if investigating the wall of a tunnel, (C) moving the head up and down 15 times for about two minutes as if investigating the roof and the floor, (D) speaking out loud Korean text for two minutes, and (E) walking for two minutes without moving the head or speaking, stated in guideline-0349-04 in “guidelines on standards of health masks (civil service guideline)”.

For each behavior, a test was performed for about two minutes, and the average of the results obtained by performing the test five times was used.

<Comparison Between Results of Official Leakage Rate>

Tables 6, 9, and 10 respectively show official leakage rates when the third fixing portion (Leakage Rate Example 1), the second fixing portion (Leakage Rate Example 2), and the first fixing portion (Leakage Rate Example 3) according to the present invention were brought into tight contact with the face, and Tables 7 and 11 respectively show official leakage rates in Leakage Rate Comparative Example 1 and Leakage Rate Comparative Example 2. In Leakage Rate Comparative Example 3, tight contact was impossible, and therefore it was not possible to measure the leakage rate. When the leakage rate was measured by force, a value of 40% or greater was measured, and therefore a substantially meaningful value was not derived.

Table 11 shows official leakage rate results of Leakage Rate Example 4 when the same experiment was performed in the state in which the pressing portion according to the embodiment of the present invention was disposed only on the nasal cartilage of the user without pressing the regions of Examples 1, 2, and 3.

TABLE 6

| Tester | Koreatech |
|---|---|
| Test date | 2020 Oct. 28 |
| Mask wearer | Joony |
| Mask manufacturer | Sample2 |
| Mask model name | NFA_Medium |
| Mask serial number | 002 |
| Test round | 2 |
| Mask leakage rate determination | 11 |
| criterion (%) | |
| Mask leakage rate (%) | 2.05 |
| Correction value before mask | 0.0000024329 |
| measurement (V) | |
| Correction value before mask | 0.00 |
| measurement (mg/m²) | |
| In-chamber measurement value (V) | 0.0072946996 |
| In-chamber measurement value (mg/m²) | 11.46 |
| In-chamber measurement value after test | 0.0052187303 |
| (V) | |
| In-chamber measurement value after test | 8.19 |
| (mg/m²) | |
| In-mask measurement value (V) | 0.000 |
| In-mask measurement value (mg/m²) | 0.09 |
| Inspiratory time (1 second) | 253 |
| Expiratory time (1 second) | 347 |
| Zero offset (V) | 0 |
| Average leakage rate during first | 2.462 (pass) |
| behavior (%) | |
| Average leakage rate during second | 2.061 (pass) |
| behavior (%) | |
| Average leakage rate during third | 1.244 (pass) |
| behavior (%) | |
| Average leakage rate during fourth | 1.723 (pass) |
| behavior (%) | |
| Average leakage rate during fifth | 2.682 (pass) |
| behavior (%) | |

TABLE 7

| Tester | Koreatech |
|---|---|
| Test date | 2020 Oct. 28 |
| Mask wearer | Joony |
| Mask manufacturer | Sample2 |
| Mask model name | Noseclip_Medium |
| Mask serial number | 002 |
| Test round | 4 |
| Mask leakage rate determination | 11 |
| criterion (%) | |
| Mask leakage rate (%) | 4.12 |
| Correction value before mask | 0.0000040403 |
| measurement (V) | |
| Correction value before mask | 0.00 |
| measurement (mg/m²) | |
| In-chamber measurement value (V) | 0.0067938882 |
| In-chamber measurement value (mg/m²) | 10.67 |
| In-chamber measurement value after test | 0.0051466752 |
| (V) | |
| In-chamber measurement value after test | 8.08 |
| (mg/m²) | |
| In-mask measurement value (V) | 0.000 |
| In-mask measurement value (mg/m²) | 0.18 |
| Inspiratory time (1 second) | 246 |
| Expiratory time (1 second) | 354 |
| Zero offset (V) | 0 |
| Average leakage rate during first | 3.352 (pass) |
| behavior (%) | |
| Average leakage rate during second | 2.354 (pass) |
| behavior (%) | |
| Average leakage rate during third | 4.454 (pass) |
| behavior (%) | |
| Average leakage rate during fourth | 3.708 (pass) |
| behavior (%) | |
| Average leakage rate during fifth | 6.814 (pass) |
| behavior (%) | |

TABLE 8

| | |
|---|---|
| Tester | Koreatech |
| Test date | Oct. 28, 2020 |
| Mask wearer | Joony |
| Mask manufacturer | Sample1 |
| Mask model name | NFA_Upper |
| Mask serial number | 001 |
| Test round | 1 |
| Mask leakage rate determination criterion (%) | 11 |
| Mask leakage rate (%) | 0.36 |
| Correction value before mask measurement (V) | 0.0000027466 |
| Correction value before mask measurement (mg/m²) | 0.00 |
| In-chamber measurement value (V) | 0.0072424736 |
| In-chamber measurement value (mg/m²) | 11.37 |
| In-chamber measurement value after test (V) | 0.0051501300 |
| In-chamber measurement value after test (mg/m²) | 8.08 |
| In-mask measurement value (V) | 0.000 |
| In-mask measurement value (mg/m²) | 0.01 |
| Inspiratory time (1 second) | 249 |
| Expiratory time (1 second) | 351 |
| Zero offset (V) | 0 |
| Average leakage rate during first behavior (%) | 0.755 (pass) |
| Average leakage rate during second behavior (%) | 0.336 (pass) |
| Average leakage rate during third behavior (%) | 0.428 (pass) |
| Average leakage rate during fourth behavior (%) | 0.130 (pass) |
| Average leakage rate during fifth behavior (%) | 0.143 (pass) |

TABLE 9

| | |
|---|---|
| Tester | Koreatech |
| Test date | Oct. 28, 2020 |
| Mask wearer | Joony |
| Mask manufacturer | Sample1 |
| Mask model name | Noseclip_Upper |
| Mask serial number | 001 |
| Test round | 4 |
| Mask leakage rate determination criterion (%) | 11 |
| Mask leakage rate (%) | 1.57 |
| Correction value before mask measurement (V) | 0.0000022869 |
| Correction value before mask measurement (mg/m²) | 0.00 |
| In-chamber measurement value (V) | 0.0068224883 |
| In-chamber measurement value (mg/m²) | 10.71 |
| In-chamber measurement value after test (V) | 0.0050919662 |
| In-chamber measurement value after test (mg/m²) | 7.99 |
| In-mask measurement value (V) | 0.000 |
| In-mask measurement value (mg/m²) | 0.06 |
| Inspiratory time (1 second) | 238 |
| Expiratory time (1 second) | 362 |
| Zero offset (V) | 0 |
| Average leakage rate during first behavior (%) | 1.575 (pass) |
| Average leakage rate during second behavior (%) | 1.547 (pass) |
| Average leakage rate during third behavior (%) | 0.826 (pass) |
| Average leakage rate during fourth behavior (%) | 1.796 (pass) |
| Average leakage rate during fifth behavior (%) | 2.050 (pass) |

TABLE 10

| | |
|---|---|
| Tester | Koreatech |
| Test date | Oct. 28, 2020 |
| Mask wearer | Joony |
| Mask manufacturer | Sample3 |
| Mask model name | NFA_Lower |
| Mask serial number | 003 |
| Test round | 3 |
| Mask leakage rate determination criterion (%) | 11 |
| Mask leakage rate (%) | 2.04 |
| Correction value before mask measurement (V) | 0.0000031152 |
| Correction value before mask measurement (mg/m²) | 0.00 |
| In-chamber measurement value (V) | 0.0068813179 |
| In-chamber measurement value (mg/m²) | 10.81 |
| In-chamber measurement value after test (V) | 0.0051730185 |
| In-chamber measurement value after test (mg/m²) | 8.12 |
| In-mask measurement value (V) | 0.000 |
| In-mask measurement value (mg/m²) | 0.09 |
| Inspiratory time (1 second) | 260 |
| Expiratory time (1 second) | 340 |
| Zero offset (V) | 0 |
| Average leakage rate during first behavior (%) | 2.609 (pass) |
| Average leakage rate during second behavior (%) | 2.104 (pass) |
| Average leakage rate during third behavior (%) | 2.068 (pass) |
| Average leakage rate during fourth behavior (%) | 1.629 (pass) |
| Average leakage rate during fifth behavior (%) | 1.785 (pass) |

TABLE 11

| | |
|---|---|
| Tester | Koreatech |
| Test date | Oct. 28, 2020 |
| Mask wearer | Joony |
| Mask manufacturer | Sample5 |
| Mask model name | Modi_nasal bone |
| Mask serial number | 5 |
| Test round | 4 |
| Mask leakage rate determination criterion (%) | 11 |
| Mask leakage rate (%) | 0.71 |
| Correction value before mask measurement (V) | 0.0000024432 |
| Correction value before mask measurement (mg/m²) | 0.00 |
| In-chamber measurement value (V) | 0.0059834309 |
| In-chamber measurement value (mg/m²) | 9.39 |
| In-chamber measurement value after test (V) | 0.0049673023 |
| In-chamber measurement value after test (mg/m²) | 7.80 |
| In-mask measurement value (V) | 0.000 |
| In-mask measurement value (mg/m²) | 0.02 |
| Inspiratory time (1 second) | 244 |
| Expiratory time (1 second) | 356 |
| Zero offset (V) | 0 |
| Average leakage rate during first behavior (%) | 0.685 (pass) |
| Average leakage rate during second behavior (%) | 0.641 (pass) |
| Average leakage rate during third behavior (%) | 0.807 (pass) |
| Average leakage rate during fourth behavior (%) | 0.648 (pass) |
| Average leakage rate during fifth behavior (%) | 0.770 (pass) |

Table 12 below shows the official leakage rates of Leakage Rate Examples 1 to 4 according to the present invention and Leakage Rate Comparative Example 1 for comparison therebetween.

TABLE 12

| | Official | |
|---|---|---|
| | leakage rate | Remarks |
| Leakage Rate Example 1 | 2.05% | Third fixing portion |
| Leakage Rate Example 2 | 0.36% | Second fixing portion |
| Leakage Rate Example 3 | 2.04% | First fixing portion |
| Leakage Rate Example 4 | 0.71% | Fixing portion in claim 2 |
| Leakage Rate | 4.12% | Less than 11% based on |
| Comparative Example 1 | | KF94 satisfied |

When the official leakage rates were measured, Leakage Rate Examples 1, 2, 3, and 4 according to the present invention and Leakage Rate Comparative Example satisfied the criterion of KF94; however, all examples of the present invention had lower leakage rates than Leakage Rate Comparative Example. <Compared to jaw motion results>

Tables 13, 15, and 17 respectively show the test results obtained by performing “(D) speaking out loud Korean text for two minutes,” in which jaws were moved, among the above leakage rate test methods, five times in the state in which masks including the pressing portions according to Leakage Rate Examples 1 to 3 of the present invention were worn, and Tables 14 and 16 respectively show the results of Leakage Rate Comparative Examples 1 and 2. In the case of (D), much leakage actually occurs; however, the leakage is not clearly recognized within the regulation of an official test, and therefore additional experiments were performed thereon.

As can be seen from Table 13, the mask including the pressing portion according to Leakage Rate Example 1 has a leakage rate of 1.87%, which is an excellent value, even for test (D). Referring to Table 14, when the conventional KF94 mask was used at the same position, the leakage rate was 8.02%, which satisfied the criteria of less than 11%; however, the leakage rate was four or more times the leakage rate of Leakage Rate Example 1.

TABLE 13

| | |
|---|---|
| Mask model name | NN003 |
| Mask serial number | 003 |
| Test round | 5 |
| Mask leakage rate determination criterion (%) | 11 |
| Mask leakage rate (%) | 1.87 |
| Correction value before mask measurement (V) | 0.0000024509 |
| Correction value before mask measurement (mg/m²) | 0.00 |
| In-chamber measurement value (V) | 0.0072987548 |
| In-chamber measurement value (mg/m²) | 11.46 |
| In-chamber measurement value after test (V) | 0.0048150216 |
| In-chamber measurement value after test (mg/m²) | 7.56 |
| In-mask measurement value (V) | 0.000 |
| In-mask measurement value (mg/m²) | 0.09 |
| Inspiratory time (1 second) | 282 |
| Expiratory time (1 second) | 318 |
| Zero offset (V) | 0 |
| Average leakage rate during first behavior (%) | 2.312 (pass) |
| Average leakage rate during second behavior (%) | 3.379 (pass) |
| Average leakage rate during third behavior (%) | 2.066 (pass) |
| Average leakage rate during fourth behavior (%) | 0.628 (pass) |
| Average leakage rate during fifth behavior (%) | 1.075 (pass) |

TABLE 14

| | |
|---|---|
| Mask model name | NN002 |
| Mask serial number | 002 |
| Test round | 5 |
| Mask leakage rate determination criterion (%) | 11 |
| Mask leakage rate (%) | 8.02 |
| Correction value before mask measurement (V) | 0.0000025650 |
| Correction value before mask measurement (mg/m²) | 0.00 |
| In-chamber measurement value (V) | 0.0069551891 |
| In-chamber measurement value (mg/m²) | 10.92 |
| In-chamber measurement value after test (V) | 0.0045803887 |
| In-chamber measurement value after test (mg/m²) | 7.19 |
| In-mask measurement value (V) | 0.000 |
| In-mask measurement value (mg/m²) | 0.40 |
| Inspiratory time (1 second) | 282 |
| Expiratory time (1 second) | 318 |
| Zero offset (V) | 0 |
| Average leakage rate during first behavior (%) | 9.486 (pass) |
| Average leakage rate during second behavior (%) | 8.483 (pass) |
| Average leakage rate during third behavior (%) | 8.208 (pass) |
| Average leakage rate during fourth behavior (%) | 9.129 (pass) |
| Average leakage rate during fifth behavior (%) | 5.096 (pass) |

As can be seen from Table 15, the mask including the pressing portion according to Leakage Rate Example 2 has a leakage rate of 0.41″, which is an excellent value. Referring to Table 16, when the conventional KF94 mask was used at the same position, the leakage rate was 1.41%, which satisfied the criteria; however, the leakage rate was about four times the leakage rate of Leakage Rate Example 2.

TABLE 15

| | |
|---|---|
| Tester | Koreatech |
| Test date | Jul. 30, 2020 |
| Mask wearer | YI |
| Mask manufacturer | KF94 |
| Mask model name | Modi_Upper |
| Mask serial number | 001 |
| Test round | 1 |
| Mask leakage rate determination criterion (%) | 11 |
| Mask leakage rate (%) | 0.41 |
| Correction value before mask measurement (V) | 0.0000017391 |
| Correction value before mask measurement (mg/m²) | 0.00 |
| In-chamber measurement value (V) | 0.0067575390 |
| In-chamber measurement value (mg/m²) | 10.61 |
| In-chamber measurement value after test (V) | 0.0044641244 |
| In-chamber measurement value after test (mg/m²) | 7.01 |
| In-mask measurement value (V) | 0.000 |
| In-mask measurement value (mg/m²) | 0.01 |
| Inspiratory time (1 second) | 281 |
| Expiratory time (1 second) | 319 |
| Zero offset (V) | 0 |
| Average leakage rate during first behavior (%) | 0.702 (pass) |
| Average leakage rate during second behavior (%) | 0.275 (pass) |
| Average leakage rate during third behavior (%) | 0.496 (pass) |
| Average leakage rate during fourth behavior (%) | 0.359 (pass) |
| Average leakage rate during fifth behavior (%) | 0.209 (pass) |

TABLE 16

| | |
|---|---|
| Tester | Koreatech |
| Test date | Jul. 30, 2020 |
| Mask wearer | YI |
| Mask manufacturer | KF94 |
| Mask model name | Nor_Upper |
| Mask serial number | 002 |
| Test round | 1 |
| Mask leakage rate determination criterion (%) | 11 |
| Mask leakage rate (%) | 1.41 |
| Correction value before mask measurement (V) | 0.0000015896 |
| Correction value before mask measurement (mg/m²) | 0.00 |
| In-chamber measurement value (V) | 0.0066951225 |
| In-chamber measurement value (mg/m²) | 10.51 |
| In-chamber measurement value after test (V) | 0.0047870668 |
| In-chamber measurement value after test (mg/m²) | 7.51 |
| In-mask measurement value (V) | 0.000 |
| In-mask measurement value (mg/m²) | 0.06 |
| Inspiratory time (1 second) | 293 |
| Expiratory time (1 second) | 307 |
| Zero offset (V) | 0 |
| Average leakage rate during first behavior (%) | 1.672 (pass) |
| Average leakage rate during second behavior (%) | 1.699 (pass) |
| Average leakage rate during third behavior (%) | 1.656 (pass) |
| Average leakage rate during fourth behavior (%) | 1.025 (pass) |
| Average leakage rate during fifth behavior (%) | 0.961 (pass) |

As can be seen from Table 17, the mask including the pressing portion according to Leakage Rate Example 3 has a leakage rate of 2.31%, which is an excellent value. In contrast, in Leakage Rate Comparative Example 3, tight contact was impossible, and therefore it was not possible to measure the leakage rate. When the leakage rate was measured by force, a value of 40% or greater was measured, and therefore a substantially meaningful value was not derived.

TABLE 17

| | |
|---|---|
| Mask model name | Modi_NFA_Low |
| Mask serial number | 001 |
| Test round | 1 |
| Mask leakage rate determination criterion (%) | 11 |
| Mask leakage rate (%) | 2.31 |
| Correction value before mask measurement (V) | 0.0000025399 |
| Correction value before mask measurement (mg/m²) | 0.00 |
| In-chamber measurement value (V) | 0.0082376058 |
| In-chamber measurement value (mg/m²) | 12.94 |
| In-chamber measurement value after test (V) | 0.0049608726 |
| In-chamber measurement value after test (mg/m²) | 7.79 |
| In-mask measurement value (V) | 0.000 |
| In-mask measurement value (mg/m²) | 0.13 |
| Inspiratory time (1 second) | 278 |
| Expiratory time (1 second) | 322 |
| Zero offset (V) | 0 |
| Average leakage rate during first behavior (%) | 1.235 (pass) |
| Average leakage rate during second behavior (%) | 4.931 (pass) |
| Average leakage rate during third behavior (%) | 2.474 (pass) |
| Average leakage rate during fourth behavior (%) | 1.484 (pass) |
| Average leakage rate during fifth behavior (%) | 1.339 (pass) |

Table 18 below shows the test results having the highest leakage rates, among the official leakage rates of Leakage Rate Examples 1 to 3 according to the present invention and Leakage Rate Comparative Examples 1 and 2, for comparison therebetween. In many cases, users work for a long time while wearing masks, and most of the users talk with each other. Referring to Table 18 below, even in this case, Leakage Rate Examples 1 to 3 according to the present invention show leakage rates similar to those shown in Table 12, from which it can be seen that uniform sealing is guaranteed even when jaw muscles or facial muscles are moved. In addition, low leakage rates are maintained irrespective of position and whether muscles are used, and therefore it is possible to always obtain excellent results even if users are not accustomed to mask wearing.

TABLE 18

| | Leakage rate due | |
|---|---|---|
| | to jaw motion | Remarks |
| Leakage Rate Example 1 | 1.87% | Third fixing portion |
| Leakage Rate Example 2 | 0.41% | Second fixing portion |
| Leakage Rate Example 3 | 2.31% | First fixing portion |
| Leakage Rate | 8.02% | Less than 11% based on |
| Comparative Example 1 | | KF94 satisfied |
| Leakage Rate | 1.41% | Less than 11% based on |
| Comparative Example 2 | | KF94 satisfied |
| Leakage Rate | — | Not fixed and |
| Comparative Example 3 | | measurement impossible |

In contrast, the conventional mask shows a great difference in leakage rate between when the jaw muscles or facial muscles of the user are stopped and when the jaw muscles or facial muscles of the user are moved, and the difference in leakage rate is quadrupled or more depending on position. There is a shortcoming in that the leakage rate is not uniform depending on whether the users are accustomed to mask wearing or whether the users talk with other people. Meanwhile, the leakage rates measured through the same experiment when the pressing portion according to the embodiment of the present invention is disposed only on the nasal cartilage of the user without pressing the regions of Leakage Rate Examples 1, 2, and 3 and when a KF94 mask of the comparative example is used are similar to those shown in Table 15 and Table 16. Even in this case, the result according to the present invention shows a leakage rate equivalent to about ¼ of the leakage rate of the comparative example.

<Displacement Experiment>

In order to check displacement of the apparatus fixed to the face depending on whether the pressing portion according to the present invention is provided, an elastic member configured to be fixed only to left and right parts of the face of the user was manufactured, and change in position of the elastic member around the nose was observed using a motion sensor.

FIG. 28 is a photograph showing that the user wears the elastic member having the pressing portion according to Leakage Rate Example 2 added thereto in order to perform a displacement experiment. In FIG. 28, displacement of the portion indicated by a black dot was observed. In the state in which the user wears the elastic member having the pressing portion according to Leakage Rate Example 2 added thereto or the elastic member not having the pressing portion according to Leakage Rate Example 2, displacement of the black dot was observed while the user said “a-e-i-o-u”. Coordinates from a reference point were calculated, and the distances therefrom were measured. The measurement results over time are shown in FIG. 29.

Even when the conventional mask is brought into tight contact with the face of the user as the result of bending a steel wire on the peripheral portion of the nose of the user, tight contact is lowered due to contraction and relaxation of the facial muscles occurring as the user speaks. The result denoted by the dotted line in FIG. 29 is a result obtained when the elastic member not having the pressing portion according to Leakage Rate Example 2 was worn, which is similar to the result obtained in the conventional mask. When the pressing portion according to the present invention is added, displacement of the corresponding region (refer to the solid line in FIG. 29) is small even in the case in which the user has a conversation, and therefore it can be indirectly checked that tight contact can be continuously maintained.

In the present invention, since positional change is small, friction against the skin due to displacement is small. Consequently, there is an advantage in that, when the mask is worn for a long time due to COVID-19 or the like, it is possible to prevent injury to the skin due to friction between the ridge of the nose and the mask.

<First Embodiment to Third Embodiment>

FIG. 30 is an exploded perspective view of a mask 100 according to a first embodiment of the present invention, and FIG. 31 illustrates a perspective view, a front view, a left view, and a top view of the mask 100 according to the first embodiment of the present invention. FIG. 32 is an exploded perspective view of a mask 200 according to a second embodiment of the present invention, and FIG. 33 is an exploded perspective view of a mask 300 according to a third embodiment of the present invention.

Hereinafter, the first to third embodiments of the mask according to the present invention will be described with reference to FIGS. 30 to 33.

The dotted lines in FIGS. 30 to 33 denote orders in which the first to third embodiments according to the present invention are assembled.

The mask according to the present invention may be broadly divided into a filter 110, 210, or 310 and a frame unit 160, 260, or 360. Each of the first embodiment, the second embodiment, and the third embodiment according to the present invention is an exemplary embodiment made by a specific combination of the filter and the frame unit.

The first embodiment, the second embodiment, and the third embodiment according to the present invention have some portions in common, which will be described hereinafter with reference to reference numerals thereof. The mask according to the present invention includes a filter 110, 210, or 310, which covers the vicinities of the nose and the mouth of the user, and a frame unit 160, 260, or 360, which is coupled to the filter 110, 210, or 310 so as to be brought into tight contact with at least part of the first fixing region of the user to fix the filter to the face of the user.

The first fixing region includes, among regions of the face of the user, at least one of:
1) a 1-1^{st} fixing region, which is a lower facial region including a range from a position including a styloid process of the user to a premolar of the user in consideration of the movement range of the sagittal or anteroposterior axis and including a temporal process of the user in consideration of the movement range of the longitudinal or craniocaudal axis;
2) a 1-2^{nd} fixing region, which is a lower facial region including a range from a position including a parotid gland of the user to a region left by excluding a region in which a funiculus anterior is located from two branches of a medial pterygoid of muscles of mastication of the user in consideration of the movement range of the sagittal or anteroposterior axis and including the temporal process of the user in consideration of the movement range of the longitudinal or craniocaudal axis;
3) a 1-3^{rd} fixing region, which is a lower facial region including a range from a position including the styloid process of the user to a masseter muscle of the muscles of mastication of the user in consideration of the movement range of the sagittal or anteroposterior axis and including the temporal process of the user in consideration of the movement range of the longitudinal or craniocaudal axis, wherein a muscle belly, which is the most protruding portion of the masseter muscle, is excluded;
4) a 1-4^{th} fixing region, which is a lower facial region including a range from a front end of a tragus of the user to a region in which a rear surface of a zygomaticus major of the user is not pressed in consideration of the movement range of the sagittal or anteroposterior axis and including the temporal process of the user in consideration of the movement range of the longitudinal or craniocaudal axis;
5) a 1-5^{th} fixing region, which is a triangular region having a temple, an angle of mandible, and an inferior border of mandible of the user as vertices;
6) a 1-6^{th} fixing region corresponding to the interior of a square provided based on the face of the user,
wherein the square provided based on the face of the user is a square having the angle of mandible and the zygomatic process of the user as one surface, and the square provided based on the face of the user has the sagittal or anteroposterior axis and the longitudinal or craniocaudal axis as a width and a length, respectively, and the distance from the angle of mandible to the zygomatic process in the longitudinal or craniocaudal axis is the length of one side; or
7) a 1-7^{th} fixing region in which values of (x,y) provided based on the face of the user are (−1,−1), (1,−1), (2,−1), (3,−1), (4,−1), (−1,1), (1,1), (2,1), (3,1), (4,1), (5,1), (−1,2), (1,2), (2,2), (3,2), (−1,3), (1,3), (2,3), (−1,4), (1,4), (−1,5), (1,5), and (2,5),
wherein (x,y) provided based on the face of the user is a position based on coordinates of each of small squares formed when the width and the length of the square provided based on the face of the user are divided into five equal parts, in which “x” is designated as 1, 2, 3, 4, and 5 from a rear surface to a front surface of the head of the user, and “y” is designated as 1, 2, 3, 4, and 5 from an upper surface to a lower surface of the head of the user,
wherein “x” of the small square of the square provided based on the face of the user, which is further disposed in symmetry based on the longitudinal or craniocaudal axis of the rear surface of the head of the user, is designated as a negative value, “y” of the small square of the square provided based on the face of the user, which is further disposed in symmetry based on the lateral axis of the upper surface of the head of the user, is designated as a negative value, and
wherein “x” and “y” of the small square of the square provided based on the face of the user, which is further disposed in symmetry based on apexes of the upper surface and the rear surface of the head of the user, are designated as negative values.

The values of (x,y) provided based on the face of the user applied to the 1-6^{th} fixing region may be (1,1), (2,1), (3,1), (4,1), (1,2), (2,2), (3,2), (1,3), (1,4), (1,5), (2,5), (1,−1), and (−1,1), may be (2,2), (4,2), (1,3), (3,3), (4,3), (5,3), (1,4), (2,4), (3,4), (4,4), (5,4), (1,5), (2,5), (4,5), (5,5), (1,1), (1,−1), and (−1,1), or may be (2,1), (2,2), (1,3), (4,3), (5,3), (1,4), (2,4), (4,4), (5,4), (1,5), (2,5), (5,5), (1,1), (1,−1), and (−1,1). The values of (x,y) provided based on the face of the user applied to the 1-6^{th} fixing region may preferably be (2,2), (1,3), (2,4), (1,5), (2,5), (1,1), (1,−1), and (−1,1), more preferably (2,2), (1,3), (1,−1), and (−1,1).

The values of (x,y) provided based on the face of the user applied to the 1-7^{th} fixing region are (−1,−(−1,2), (1,2), (−1,3), and (1,3).

An excellent effect of the 1-1^{th} fixing region to the 1-7^{th} fixing region was proved through <First experiment>, <Second experiment>, and <Fixing force experiment> described above. The 1-1^{st} fixing region to the 1-7^{th} fixing region correspond to regions that a fixing portion 184, 284, or 384 tightly contacts and presses.

The mask according to the present invention may be broadly divided into a filter 110, 210, or 310 and a frame unit 160, 260, or 360. Each of the first embodiment, the second embodiment, and the third embodiment according to the present invention is an exemplary embodiment made by a specific combination of the filter and the frame unit.

In the conventional mask, a metallic member is inserted into an outer periphery of the mask, which is formed of a non-woven fabric, in order to prevent leakage from the peripheral portion of the nose of the user, and the user deforms the metallic member so that the metallic member is brought into tight contact with the peripheral portion of his/her nose. This configuration has a shortcoming in that leakage easily occurs when the user talks, moves his/her head, or moves his/her facial muscles, and the user needs to again fit the mask snugly against his/her face whenever leakage occurs.

Nevertheless, in the state in which the user wears the mask, the user may easily experience formation of water droplets on his/her glasses due to air escaping from his/her mouth.

The present invention has been made to solve the above problems, and the mask according to the present invention includes a filter 110, 210, or 310, which covers the vicinities of the nose and the mouth of the user, a frame unit 160, 260, or 360, which is disposed along an outer surface of the filter, and a fixing portion 184, 284, or 384, which is formed at each end of the frame unit 160, 260, or 360 to couple the frame unit 160, 260, or 360 to the filter 110, 210, or 310 and is formed so as to be brought into tight contact with at least part of the face of the user to fix the filter 110, 210, or 310 and the frame unit 160, 260, or 360 to the face of the user.

The frame unit 160, 260, or 360 includes a pressing portion 274 or 374 formed so as to press an outer surface of an upper filter surface 114, 214, or 314, which is a part of the filter 110, 210, or 310, so that the upper filter surface 114, 214, or 314 is brought into tight contact with the skin of at least part of the nose of the user and the skin of the peripheral portion of the nose, wherein the pressing portion 274 or 374 presses:
1) the surface of the upper filter surface 114, 214, or 314, opposite the skin of the user, against a first pressed region, which is at least part of a nasolabial fold region of the user, so that the upper filter surface 114, 214, or 314 is brought into tight contact with the skin of the user,
2) the surface of the upper filter surface 114, 214, or 314, opposite the skin of the user, against a second pressed region, which is at least part of a levator labii superioris (refer to FIGS. 23 and 24) or a levator labii superioris alaeque nasi (refer to FIG. 24) of the user, so that the upper filter surface 114, 214, or 314 is brought into tight contact with the skin of the user, or
3) the surface of the upper filter surface 114, 214, or 314, opposite the skin of the user, against a third pressed region, which is at least part of an outer periphery of each of alar creases of the user, so that the upper filter surface 114, 214, or 314 is brought into tight contact with the skin of the user.

The excellent effect in which the fixing force is increased when the pressing portion 274 or 374 according to the present invention is added was proved through <Measurement of fixing force generated by addition of pressing portion>. In addition, in the present invention, it is confirmed through <Measurement of official leakage rate> that the leakage rate is very low due to the pressing portion, and is maintained at a low level even when the chin of the user is moved.

The pressing portion 274 or 374 brings the upper filter surface 114, 214, or 314 into tight contact with the skin of the user, and at the same time, allows the mask to be supported by the face of the user.

The mask 100 according to the first embodiment of the present invention is configured such that no pressing portion is formed on a frame main body 170 of the frame unit 160. However, in the case of the mask 100 according to the first embodiment of the present invention, the frame main body 170 of the frame unit 160 is deformed so as to perform the same function as the pressing portion 274 of the mask 200 according to the second embodiment of the present invention and the pressing portion 374 of the mask 300 according to the third embodiment of the present invention.

The filter 110, 210, or 310 includes a filter main body 112, 212, or 312, which is disposed on a front surface of the face of the user, an upper filter surface 114, 214, or 314, which is fixed along at least part of the outer periphery of the upper portion of the filter main body 112, 212, or 312, is fixed while being spaced downwards apart from at least part of the outer periphery of the upper portion of the filter main body 112, 212, or 312, or is formed as the result of the upper portion of the filter main body 112, 212, or 312 being bent to cover the nose of the user and the peripheral portion of the nose, a lower filter surface 116, 216, or 316, which is fixed along at least part of the outer periphery of the lower portion of the filter main body 112, 212, or 312, is fixed while being spaced upwards apart from at least part of the outer periphery of the lower portion of the filter main body 112, 212, or 312, or is formed as the result of the lower surface of the filter main body 112, 212, or 312 being bent to cover the skin of at least part of the chin of the user and the skin of the peripheral portion of the chin, and a side filter surface 118, 218, or 318, which is formed at each of opposite sides of the filter main body 112, 212, or 312 so as to be coupled to the frame unit 160, 260, or 360.

The side filter surface 118, 218, or 318 extends from the filter main body 112, 212, or 312, and is made of the same material as the filter main body 112, 212, or 312. A reinforcing portion may be added to the side filter surface 118, 218, or 318.

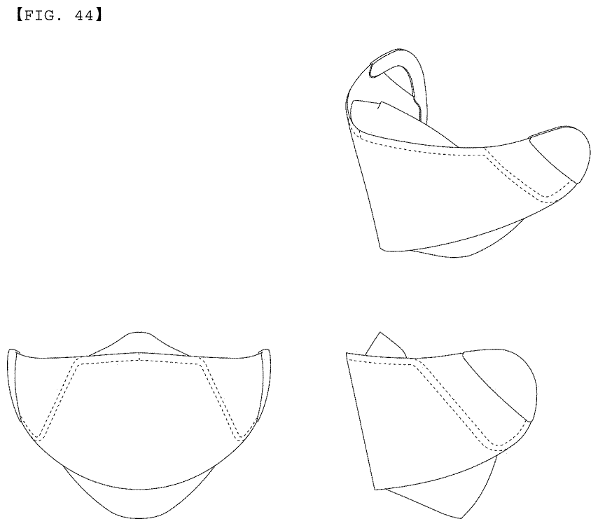

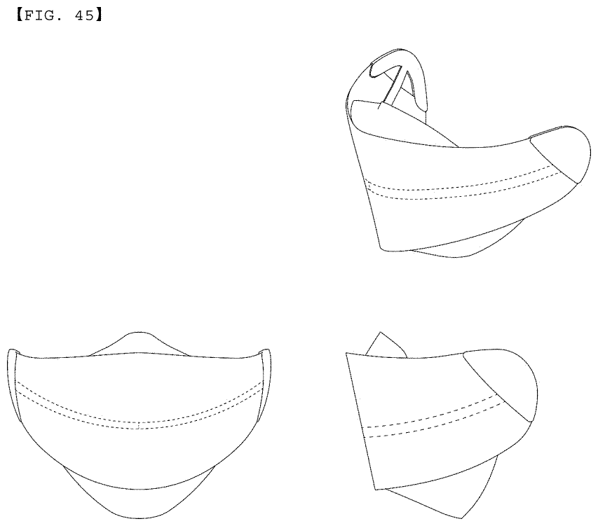

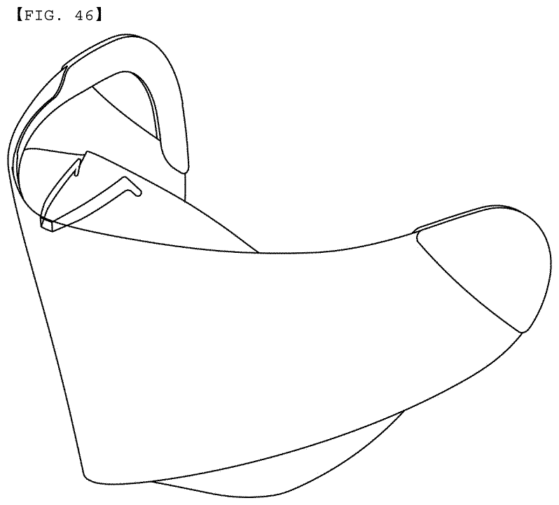

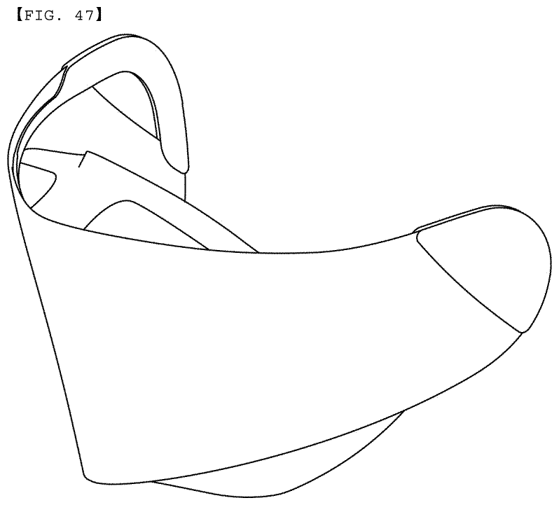

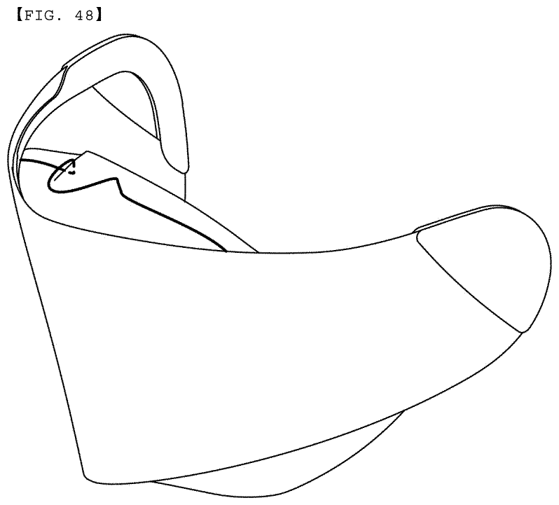

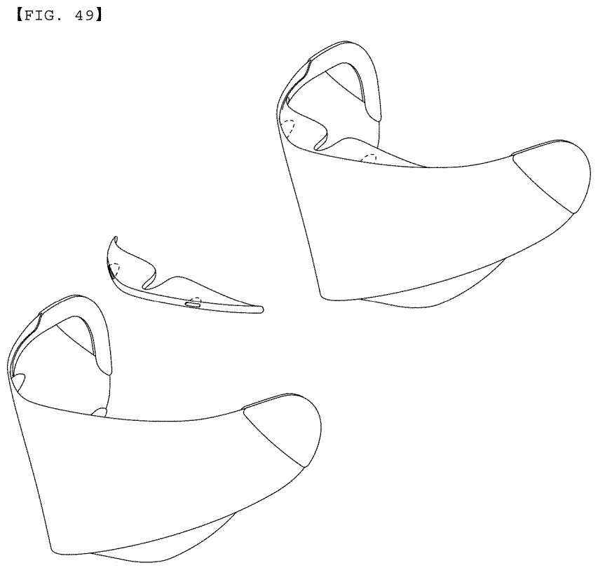

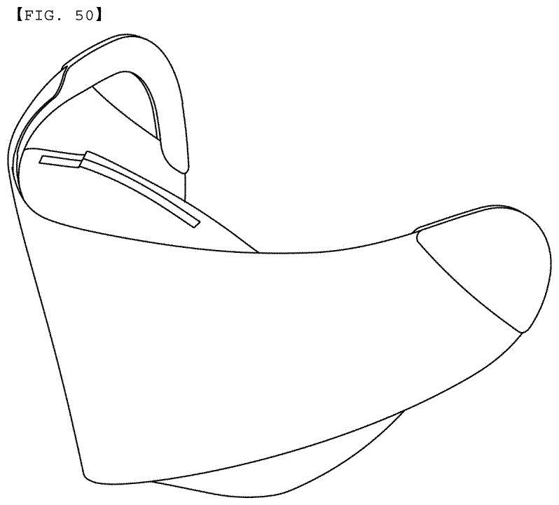

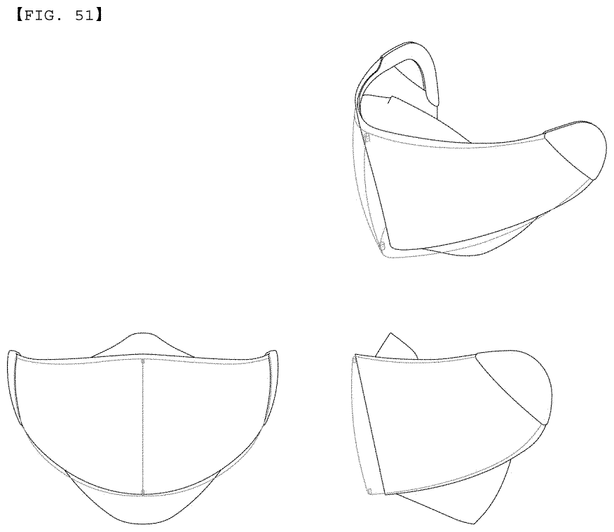

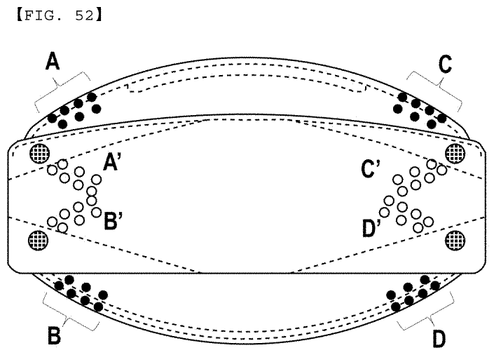

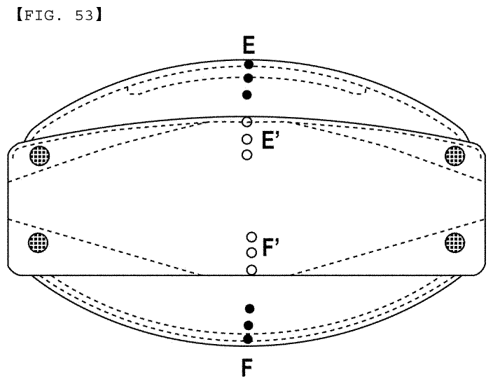

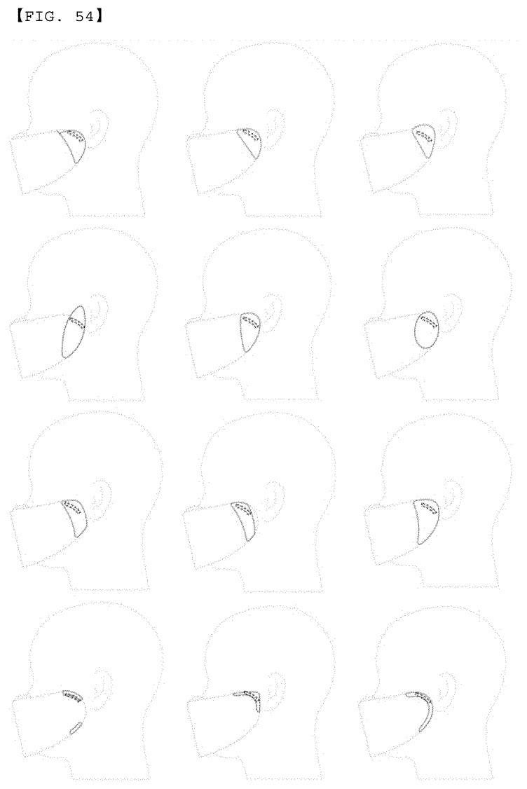

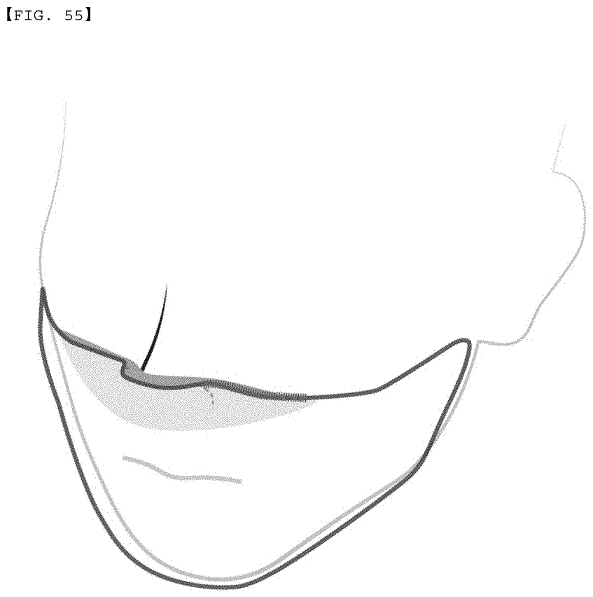

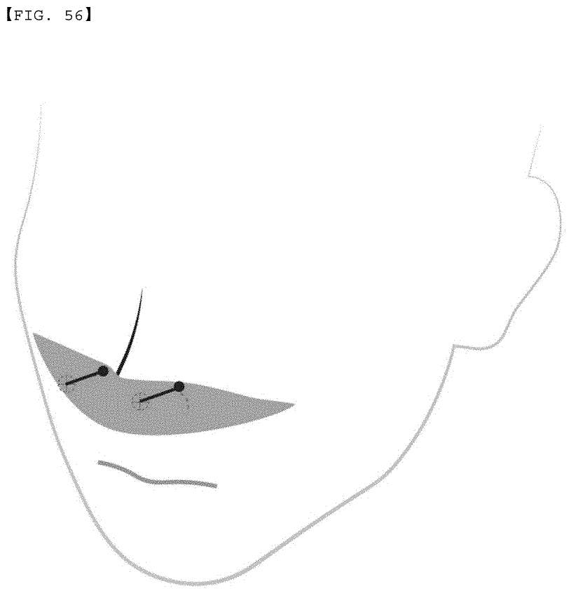

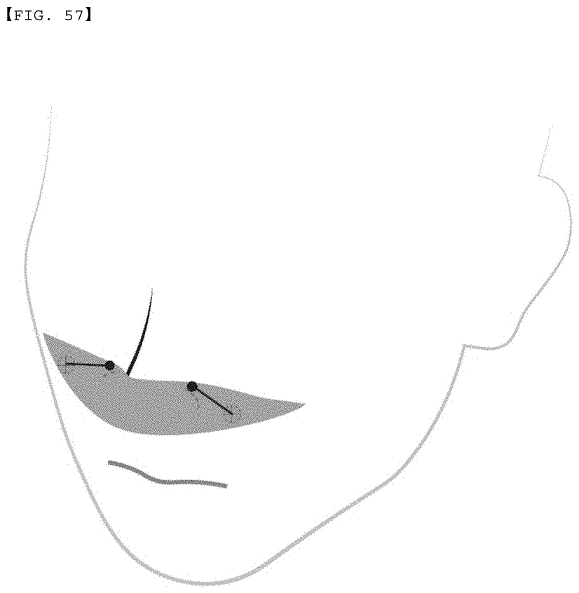

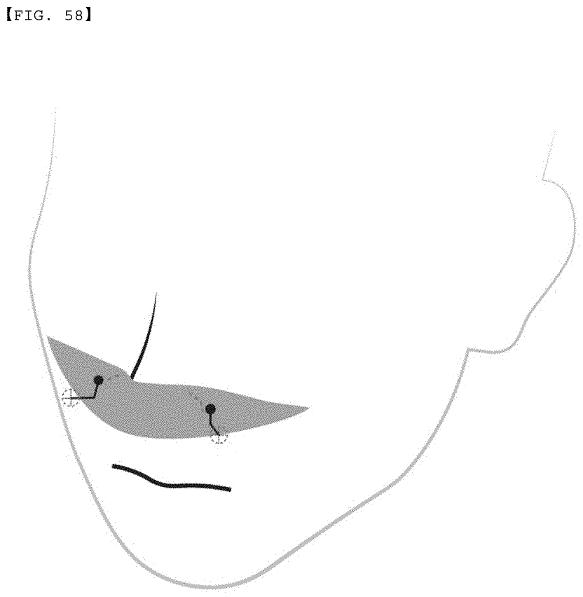

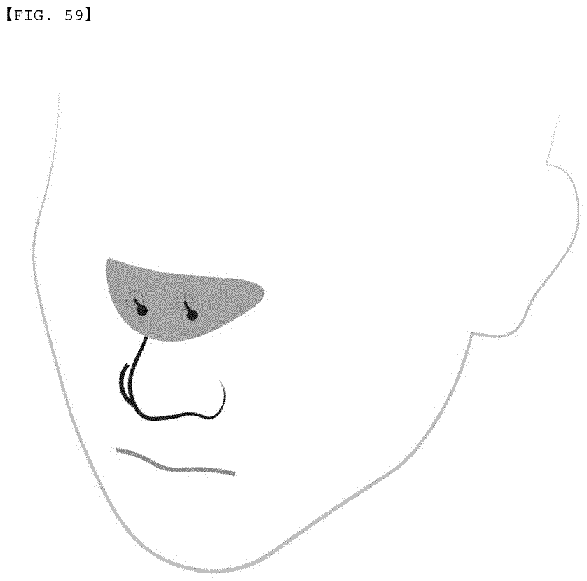

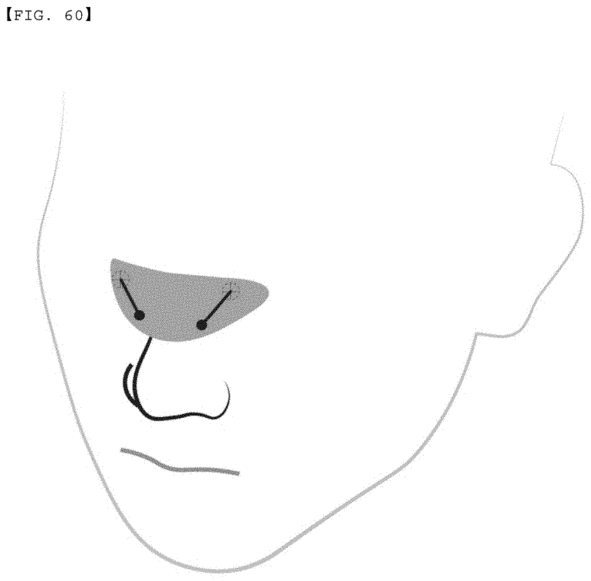

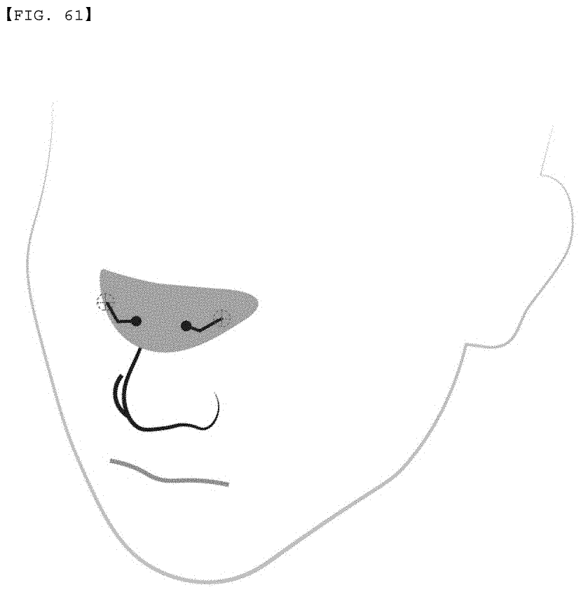

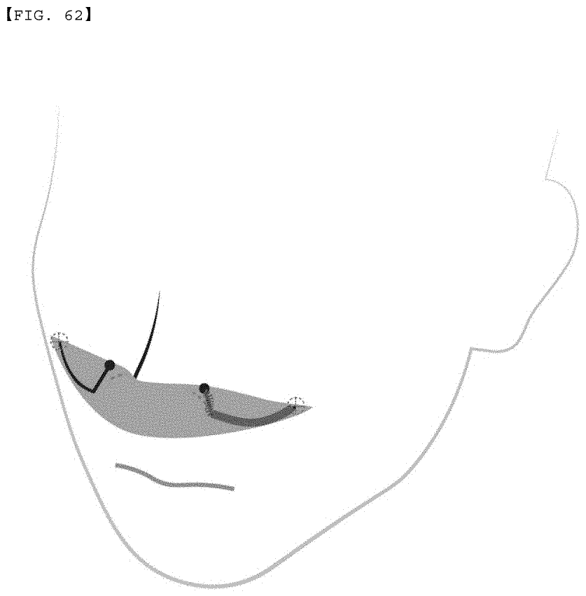

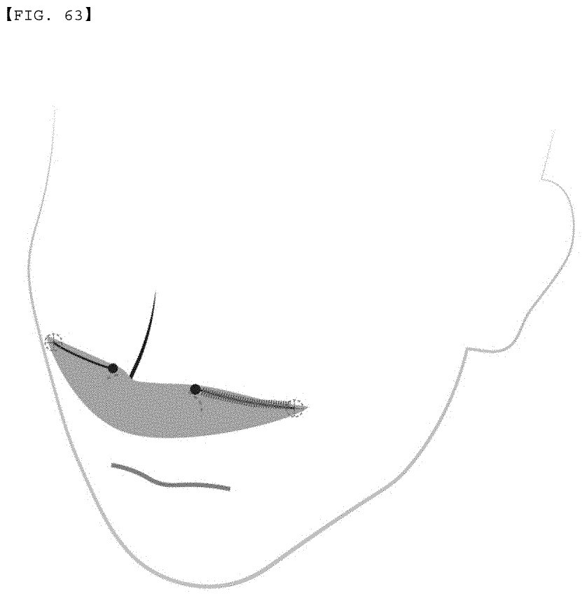

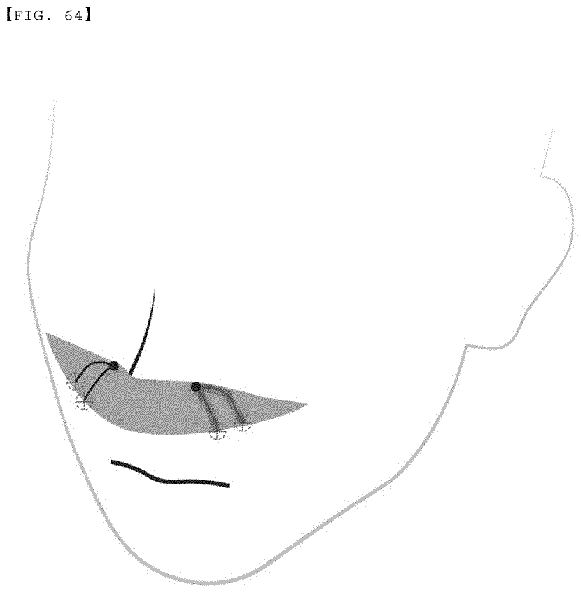

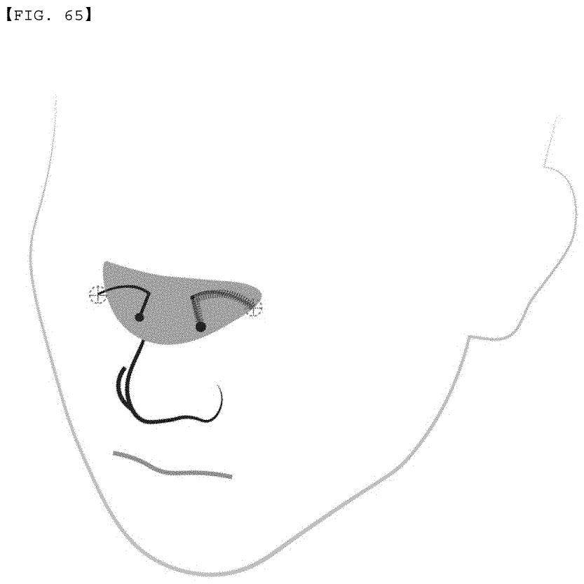

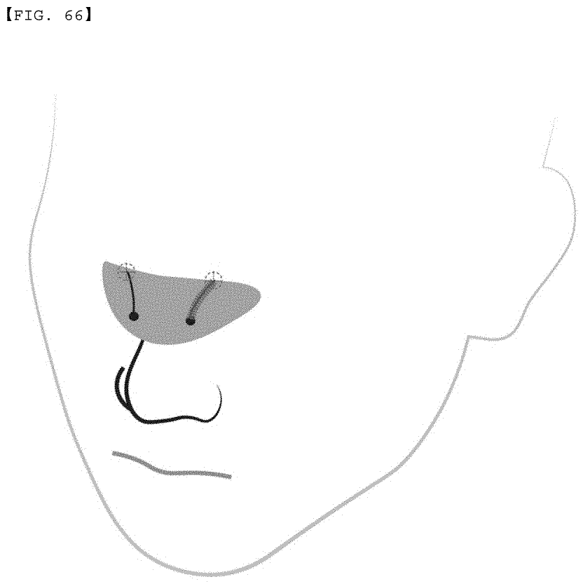

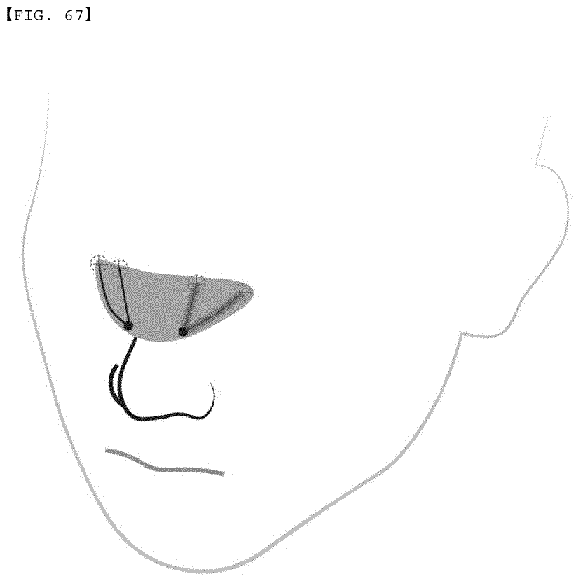

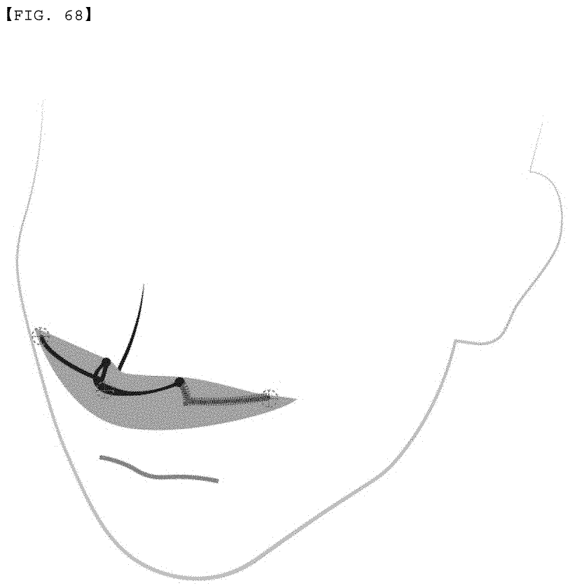

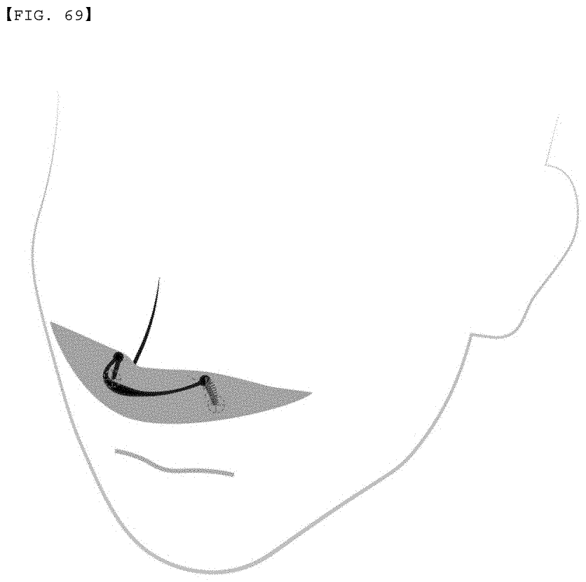

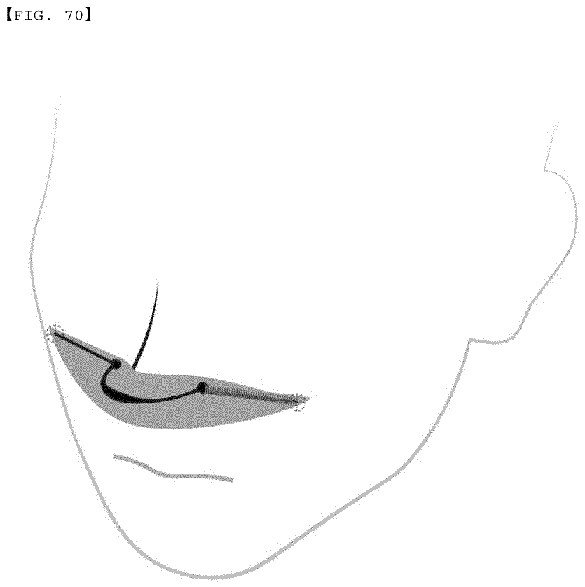

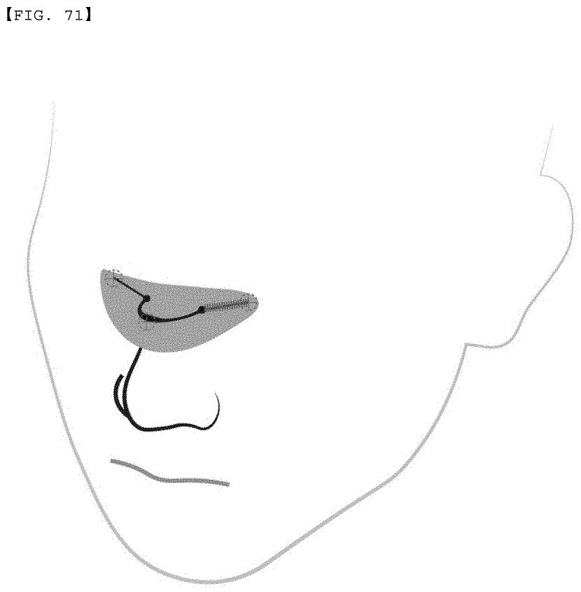

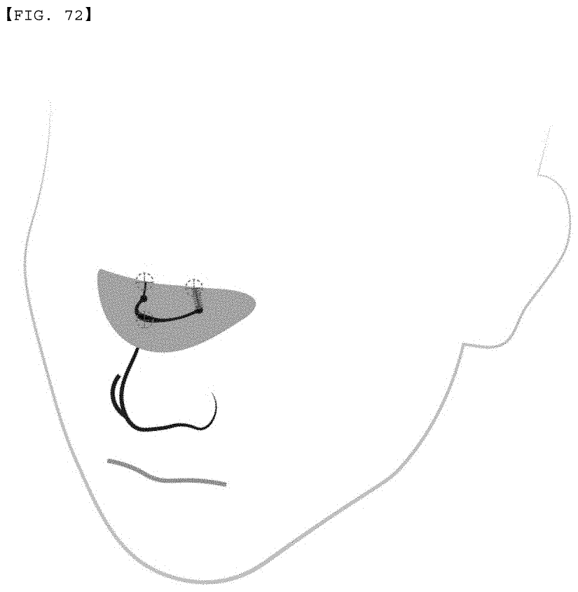

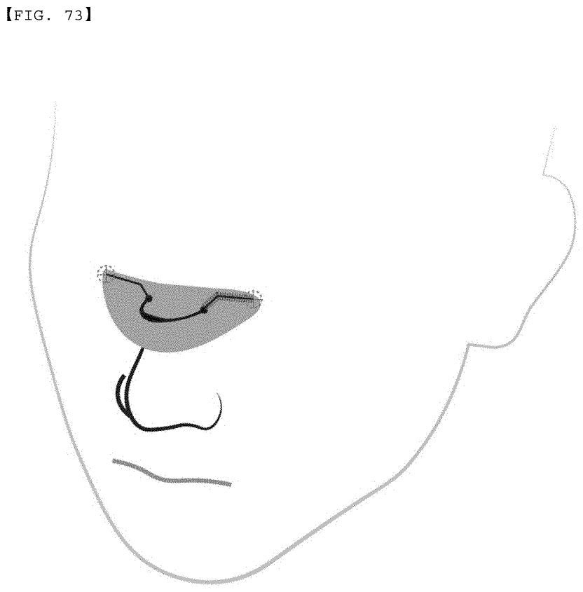

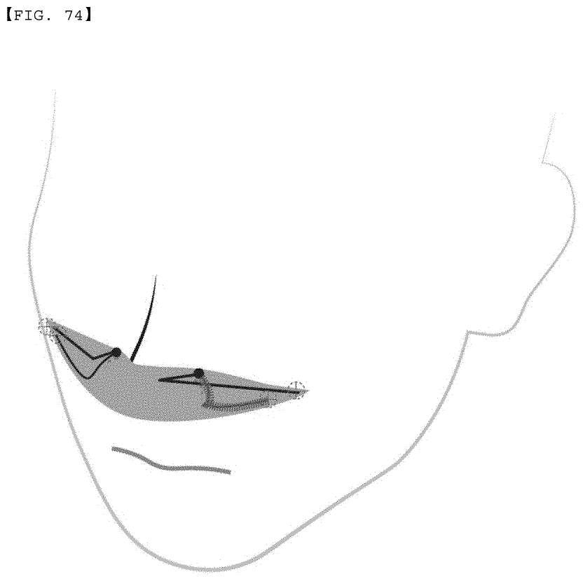

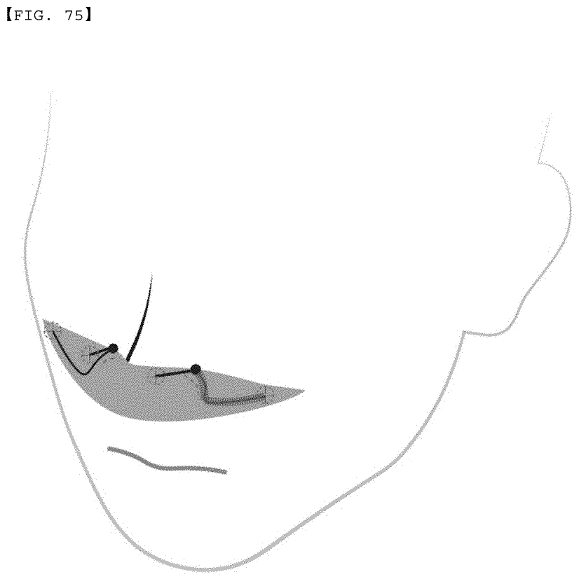

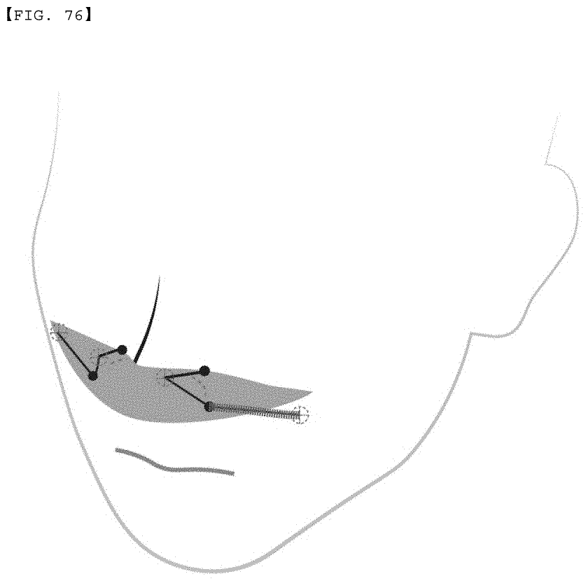

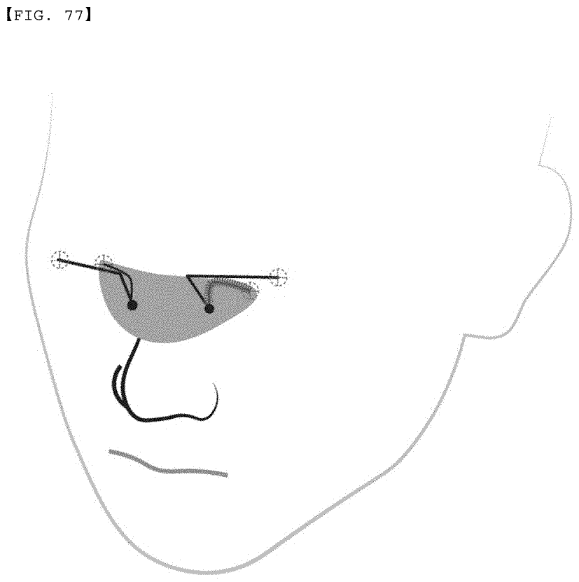

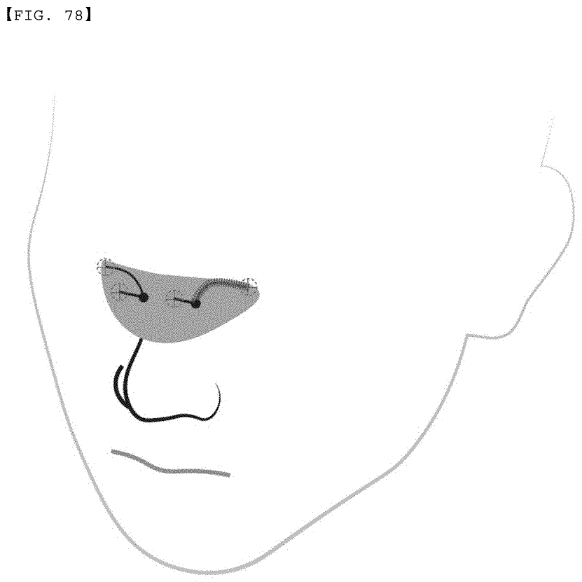

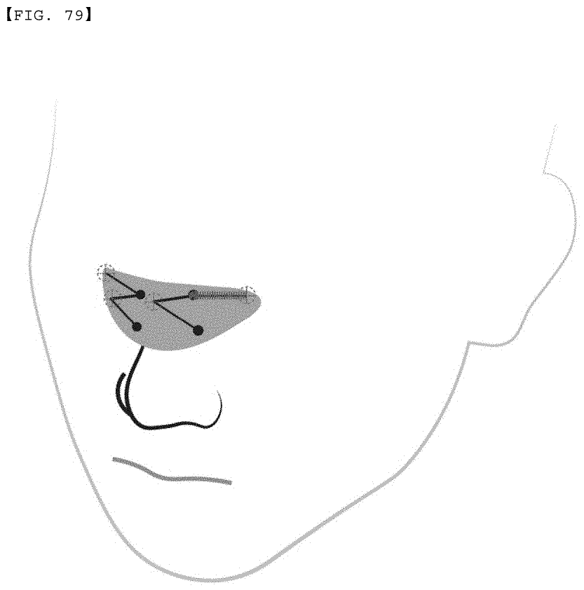

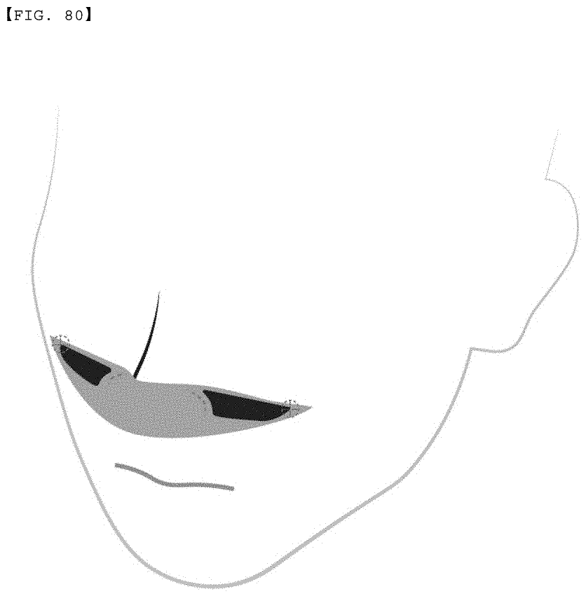

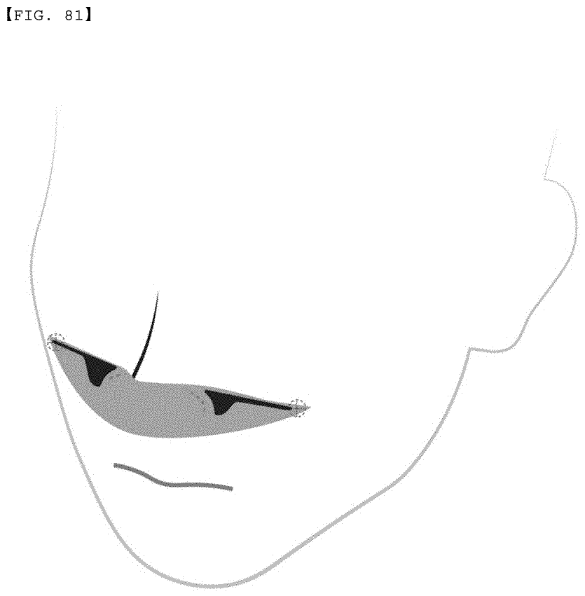

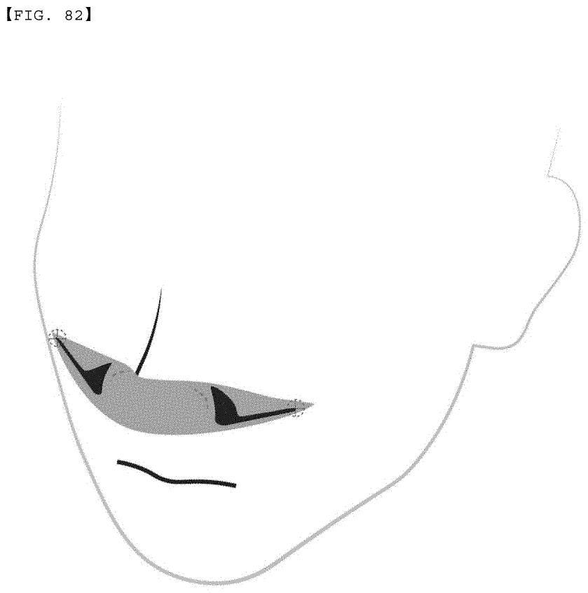

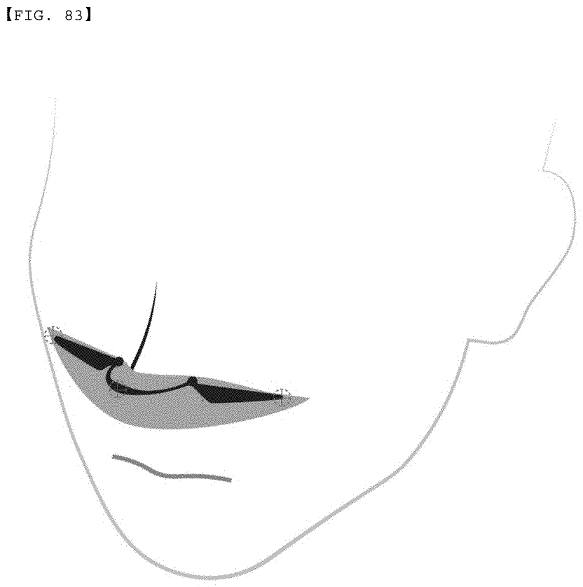

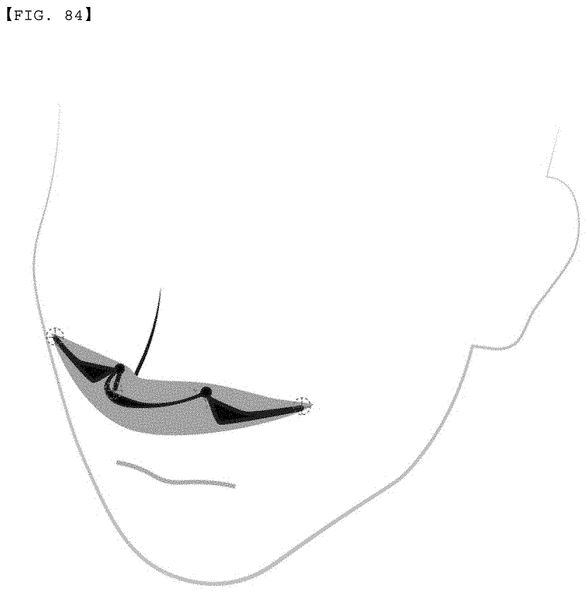

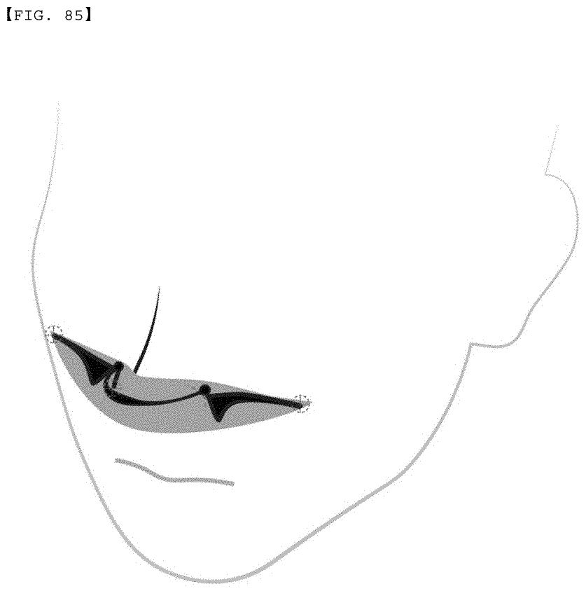

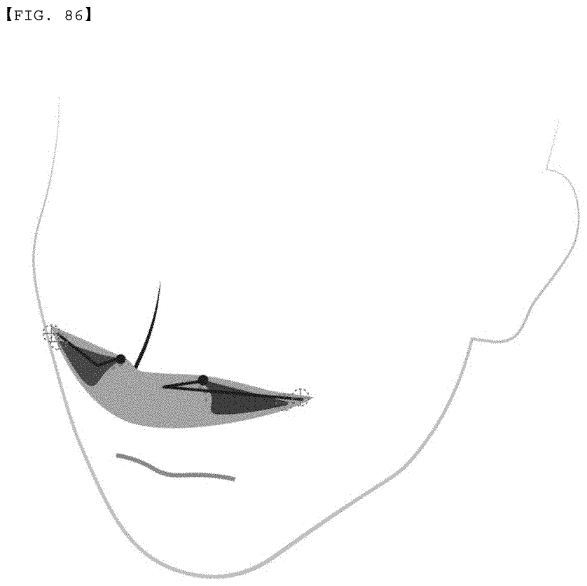

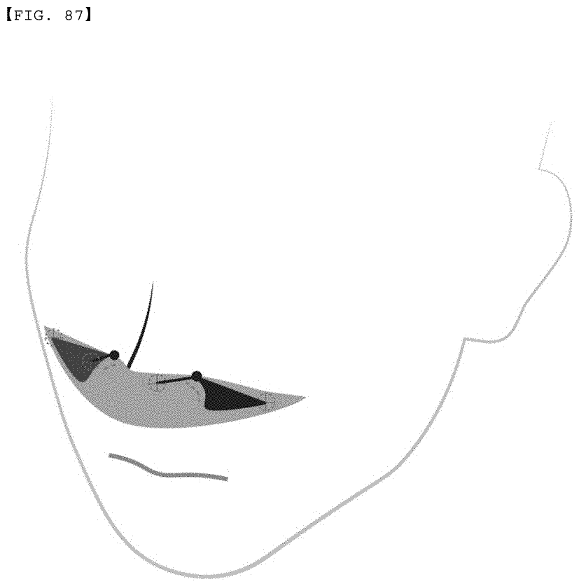

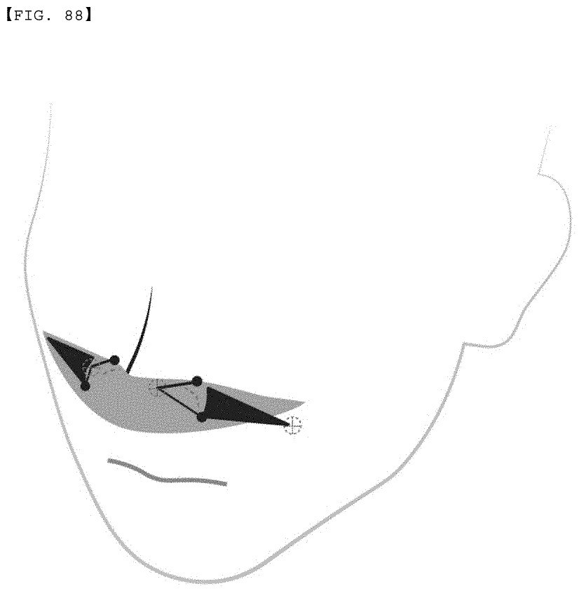

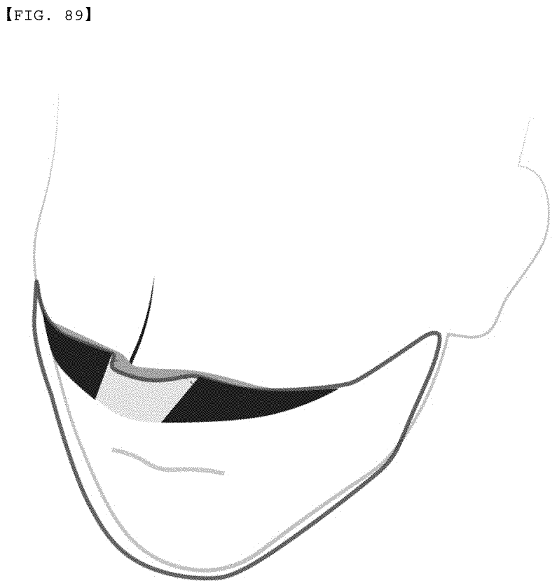

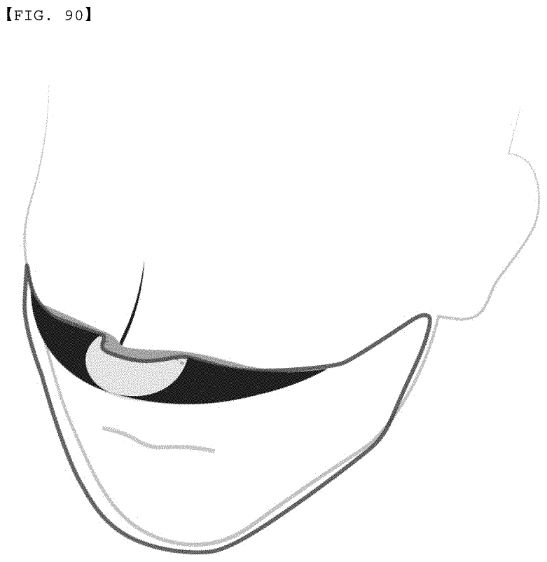

FIGS. 34 to 39 show various examples of a structure in which the frame main body according to the present invention is coupled to the outer surface of the mask, and FIGS. 40 to 45 show various examples of a structure in which the frame main body according to the present invention is coupled to the inner surface of the mask.

Although the frame main body is illustrated in FIGS. 34 to 45 as being coupled only to the outer surface or the inner surface of the mask, the frame main body may be coupled to both the inner surface and the outer surface of the mask.

FIGS. 34 and 40 show structures in which the frame main body is coupled to the upper portion of the filter main body, FIGS. 35 and 41 show structures in which the frame main body is coupled to the lower portion of the filter main body, and FIGS. 36 and 42 show structures in which the frame main body is coupled to each of the upper portion and the lower portion of the filter main body. FIGS. 37, 38, 43, and 44 show structures in which the frame main body is deformed so as to extend from the upper portion to the lower portion of the filter main body or from the lower portion to the upper portion of the filter main body.

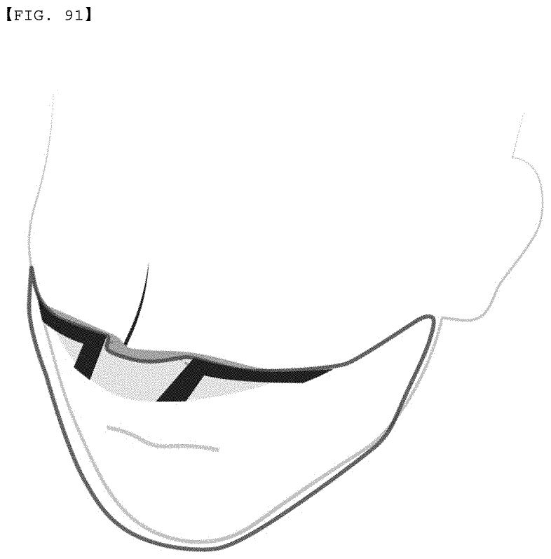

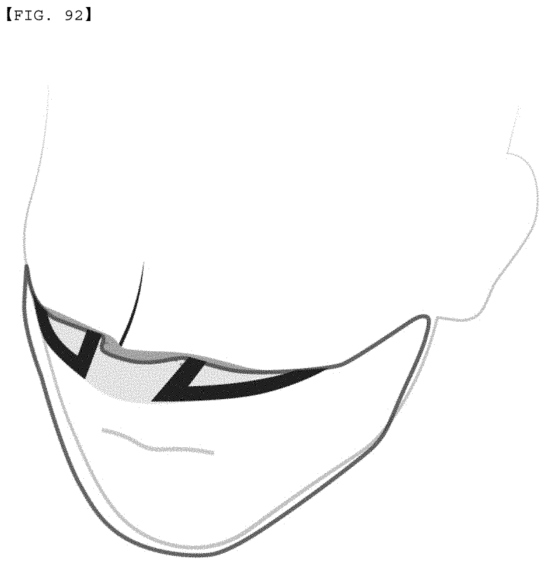

FIGS. 39 and 45 show structures in which the frame main body is coupled to the middle portion of the filter main body.

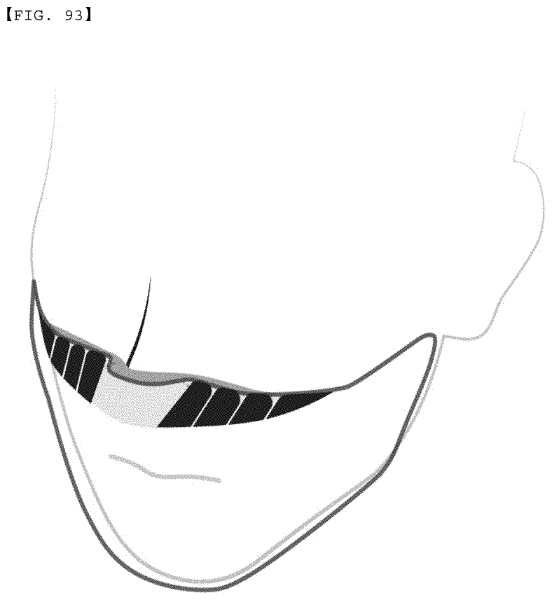

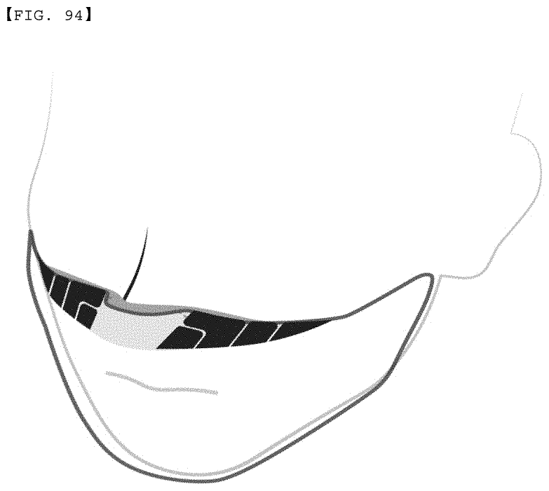

FIGS. 46 to 49 show various examples of the pressing portion of the present invention.

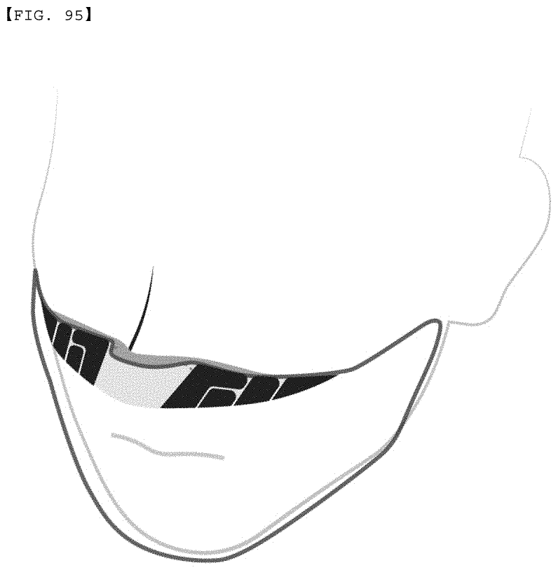

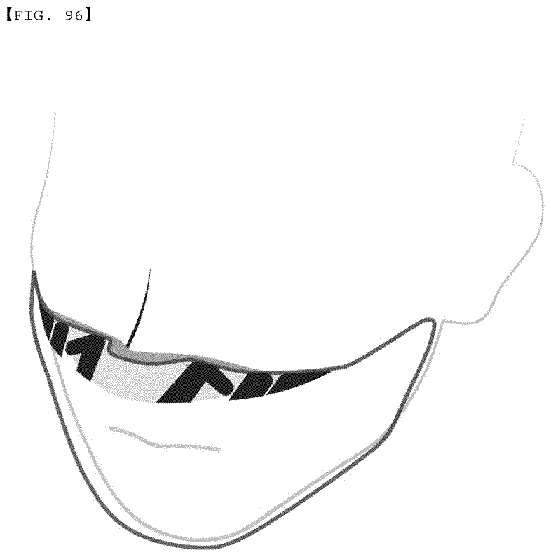

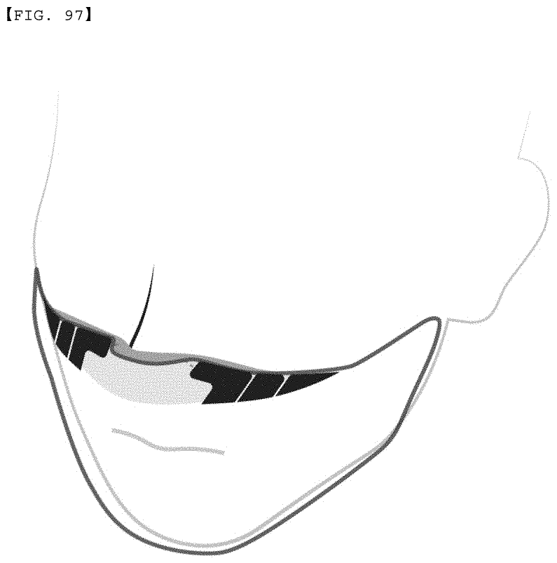

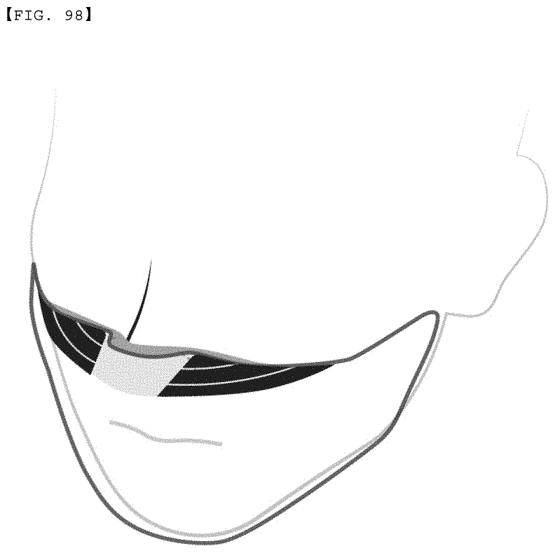

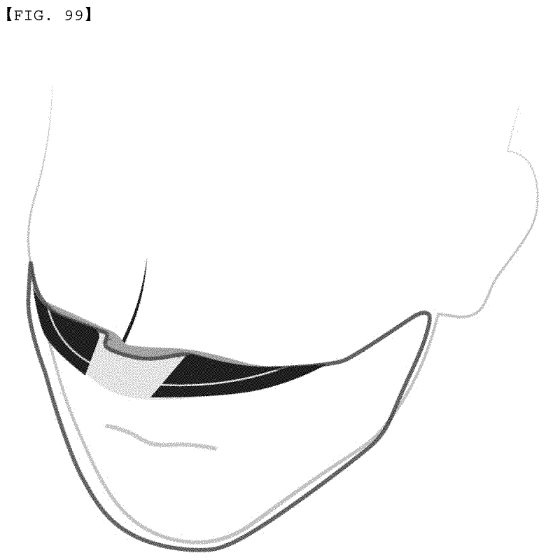

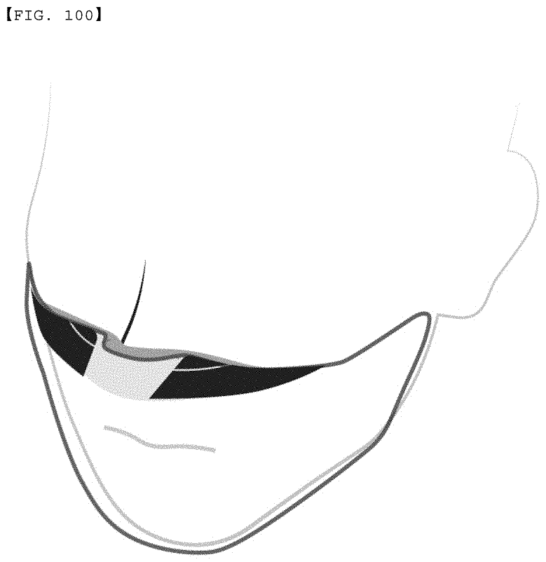

FIG. 46 shows that the pressing portion is implemented as two support portions protruding from the frame main body, and FIG. 47 shows that the pressing portion is formed in a shape of a plane coupled to the frame main body at three points. FIG. 48 shows that the pressing portion is implemented as an elastic metal spring. FIG. 49 shows a structure in which an elastic member having a predetermined volume is separately provided and coupled to the frame main body.

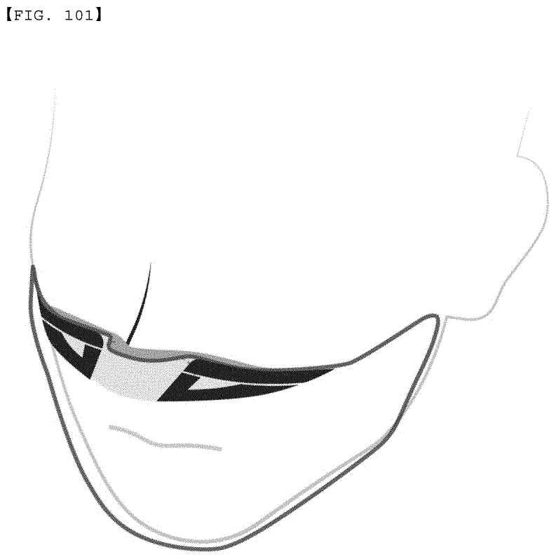

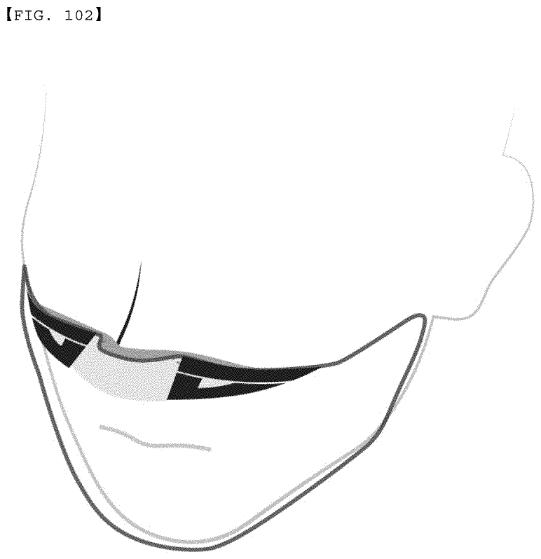

FIG. 50 shows an example of a clip according to an embodiment of the present invention.

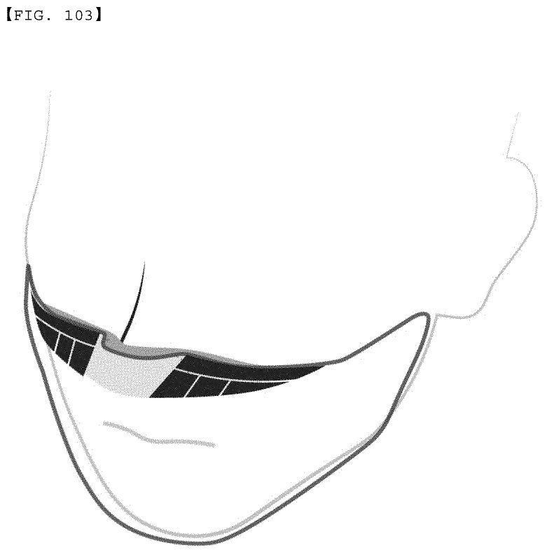

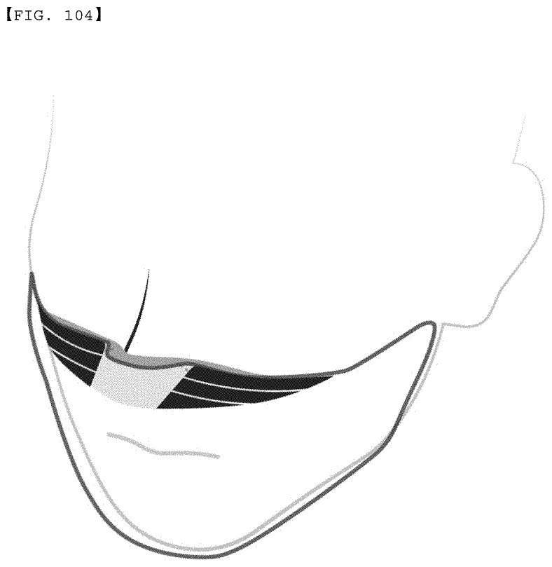

FIG. 51 is a schematic view of a structure in which an additional protective layer is provided on the outer surface of a mask according to an embodiment of the present invention. The protective layer may be made of a fiber, a polymer resin, a filtering material, a non-woven fabric, metal, or the like to form a separate screen outside the mask.

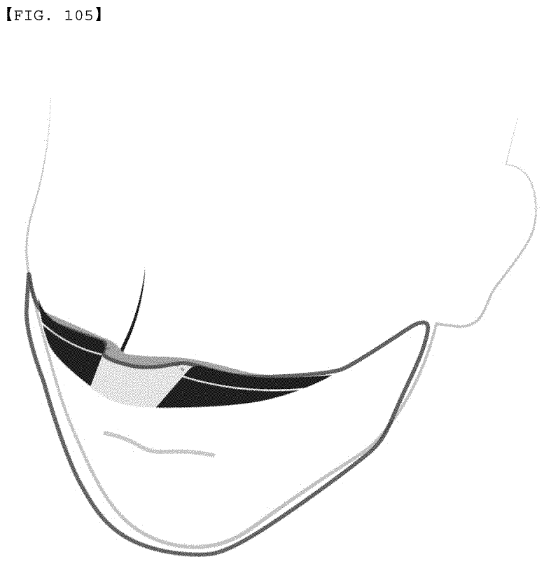

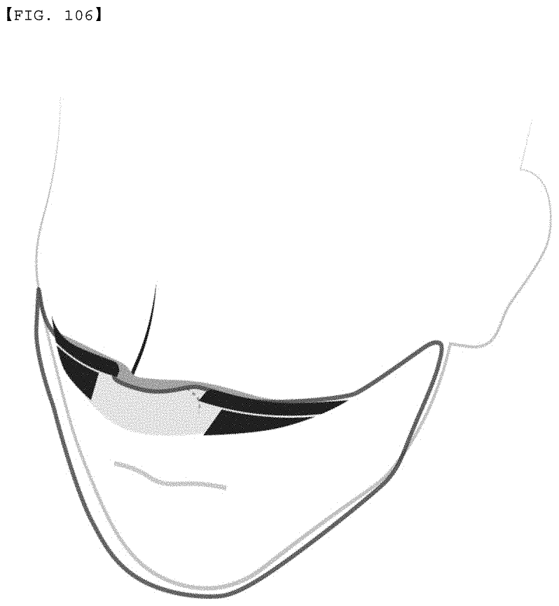

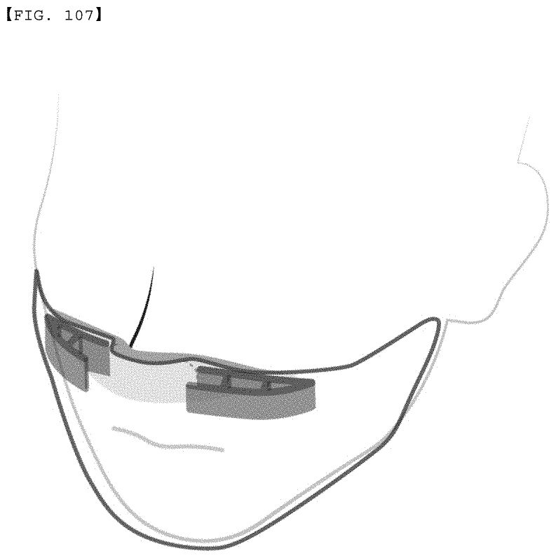

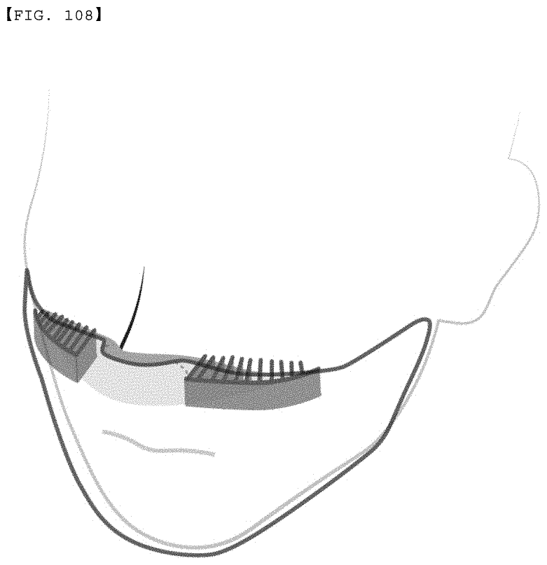

Referring to FIG. 52 or 53, one or more first coupling portions (at least one of a plurality of points corresponding to A-A′, B-B′, C-C′, and D-D′) fixed to the filter main body 112, 212, or 312 may be provided at opposite sides of the upper filter surface 114, 214, or 314 and/or the lower filter surface 116, 216, or 316, and the first coupling portions (at least one of a plurality of points corresponding to A-A′, B-B′, C-C′, and D-D′) may have a detachable coupling structure. One or more second coupling portions (at least one of a plurality of points corresponding to E-E′ and F-F′) fixed to the filter main body 112, 212, or 312 may be provided at the middle of the upper filter surface 114, 214, or 314 and/or the lower filter surface 116, 216, or 316, and the second coupling portions (at least one of a plurality of points corresponding to E-E′ and F-F′) may have a detachable coupling structure. Here, the detachable coupling structure must be configured such that the coupling portions can be detached from each other without damage to the filter main body 112, 212, or 312, the upper filter surface 114, 214, or 314, and the lower filter surface 116, 216, or 316. As another example, the detachable coupling structure may be at least one selected from the group consisting of Velcro tape, snap buttons, and clips. A range within which the upper filter surface 114, 214, or 314 can be disposed may be between tip-defining points and a lower end of the nasal bone.

In FIG. 52 or 53, A-A′, B-B′, C-C′, D-D′, E-E′, and F-F′ are marked as an example of regions that can be coupled to each other. Each of A, B, C, D, E, and F is marked with a plurality of points, and at least one thereof may become a coupling region. Coupling regions A, B, C, D, E, and F are coupled to corresponding coupling regions A′, B′, C′, D′, E′, and F′, respectively. A, B, C, and D are examples of the first coupling portions, and E and F are examples of the second coupling portions.

When the first coupling portions and the second coupling portions are disposed along the outer peripheries of the upper filter surface 114, 214, or 314 and the lower filter surface 116, 216, or 316, strength in tight contact is high. Even if a portion of the upper filter surface 114, 214, or 314 or the lower filter surface 116, 216, or 316 is damaged at the time of detachment, therefore, there is no problem. In this case, tight contact with the face of the user is achieved by the remaining portion of the upper filter surface 114, 214, or 314 or the lower filter surface 116, 216, or 316, since the damaged portion of the upper filter surface or the lower filter surface is the outermost portion of the upper filter surface or the lower filter surface. In this case, the coupling portions disposed along the outer peripheries of the upper filter surface and the lower filter surface, among examples of A-A′, B-B′, C-C′, D-D′, E-E′, and F-F′, correspond thereto.

The upper filter surface 114, 214, or 314 or the lower filter surface 114, 214, or 314 may be provided with separate wrinkles formed at positions corresponding to the first coupling portions or the second coupling portions. The wrinkles may be curved along the contour line of the face, particularly the contour line of the jaws, rather than being straight.

A maximum vertical range within which the upper filter surface 114, 214, or 314 can be disposed may be between the tip-defining points and the lower end of the nasal bone.

FIGS. 22 to 24 are schematic anatomical diagrams showing the face on which the first to third pressed regions according to the present invention can be disposed. The nasal bone is shown in FIG. 22, and the tip-defining points are parts that are commonly referred to as a nasal tip.

The frame unit 160, 260, or 360 includes a frame main body 170, 270, or 370, which has a semicircular band shape and is disposed on the upper surface of the upper filter surface 114, 214, or 314, and a coupling portion 180, 280, or 380, which extends from each of opposite ends of the frame main body 170, 270, or 370 so as to be coupled to the side filter surface 118, 218, or 318.

The frame main body 270 may be provided with connecting portions 277 and 278, which are disposed at the middle of the frame main body 270 to allow the frame main body 270 to be folded. The connecting portions 277 and 278 may be made of an elastic material or a flexible material, or may be of a hinge type.

At least a portion of the frame main body 170, 270, or 370 may be coupled to at least one of the filter main body 112, 212, or 312, the upper filter surface 114, 214, or 314, or the lower filter surface 116, 216, or 316. Preferably, the middle portion of the frame main body 170, 270, or 370 is fused with the filter main body 112, 212, or 312, the upper filter surface 114, 214, or 314, or the lower filter surface 116, 216, or 316.

At least a portion of the frame main body 170, 270, or 370 may be coupled to at least one of the inner surface or the outer surface of at least one of the filter main body 112, 212, or 312, the upper filter surface 114, 214, or 314, or the lower filter surface 116, 216, or 316. FIGS. 34 to 45 show various examples in which the frame main body can be coupled to the filter main body.

The coupling portion 180, 280, or 380 may include a fixing portion 184, 284, or 384, which is directly brought into tight contact with the first fixing region, and a fixing portion cover 182, 282, or 382, which is coupled to the outer surface of the fixing portion 184, 284, or 384. The first to third embodiments of the present invention are configured such that the fixing portion cover 182, 282, or 382 is separately provided; however, the frame main body 170, 270, or 370 and the coupling portion 180, 280, or 380 may be formed integrally with each other.

The side filter surface 118, 218, or 318 may be coupled to at least one of one surface of the fixing portion 184, 284, or 384 or one surface of the fixing portion cover 182, 282, or 382, or may be disposed between the fixing portion 184, 284, or 384 and the fixing portion cover 182, 282, or 382. Specifically, coupling of the side filter surface may be achieved through at least one method selected from among fitting, hanging, bonding, adhesion, magnetic force, and fusion.

Preferably, the fixing portion 184, 284, or 384 has a reversed C-shape or an inverted L-shape. The reason for this is to secure the greatest fixing force with a minimum contact area. Since the fixing portion 184, 284, or 384 serves to fix the mask according to the present invention to the first fixing region, the fixing portion is preferably implemented as an elastic member containing silicone having high frictional force and low reactivity to the human body.

The fixing portion 184, 284, or 384 may be formed in any one of a polygonal shape and a circular shape, but it is preferable for the fixing portion to have a shape in which the peripheral portion thereof protrudes, i.e. a C-shape or an inverted L-shape. The reason for this is to prevent the mask from moving forwards away from the face or rotating due to unpressed skin protruding toward the center of the fixing portion 184, 284, or 384 when the fixing portion 184, 284, or 384 presses the skin.

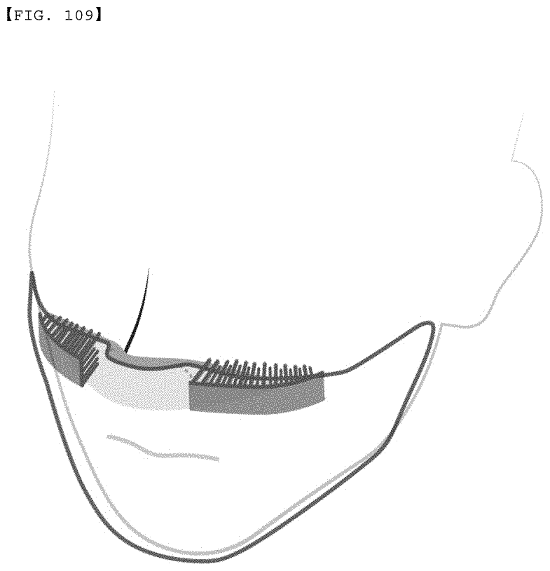

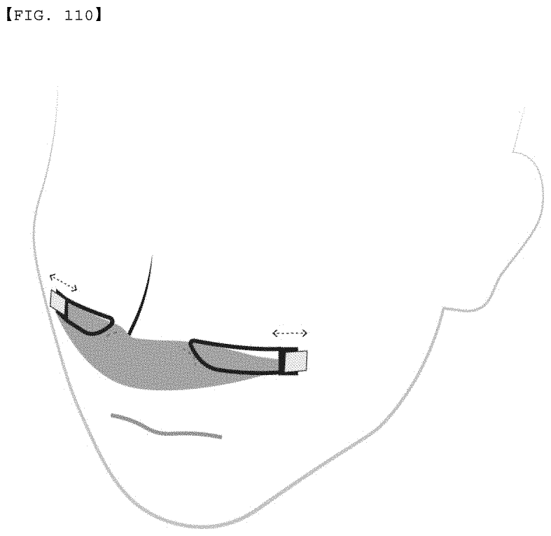

FIG. 54 shows various modified examples of the fixing portion cover 182, 282, or 382 according to the embodiment of the present invention. Although the fixing portion cover 182, 282, or 382 is illustrated in FIG. 54 as having a curved shape, the fixing portion cover may alternatively have a polygonal shape. A portion indicated by the dotted line in FIG. 54 is the fixing portion 184, 284, or 384.

In addition, at least one wing support may be added to the fixing portion 184, 284, or 384. Although not shown in the drawings, the wing support is connected to the fixing portion 184, 284, or 384 to increase the size of a fixing surface, whereby it is possible to secure more stable fixing force.

The fixing portion 184, 284, or 384 may include an elastic member containing silicone. The fixing portion 184, 284, or 384 may be formed integrally with the frame main body 170, 270, or 370, or may be separately provided and added to the frame main body. In either case, the fixing portion is brought into contact with the skin, and therefore the fixing portion needs to be made of a material that is harmless to the human body and can ensure adhesive strength.

A separate protective layer (refer to FIG. 51) may be added to the outer surface of the filter, and the protective layer may be fixed to at least one of the filter or the frame unit. In addition, the protective layer may be made of at least one material selected from among a fiber, a polymer resin, a filtering material, a non-woven fabric, and metal, and may be translucent or opaque.

Although not explicitly shown in the drawings of the first embodiment or the third embodiment, in the case of a heavy mask or in the case in which excessive vibration or motion occurs, an auxiliary fixing portion may be additionally provided so as to be fixed to an auxiliary fixing region located on at least one of a nose, a chin, each ear, a mastoid bone, a back of a neck, or a parietal bone or occipital bone of a head in order to provide additional fixing force. It is possible to secure more stable fixing force using the auxiliary fixing portion. However, since the mask according to the present invention exhibits high fixing force, it is not necessary for the auxiliary fixing portion to strongly press the skin.

A pressing region of the pressing portion 274 or 374 may have at least one shape from among a dot shape, a line shape, and a plane shape, and the pressing portion 274 or 374 may have one or more pressing regions. In addition, in order to increase bonding strength, the pressing region of the pressing portion 274 or 374 may be formed to have fine protrusions.

Further, a region of the pressing portion 274 or 374, to which force is substantially applied, may have at least one shape from among a dot shape, a line shape, a plane shape, and a solid shape. The pressing portion 274 or 374 may be deformed in any of various shapes. In order to exhibit the effect according to the present invention, the pressing portion 274 or 374 needs to press at least one of the first to third pressed regions.

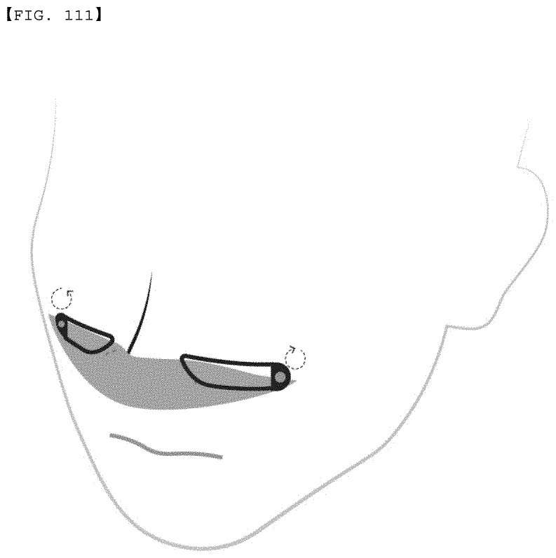

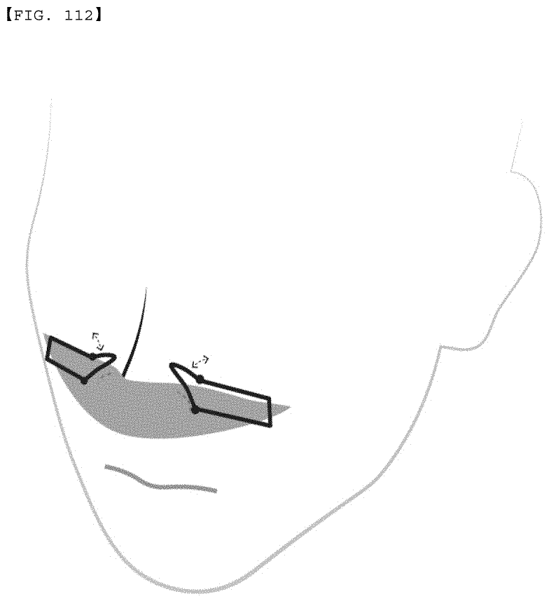

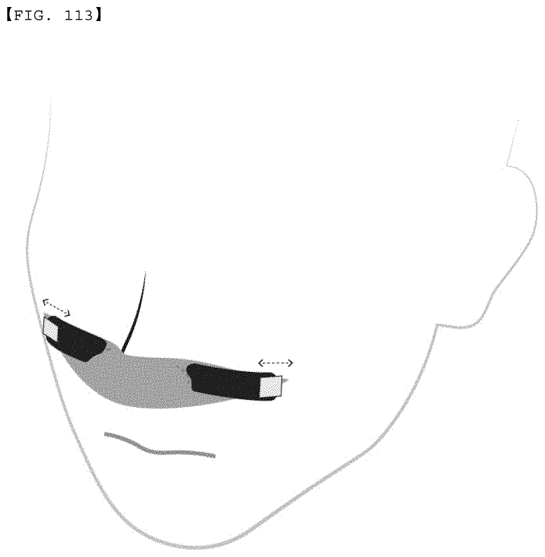

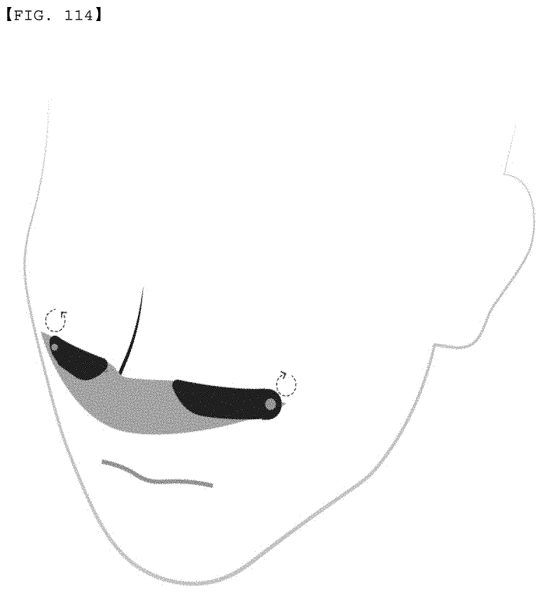

FIGS. 55 to 120 show various examples of the pressing portion according to the present invention.

FIG. 55 illustrates the upper filter surface 114, 214, or 314 of the mask according to the present invention and a portion of the upper filter surface 114, 214, or 314 that is pressed by the pressing portion 274 or 374. In FIG. 55, the upper filter surface 114, 214, or 314 is marked in gray. Dark gray indicates a portion of the upper filter surface 114, 214, or 314 that is exposed to the outside, and light gray indicates a portion of the upper filter surface 114, 214, or 314 that is hidden and invisible.

In FIG. 55, the black solid line surrounding the periphery of the face indicates the outermost edge of the mask. In FIG. 55, the upper filter surface 114, 214, or 314 may be made of an elastic cloth or the same material as the filter. A portion of the upper filter surface 114, 214, or 314 that covers outer peripheries of the alar creases (marked in red or indicated by the hatched lines) is pressed so that the upper filter surface 114, 214, or 314 is brought into tight contact with the skin. In the case of FIG. 55, since the outer peripheries of the alar creases of the nose are pressed, the upper filter surface 114, 214, or 314 may be stretched or deformed so as to be brought into tight contact with the nose without pressing the nasal cartilage.

FIGS. 56 to 79 show that the pressing portion presses a facial region in a dot shape or a line shape.

FIGS. 56 to 67 are schematic views showing only the upper filter surface and the pressing portion pressing the upper filter surface. A portion marked in gray is an example of the upper filter surface according to the present invention. The upper filter surface may cover the alar creases and the peripheral portion thereof (FIGS. 56 to 58 and 62 to 64), or may cover the upper end of the nasal cartilage and the peripheral portion thereof (FIGS. 59 to 61 and 65 to 67).

In FIGS. 56 to 67, the black dot indicates a portion at which the pressing portion presses the outer surface of the upper filter surface against the face of the user. The red circle indicated by the dotted line indicates a portion at which the pressing portion is supported or fixed (hereinafter referred to as a “support portion”). A combination of the black center line and the red waveform on the black center line indicates a portion that is pressed in a line shape. FIG. 55 also shows a portion that is pressed in a line shape. The black dot, at which the upper filter surface is pressed, can be changed in position due to elasticity.

The pressing portion illustrated in FIGS. 56 to 67 is implemented as an elastic spring, one end of which is fixed by the support portion and the other end of which presses the outer surface of the upper filter surface against the face of the user. A region between a point at which the pressing portion presses the upper filter surface and a point at which the pressing portion is fixed has a straight shape (FIGS. 56, 57, 59, 60, 63, and 68), or has a bent portion (FIGS. 58, 61, 62, 64, and 65). A single bent portion may be provided, or a plurality of bent portions may be provided (FIGS. 62 and 64).

The straight region or the region having the bent portion may be changed in shape depending on the direction in which the pressing portion presses the same. The direction in which the pressing portion presses the outer surface of the upper filter surface may be a direction perpendicular to the skin of the user (FIGS. 56, 57, 59, and 61), a direction of wrinkles formed on the face of the user, a direction perpendicular to wrinkles formed on the face of the user (FIG. 62), a direction extending along the outer periphery of the nose of the user (FIG. 63), a direction oriented toward or away from the outer periphery of the nose of the user (FIGS. 57, 58, and 64), a direction of muscles around the nose of the user (FIGS. 60 and 65), or a complex combination of the above directions (FIGS. 61 and 66).

Meanwhile, a relative position of a region that is pressed by the pressing portion may be stationary, or may not be stationary. In FIGS. 56 to 67, the black dot corresponding to a region that is pressed by the pressing portion may be changed in position due to elasticity.

In FIGS. 56 to 58 and 62 to 64, a region that is pressed by the pressing portion corresponds to the first pressed region, the second pressed region, or the third pressed region. In FIGS. 59 to 61 and 65 to 67, a region that is pressed by the pressing portion corresponds to the second pressed region. In FIGS. 56 to 67, a pair of pressing portions is disposed symmetrically with respect to the nose. In the examples shown in FIGS. 56 to 67, one pressing portion presses one region in a dot shape. One pressing portion is fixed to the support portion at one point thereof (FIGS. 56 to 63, 65, and 66) or two points thereof (FIGS. 64 and 67).

FIGS. 68 to 73 show that a connecting portion configured to interconnect the pressing portions disposed symmetrically with respect to the nose is provided in addition to the configuration shown in FIGS. 56 to 67. However, in the configuration shown in FIGS. 68 to 70, the connecting portion, which is implemented as an elastic spring, does not directly press the nose. In this case, the spring forming the connecting portion is configured in one body.

FIGS. 74 to 79 show various embodiments of the configuration shown in FIGS. 26 to 67, in which two or more support portions are provided and two or more bent portions are provided. The design of this structure may be changed depending on the shape of the apparatus that is attached to the face or a region that is to be pressed. The various shapes shown in FIGS. 74 to 79 may be also realized by deforming one body.

This shape may also be changed depending on the position of the support portion. In the case in which the support portion is formed near the face, the pressing portion may be disposed along the facial region. In the case in which the support portion is formed at a position apart from the facial region, the pressing portion may be formed to be oriented away from the face. In this way, the spring-type elastic member may be variously changed in shape using three axes, which includes an x-axis, a y-axis, and a z-axis.

FIGS. 80 to 88 show that the pressing portion presses a facial region in a plane shape.

In FIGS. 80 to 88, a region marked in black indicates that the pressing portion according to the present invention presses the outer surface of the upper filter surface in a plane shape. FIGS. 80 to 93 show that two pressing portions, which are not connected to each other, are disposed symmetrically with respect to the nasal cartilage, and FIGS. 83 to 85 show that the two pressing portions are connected to each other via a connecting portion interposed therebetween. FIGS. 80 to 88 show cases including all of a region pressed in a dot shape, a region pressed in a line shape, and a region pressed in a plane shape. Even in this case, the pressing portions may be integrated using an elastic metal material or the like.

FIGS. 89 to 106 show that a region that is pressed by the pressing portion or an additional pressing portion has a plane shape and the pressing portion or the additional pressing portion has a solid shape. In FIGS. 89 to 106, a region marked in black indicates the side surface of the pressing portion when viewed from the top of the face of the user. A region marked in gray around the nasal cartilage indicates the additional pressing portion, and the additional pressing portion is also formed in a solid shape. The pressing portion defined in FIGS. 89 to 101 is formed in a sold shape and is made of an elastic foam material. The pressing portion may be configured in one body, or may be composed of a plurality of bodies. A part of the pressing portion that presses the upper filter surface has a plane shape, and a part of the pressing portion that is fixed to the support portion has a plane shape.

FIGS. 107 to 109 show other solid shapes of the pressing portion. The pressing portion is made of an elastic material such as foam or silicone, and the pressing region thereof has a plane shape, or has fine protrusions. A part of the pressing portion that is fixed to the support portion has a plane shape. FIGS. 107 to 109 show various examples of a structure capable of dispersing pressure applied to the face of the user.

FIGS. 110 to 120 show various examples of a structure in which the pressing portion and/or the additional pressing portion can perform motions, such as rotation, shift, and twisting, while being fixed to the support portion. The motion that the pressing portion can perform is not limited thereto, and the pressing portion may perform various mechanical motions, such as sliding, rotation, and hinge folding.

FIGS. 118 to 120 show exemplary embodiments in which a member that is changeable in shape, such as foam, an air cap, silicone, or a spring, is fixed to the support portion, and the pressing portion is connected to the support portion so that the pressing portion performs non-mechanical motion.

FIGS. 119 and 120 show various examples of the 1-3^{rd} fixing region and a fixing surface of the mask according to the present invention that presses the corresponding fixing region.

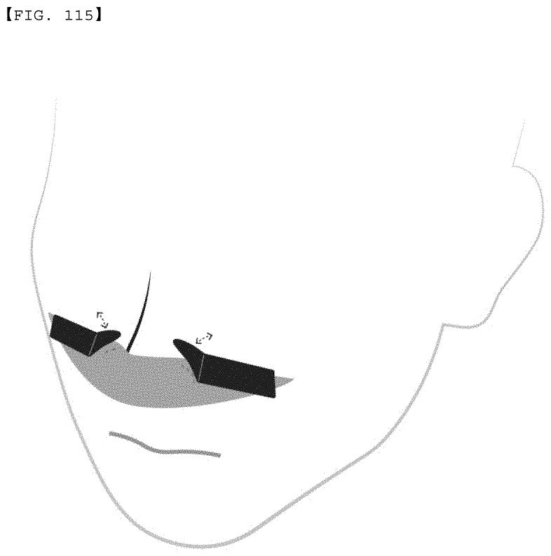

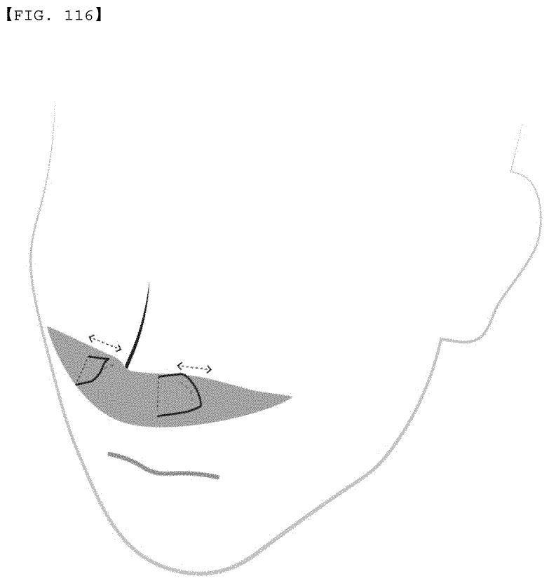

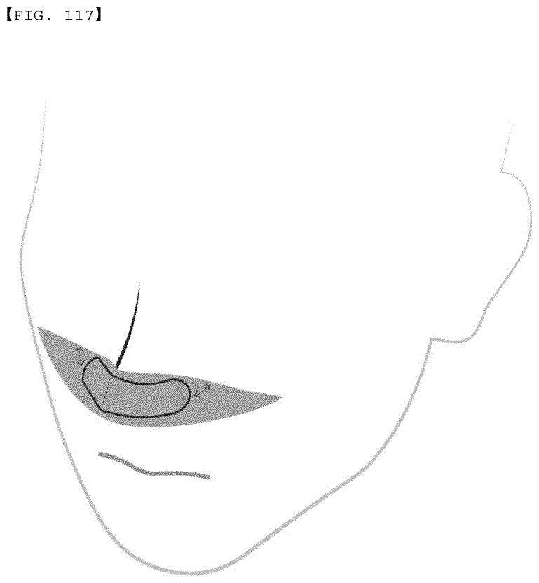

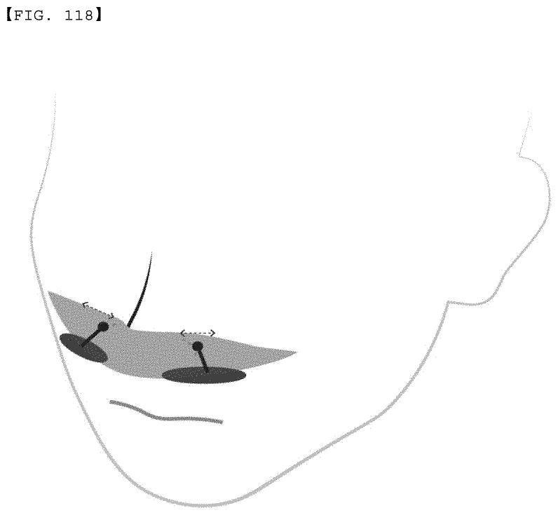

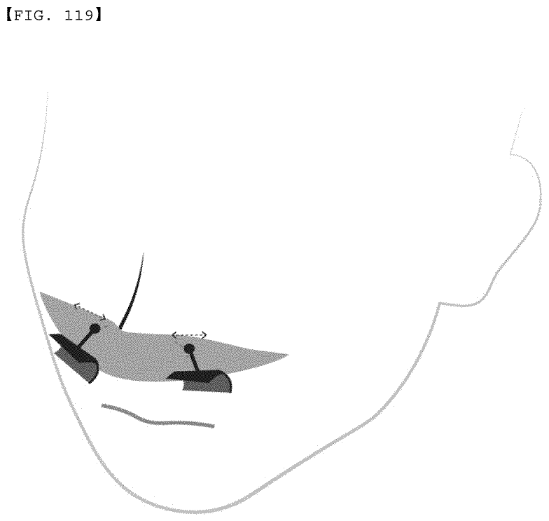

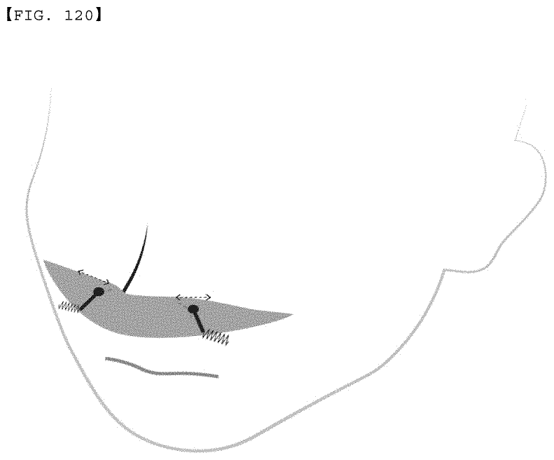

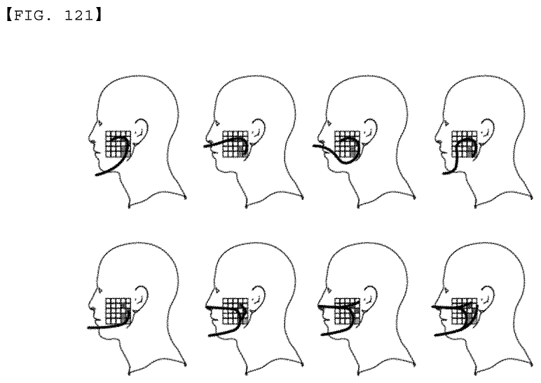

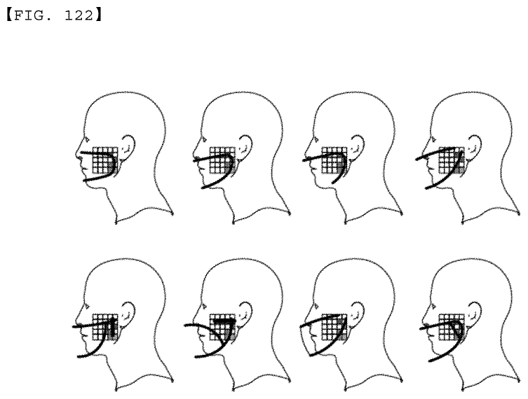

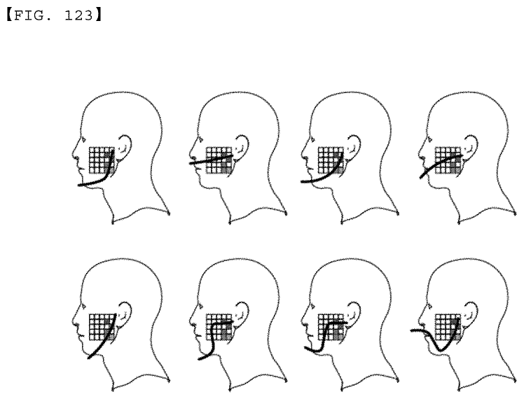

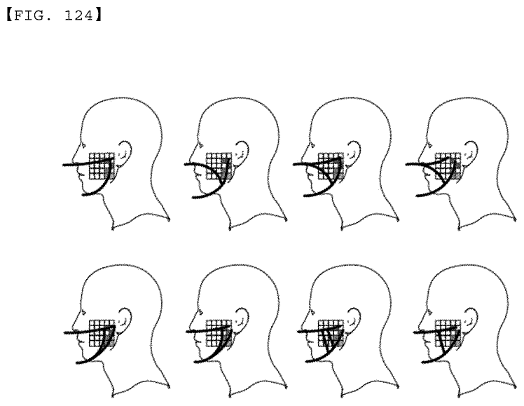

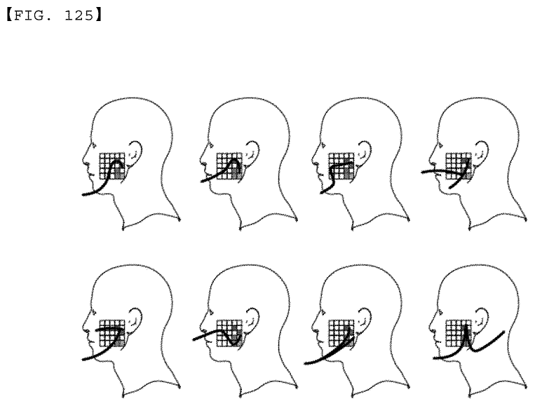

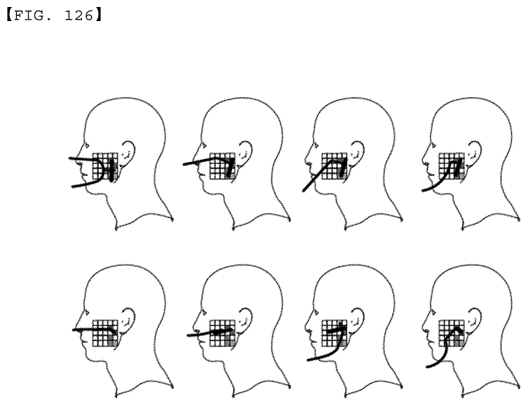

In FIGS. 121 to 126, a gray region indicates a region in which the fixing surface presses the face of the user, and a black solid line indicates an example of the frame unit. Various embodiments of the frame unit made of an elastic material are shown in the drawings. In addition to the gray regions, the frame unit may be bent so as to directly press the face. Although the frame unit is shown as only a line in the drawings, change to an elastic surface is possible, and therefore concrete illustration thereof will be omitted. Furthermore, the portion of the frame unit that is bent so as to directly press the face may also be changed into a surface.

FIGS. 121 to 126 show only the section of the face; however, the frame unit is configured to cover the face, and therefore the fixing portion is also disposed at the portion that is not shown in the drawings.

### DESCRIPTION OF REFERENCE SYMBOLS

100, 200, 300: Mask
110, 210, 310: Filter
112, 212, 312: Filter main body
114, 214, 314: Upper filter surface
116, 216, 316: Lower filter surface
118, 218, 318: Side filter surface
160, 260, 360: Frame unit
170, 270, 370: Frame main body
277, 278: Connecting portion
180, 280, 380: Coupling portion
182, 282, 382: Fixing portion cover
184, 284, 384: Fixing portion
274, 374: Pressing portion
A-A′, B-B′, C-C′, D-D′: First coupling portion
E-E′, F-F′: Second coupling portion

### INDUSTRIAL APPLICABILITY

The present invention relates to a novel mask, which includes a side fixing portion that is not fixed to ears but is brought into tight contact with a specific region of a face so as to fix the mask to the face and a pressing portion that securely seals the peripheral portion of a nose without pressing the face of a user, unlike a conventional mask, and therefore the present invention has industrial applicability.

1. A mask comprising:
a filter configured to cover vicinities of a nose and a mouth of a user; and
a frame unit coupled to the filter so as to be brought into tight contact with at least part of a first fixing region of the user to fix the filter to a face of the user,
wherein the first fixing region comprises, among regions of the face of the user, at least one of:
1) a 1-1^{st} fixing region corresponding to a lower facial region including a range from a position including a styloid process of the user to a premolar of the user in consideration of a movement range of a sagittal or anteroposterior axis and including a temporal process of the user in consideration of a movement range of a longitudinal or craniocaudal axis;
2) a 1-2^{nd} fixing region corresponding to a lower facial region including a range from a position including a parotid gland of the user to a region left by excluding a region in which a funiculus anterior is located from two branches of a medial pterygoid of muscles of mastication of the user in consideration of the movement range of the sagittal or anteroposterior axis and including the temporal process of the user in consideration of the movement range of the longitudinal or craniocaudal axis;
3) a 1-3^{rd} fixing region corresponding to a lower facial region including a range from a position including the styloid process of the user to a masseter muscle of the muscles of mastication of the user in consideration of the movement range of the sagittal or anteroposterior axis and including the temporal process of the user in consideration of the movement range of the longitudinal or craniocaudal axis, wherein a muscle belly is excluded, the muscle belly being most protruding portion of the masseter muscle;
4) a 1-4^{th} fixing region corresponding to a lower facial region including a range from a front end of a tragus of the user to a region in which a rear surface of a zygomaticus major of the user is not pressed in consideration of the movement range of the sagittal or anteroposterior axis and including the temporal process of the user in consideration of the movement range of the longitudinal or craniocaudal axis;
5) a 1-5^{th} fixing region corresponding to a triangular region having a temple, an angle of mandible, and an inferior border of mandible of the user as vertices;
6) a 1-6^{th} fixing region corresponding to the interior of a square provided based on the face of the user,
wherein the square provided based on the face of the user is a square having the angle of mandible and a zygomatic process of the user as one surface, and the square provided based on the face of the user has the sagittal or anteroposterior axis and the longitudinal or craniocaudal axis as a width and a length, respectively, and a distance from the angle of mandible to the zygomatic process in the longitudinal or craniocaudal axis is a length of one side; or
7) a 1-7^{th} fixing region in which values of (x,y) provided based on the face of the user are (−1,−1), (1,−1), (2,−1), (3,−1), (4,−1), (−1,1), (1,1), (2,1), (3,1), (4,1), (5,1), (−1,2), (1,2), (2,2), (3,2), (−1,3), (1.3), (2,3), (−1,4), (1,4), (−1,5), (1,5), and (2,5),
wherein (x,y) provided based on the face of the user is a position based on coordinates of each of small squares formed when the width and the length of the square provided based on the face of the user are divided into five equal parts, wherein the x is designated as 1, 2, 3, 4, and 5 from a rear surface to a front surface of a head of the user, and the y is designated as 1, 2, 3, 4, and 5 from an upper surface to a lower surface of the head of the user,
wherein “x” of a small square further disposed in symmetry based on the longitudinal or craniocaudal axis of the rear surface of the head of the user in the square provided based on the face of the user is designated as a negative value,
wherein “y” of a small square further disposed in symmetry based on a lateral axis of the upper surface of the head of the user in the square provided based on the face of the user is designated as a negative value, and
wherein “x” and “y” of a small square further disposed in symmetry based on apexes of the upper surface and the rear surface of the head of the user in the square provided based on the face of the user are designated as negative values.

2-6. (canceled)

7. A mask comprising:
a filter configured to cover vicinities of a nose and a mouth of a user;
a frame unit disposed along an outer surface of the filter; and
a fixing portion formed at each end of the frame unit to couple the frame unit to the filter, the fixing portion being brought into tight contact with at least part of a face of the user to fix the filter and the frame unit to the face of the user,
wherein the frame unit comprises a pressing portion configured to press an outer surface of an upper filter surface corresponding to a part of the filter so that the upper filter surface is brought into tight contact with a skin of at least part of the nose of the user and a skin of a peripheral portion of the nose, and
wherein the pressing portion presses:
1) a surface of the upper filter surface, opposite a skin of the user, against a first pressed region corresponding to at least part of a nasolabial fold region of the user so that the upper filter surface is brought into tight contact with the skin of the user,
2) a surface of the upper filter surface, opposite a skin of the user, against a second pressed region corresponding to at least part of a levator labii superioris or a levator labii superioris alaeque nasi of the user so that the upper filter surface is brought into tight contact with the skin of the user, or
3) a surface of the upper filter surface, opposite a skin of the user, against a third pressed region corresponding to at least part of an outer periphery of each of alar creases of the user so that the upper filter surface is brought into tight contact with the skin of the user.

8. The mask according to claim 7, wherein the pressing portion brings the upper filter surface into tight contact with the skin of the user, and simultaneously allows the mask to be supported by the face of the user.

9. The mask according to claim 7, wherein the filter comprises:
a filter main body disposed on a front surface of the face of the user in a curved shape;
an upper filter surface fixed along at least part of an outer periphery of an upper portion of the filter main body, fixed while being spaced downwards apart from at least part of the outer periphery of the upper portion of the filter main body, or formed as a result of the upper portion of the filter main body being bent to cover a skin of at least part of the nose of the user and a skin of a peripheral portion of the nose;
a lower filter surface fixed along at least part of an outer periphery of a lower portion of the filter main body, fixed while being spaced upwards apart from at least part of the outer periphery of the lower portion of the filter main body, or formed as a result of a lower surface of the filter main body being bent to cover a skin of at least part of a chin of the user and a skin of a peripheral portion of the chin; and
a side filter surface formed at each of opposite sides of the filter main body so as to be coupled to the frame unit.

10-11. (canceled)

12. The mask according to claim 9, wherein the upper filter surface and/or the lower filter surface is provided at opposite sides thereof with one or more first coupling portions fixed to the filter main body, and the first coupling portions have a detachable coupling structure.

13-15. (canceled)

16. The mask according to claim 9, wherein a range within which the upper filter surface is disposed is between tip-defining points and a lower end of a nasal bone.

17. The mask according to claim 9, wherein the frame unit comprises:
a frame main body disposed on an upper surface of the upper filter surface in a semicircular band shape; and
a coupling portion extending from each of opposite ends of the frame main body so as to be coupled to the side filter surface.

18. The mask according to claim 17, wherein the frame main body is provided with a connecting portion disposed at a middle of the frame main body to allow the frame main body to be folded.

19. The mask according to claim 17, wherein at least a portion of the frame main body is coupled to at least one of the filter main body, the upper filter surface, or the lower filter surface.

20. (canceled)

21. The mask according to claim 17, wherein the coupling portion comprises a fixing portion configured to be directly brought into tight contact with the first fixing region.

22. The mask according to claim 21, wherein the fixing portion is provided with a fixing portion cover coupled to an outer surface thereof.

23. mask according to claim 22, wherein the side filter surface is coupled to at least one of one surface of the fixing portion or one surface of the fixing portion cover, or is disposed between the fixing portion and the fixing portion cover.

24. (canceled)

25. The mask according to claim 21, wherein the fixing portion comprises an elastic member comprising silicone.

26. The mask according to claim 7, wherein the filter is provided with a separate protective layer disposed on an outer surface thereof.

27-30. (canceled)

31. The mask according to claim 17, wherein the pressing portion protrudes upwards from the frame main body, is coupled to an upper surface of the frame main body, or is formed as a part of the frame.

32-39. (canceled)

40. The mask according to claim 1, wherein the filter comprises:
a filter main body disposed on a front surface of the face of the user in a curved shape;
an upper filter surface fixed along at least part of an outer periphery of an upper portion of the filter main body, fixed while being spaced downwards apart from at least part of the outer periphery of the upper portion of the filter main body, or formed as a result of the upper portion of the filter main body being bent to cover a skin of at least part of the nose of the user and a skin of a peripheral portion of the nose;
a lower filter surface fixed along at least part of an outer periphery of a lower portion of the filter main body, fixed while being spaced upwards apart from at least part of the outer periphery of the lower portion of the filter main body, or formed as a result of a lower surface of the filter main body being bent to cover a skin of at least part of a chin of the user and a skin of a peripheral portion of the chin; and
a side filter surface formed at each of opposite sides of the filter main body so as to be coupled to the frame unit.

41. The mask according to claim 40, wherein the upper filter surface and/or the lower filter surface is provided at opposite sides thereof with one or more first coupling portions fixed to the filter main body, and the first coupling portions have a detachable coupling structure.

42. The mask according to claim 40, wherein a range within which the upper filter surface is disposed is between tip-defining points and a lower end of a nasal bone.

43. The mask according to claim 40, wherein the frame unit comprises:
a frame main body disposed on an upper surface of the upper filter surface in a semicircular band shape; and
a coupling portion extending from each of opposite ends of the frame main body so as to be coupled to the side filter surface.

44. The mask according to claim 1, wherein the filter is provided with a separate protective layer disposed on an outer surface thereof.
